(19) United States
(12) Patent Application Publication
(10) Pub. No.: US 2023/0340330 A1
(43) Pub. Date: Oct. 26, 2023

(54) COMPOSITION FOR COLOR CONVERSION FILM, COLOR CONVERSION FILM, METHOD FOR MANUFACTURING COLOR CONVERSION FILM, BACKLIGHT UNIT, AND LIQUID CRYSTAL DISPLAY DEVICE

(71) Applicant: FUJIFILM CORPORATION, Tokyo (JP)

(72) Inventor: Kentaro TOYOOKA, Shizuoka (JP)

(21) Appl. No.: 18/335,139

(22) Filed: Jun. 15, 2023

Related U.S. Application Data
(63) Continuation of application No. PCT/JP2021/039169, filed on Oct. 22, 2021.

(30) Foreign Application Priority Data
Dec. 18, 2020 (JP) 2020-210834

(51) Int. Cl. C09K 19/40; C09K 19/12; C09K 19/44

(52) U.S. Cl. CPC C09K 19/404; C09K 19/12; C09K 19/44; C09K 2019/123; C09K 2219/03

(57) ABSTRACT

Provided are a composition for a color conversion film, that contains at least two types of organic light-emitting materials which emit, by an excitation light, light having a longer wavelength than the excitation light and have peak wavelengths of light emission different from each other and at least one of a photopolymerizable compound or a compound having a crosslinkable group to which a protective group that is to be eliminated by heat is bonded; a color conversion film; a method for manufacturing a color conversion film; a backlight unit; and a liquid crystal display device.

### CROSS-REFERENCE TO RELATED APPLICATIONS

This application is a continuation application of International Application No. PCT/JP2021/039169, filed Oct. 22, 2021, the disclosure of which is incorporated herein by reference in its entirety. Further, this application claims priority from Japanese Patent Application No. 2020-210834, filed Dec. 18, 2020, the disclosure of which is incorporated herein by reference in its entirety.

### BACKGROUND OF THE INVENTION

### 1. Field of the Invention

The present disclosure relates to a composition for a color conversion film, a color conversion film, a method for manufacturing a color conversion film, a backlight unit, and a liquid crystal display device.

### 2. Description of the Related Art

A flat panel display such as a liquid crystal display device (LCD) has low power consumption, and its use has been expanded year by year as a space-saving display device.

Since a color conversion film of a backlight unit included in the LCD contains a light-emitting material which emits green light and red light by blue light, white light in which the blue light, the green light, and the red light are mixed can be extracted from the color conversion film.

As the color conversion film, for example, a color conversion film which includes a layer (A) including a support, an organic light-emitting material, and a binder resin, and a layer (B) in which an oxygen permeability is 1.0 cc/m²·day·atm or less (for example, see WO2017/057287A).

### SUMMARY OF THE INVENTION

A composition for a color conversion film, used for manufacturing the color conversion film, is required to have excellent storage stability without causing gelation or the like during storage.

In addition, the color conversion film manufactured by using the above-described composition for a color conversion film is required to have excellent light resistance.

For the above-described reasons, there is a demand for development of a composition for a color conversion film, with which a color conversion film having excellent light resistance can be manufactured and which has excellent storage stability.

The present disclosure has been made based on the above-described findings, and an object to be achieved is to provide a composition for a color conversion film, with which a color conversion film having excellent light resistance can be manufactured and which has excellent storage stability, a color conversion film, a method for manufacturing a color conversion film, a backlight unit, and a liquid crystal display device.

<1> A composition for a color conversion film, comprising:
at least two types of organic light-emitting materials which emit, by an excitation light, light having a longer wavelength than the excitation light and have peak wavelengths of light emission different from each other; and
at least one of a photopolymerizable compound or a compound having a crosslinkable group to which a protective group that is to be eliminated by heat is bonded.

<2> The composition for a color conversion film according to <1>,
in which the photopolymerizable compound includes a radically polymerizable compound.

<3> The composition for a color conversion film according to <1> or <2>,
in which the photopolymerizable compound includes a cationically polymerizable compound.

<4> The composition for a color conversion film according to any one of <1> to <3>, further comprising:
a photopolymerization initiator.

<5> The composition for a color conversion film according to any one of <1> to <4>,
in which the organic light-emitting material includes a first organic light-emitting material which emits, by an excitation light having a wavelength of 400 nm or more and less than 500 nm, light observed in a region having a peak wavelength of 500 nm or more and less than 580 nm, and a second organic light-emitting material which emits, by at least one of the excitation light having a wavelength of 400 nm or more and less than 500 nm or the light emitted from the first organic light-emitting material, light observed in a region having a peak wavelength of 580 nm or more and 750 nm or less.

<6> The composition for a color conversion film according to any one of <1> to <5>,
in which the organic light-emitting material is represented by General Formula (1),

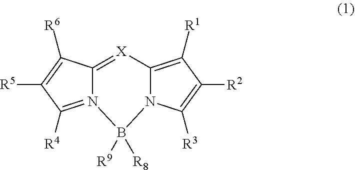

in General Formula (1), X represents C—R⁷ or N, and R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring.

<7> A color conversion film comprising:
a support; and
a color conversion layer that contains at least two types of organic light-emitting materials which emit, by an excitation light, light having a longer wavelength than the excitation light and have peak wavelengths of light emission different from each other and at least one of a photopolymerized compound or a polymerized substance of a compound having a crosslinkable group to which a protective group that is to be eliminated by heat is bonded.

<8> A method for manufacturing a color conversion film, comprising:
forming a color conversion layer on a support by curing a composition for a color conversion film, that contains at least two types of organic light-emitting materials which emit, by an excitation light, light having a longer wavelength than the excitation light and have peak wavelengths of light emission different from each other and at least one of a photopolymerizable compound or a compound having a crosslinkable group to which a protective group that is to be eliminated by heat is bonded.

<9> A backlight unit comprising:
a light source; and
the color conversion film according to <7>.

<10> A liquid crystal display device comprising:
the backlight unit according to <9>; and
a liquid crystal cell unit.

According to the present disclosure, it is possible to provide a composition for a color conversion film, with which a color conversion film having light resistance can be manufactured and which has excellent storage stability, a color conversion film, a method for manufacturing a color conversion film, a backlight unit, and a liquid crystal display device.

### BRIEF DESCRIPTION OF THE DRAWINGS

FIG. 1 is a schematic cross-sectional diagram showing one embodiment of a color conversion film.

FIG. 2 is a schematic configuration cross-sectional diagram showing an embodiment of a backlight unit according to the present disclosure.

FIG. 3 is a schematic configuration cross-sectional diagram showing an embodiment of a liquid crystal display device according to the present disclosure.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

In the present disclosure, the numerical ranges shown using “to” include the numerical values described before and after “to” as the minimum value and the maximum value.

In a numerical range described in a stepwise manner in the present disclosure, an upper limit or a lower limit described in one numerical range may be replaced with an upper limit or a lower limit in another numerical range described in a stepwise manner. Further, in a numerical range described in the present disclosure, an upper limit or a lower limit described in the numerical range may be replaced with a value described in an example.

In the present disclosure, each component may contain a plurality of types of corresponding substances. In a case where a plurality of types of substances corresponding to each component are present in the composition, a content rate or a content of each component is the total content rate or the total content of the plurality of types of substances present in the composition, unless otherwise specified.

In the present disclosure, “(meth)acrylic” is a term used in a concept which includes both acrylic and methacrylic.

In the present disclosure, “(meth)acrylic acid” is a term used in a concept which includes both acrylic acid and methacrylic acid.

In the present disclosure, “(meth)acrylate” is a term used in a concept which includes both acrylate and methacrylate.

In the present disclosure, “(meth)acryloyl” is a term used in a concept which includes both acryloyl and methacryloyl.

In the present disclosure, “(meth)acryloxy” is a term used in a concept which includes both acryloxy and methacryloxy.

In the present disclosure, “photopolymerizable compound” means a compound which is polymerized by irradiation with an actinic ray, and “photopolymerized compound” means a polymerized product of the photopolymerizable compound.

In the present disclosure, a term “layer” includes not only a case where the layer is formed over the entire region but also a case where the layer is formed only in part of the region.

In the present disclosure, “light-emitting material” refers to a material which, when irradiated with light, emits light having a wavelength different from that of the light.

In the present disclosure, “excitation light” refers to light which excites the organic light-emitting material to emit light.

In the present disclosure, a peak wavelength of light emitted from the organic light-emitting material is measured as follows.

First, a peak wavelength of an organic light-emitting material contained in a composition for a color conversion film can be confirmed by adding the composition for a color conversion film to a solvent to form a solution and measuring emission spectrum of the solution.

As the solvent, toluene, dichloromethane, tetrahydrofuran, or the like can be used, and toluene is preferable.

A peak wavelength of light emitted from an organic light-emitting material contained in a color conversion layer included in a color conversion film is measured as follows.

First, the color conversion film is disposed on a planar light-emitting device capable of emitting excitation light having a wavelength of 400 nm or more and less than 500 nm such that the support is on a light-emitting device side, and a prism sheet is placed on the color conversion film.

Since white light including blue light, green light, and red light is observed in a case where a current is passed through the planar light-emitting device and the above-described color conversion film is irradiated with the above-described excitation light, emission spectrum of the white light is obtained using a spectral emission brightness meter (for example, CS-1000 manufactured by Konica Minolta Inc.), and from the emission spectrum, light emission observed in a region with a peak wavelength of 500 nm or more and less than 580 nm and light emission observed in a region with a peak wavelength of 580 nm or more and 750 nm or less are confirmed.

In the present disclosure, a thickness of each layer can be controlled by adjusting a coating amount of a coating liquid and a concentration (% by mass) of solid contents of a liquid so as to obtain a desired thickness. In addition, the thickness can be determined from a cross-sectional image of the color conversion film, which is obtained by a scanning electron microscopy (SEM) or a transmission electron microscopy (TEM).

In the drawings, constituent components substantially the same are designated by the same reference numerals, and the description thereof will be omitted.

Hereinafter, the present disclosure will be described in detail.

(Composition for Color Conversion Film)

The composition for a color conversion film according to the embodiment of the present disclosure contains at least two types of organic light-emitting materials which emit, by an excitation light, light having a longer wavelength than the excitation light and have peak wavelengths of light emission different from each other and at least one of a photopolymerizable compound or a compound having a crosslinkable group to which a protective group that is to be eliminated by heat is bonded.

The above-described composition for a color conversion film has excellent storage stability, a color conversion film having excellent light resistance can be manufactured.

The reason why the above-described effect is obtained is presumed as follows, but is not limited thereto.

The composition for a color conversion film according to the embodiment of the present disclosure contains the organic light-emitting material and at least one of the photopolymerizable compound or the compound having a crosslinkable group to which a protective group that is to be eliminated by heat is bonded. In a color conversion layer formed by curing the composition for a color conversion film on a support, it is presumed that the photopolymerizable compound forms a crosslinking structure, and the color conversion layer has excellent light resistance.

In addition, in the composition for a color conversion film according to the embodiment of the present disclosure, since a crosslinking reaction does not proceed at room temperature in a shielded environment, it is presumed that the composition for a color conversion film has excellent storage stability.

(Organic Light-Emitting Material)

The composition for a color conversion film according to the embodiment of the present disclosure contains at least two types of organic light-emitting materials having peak wavelengths of light emission different from each other.

In a preferred aspect, the organic light-emitting material includes a first organic light-emitting material which emits, by excitation light having a wavelength of 400 nm or more and less than 500 nm, light observed in a region having a peak wavelength of 500 nm or more and less than 580 nm, and a second organic light-emitting material which emits, by at least one of the excitation light having a wavelength of 400 nm or more and less than 500 nm or the light emitted from the first organic light-emitting material, light observed in a region having a peak wavelength of 580 nm or more and 750 nm or less.

From the viewpoint of wavelength conversion effect, a content of the above-described first organic light-emitting material is preferably 40 parts by mass to 80 parts by mass and more preferably 50 parts by mass to 75 parts by mass with respect to 100 parts by mass of the total amount of the organic light-emitting materials contained in the composition for a color conversion film.

From the viewpoint of wavelength conversion effect, a content of the above-described second organic light-emitting material is preferably 20 parts by mass to 60 parts by mass and more preferably 25 parts by mass to 50 parts by mass with respect to 100 parts by mass of the total amount of the organic light-emitting materials contained in the composition for a color conversion film.

Examples of the organic light-emitting material include a compound having a fused aryl ring and a derivative thereof. Examples of the fused aryl ring include naphthalene, anthracene, phenanthrene, pyrene, chrycene, naphthacene, triphenylene, perylene, fluorantene, fluorene, and indene.

In addition, examples of the organic light-emitting material include a compound having a heteroaryl ring, a derivative thereof, and a borane compound. Examples of the heteroaryl ring include furan, pyrrole, thiophene, silole, 9-silafluorene, 9,9′-spirobisilafluorene, benzothiophene, benzofuran, indole, dibenzothiophene, dibenzofuran, imidazopyridine, phenanthroline, pyridine, pyrazine, naphthyridine, quinoxaline, and pyrrolopyridine.

In addition, examples of the organic light-emitting material include a stillbene compound, an aromatic acetylene compound, a tetraphenylbutadiene compound, an aldazine compound, a pyrromethene compound, and a diketopyrrolo[3,4-c]pyrrole compound.

Examples of the stillbene compound include 1,4-distyrylbenzene, 4,4′-bis(2-(4-diphenylaminophenyl)ethenyl)biphenyl, and 4,4′-bis(N-(stillben-4-yl)-N-phenylamino) stillbene.

In addition, examples of the organic light-emitting material include coumarin compounds such as coumarin 6, coumarin 7, and coumarin 153; azole compounds such as imidazole, thiazole, thiadiazole, carbazole, oxazole, oxadiazole, and triazole and metal complexes thereof; cyanine-based compounds such as indocyanine green; xanthene-based compounds such as fluorescein, eosin, and rhodamine; and thioxanthene-based compounds.

In addition, examples of the organic light-emitting material include polyphenylene-based compounds, naphthalimide compounds, phthalocyanine compounds and metal complexes thereof, porphyrin compounds and metal complexes thereof, oxazine-based compounds such as Nile red and Nile blue, helicene-based compounds, and aromatic amine compounds such as N,N′-diphenyl-N,N′-di(3-methylphenyl)-4,4′-diphenyl-1,1′-diamine.

In addition, examples of the organic light-emitting material include organic metal complex compounds of iridium (Ir), ruthenium (Ru), rhodium (Rh), palladium (Pd), platinum (Pt), osmium (Os), renium (Re), and the like.

However, in the present disclosure, the organic light-emitting material is not limited to those described above.

The organic light-emitting material may be a fluorescent light-emitting material or a phosphorus light-emitting material, but in order to achieve excellent color purity, a fluorescent light-emitting material is preferable.

Among the above, from the viewpoint of excellent thermal stability and photostability, a compound having a fused aryl ring or a derivative thereof is preferable.

In addition, from the viewpoint of solubility and diversity of a molecular structure, the organic light-emitting material is preferably a compound having a coordinate bond. From the viewpoint that a half-width is small and highly efficient light emission is possible, a boron-containing compound such as a boron fluoride complex is also preferable.

As the first organic light-emitting material, coumarin compounds such as coumarin 6, coumarin 7, and coumarin 153; cyanine compounds such as indocyanine green; fluorescein compounds such as fluorescein, fluorescein isothiocyanate, and carboxyfluorescein diacetate; phthalocyanine compounds such as phthalocyanine green; perylene compounds such as diisobutyl-4,10-dicyanoperylene-3,9-dicarboxylate; pyrromethene compounds; stillbene compounds; oxazine compounds; naphthalimide compounds; pyrazine compounds; benzoimidazole compounds; benzoxazole compounds; benzothiazole compounds; imidazole pyridine compounds; azole compounds; compounds having a fused aryl ring, such as anthracene; derivatives thereof; aromatic amine compounds; organic metal complex compounds; or the like is preferable. However, the first organic light-emitting material is not particularly limited thereto.

Suitable examples of the second organic light-emitting material include cyanine compounds such as 4-dicyanomethylene-2-methyl-6-(p-dimethylaminostyryl)-4H-pyran; rhodamine compounds such as rhodamine B, rhodamine 6G, rhodamine 101, and sulforhodamine 101; pyridine compounds such as 1-ethyl-2-(4-(p-dimethylaminophenyl)-1,3-butadienyl)-pyridinium-perchlorate; perylene compounds such as N,N′-bis(2,6-diisopropylphenyl)-1,6,7,12-tetraphenoxyperylene-3,4:9,10-bisdicarboimide; porphyrin compounds; pyrromethene compounds; oxazine compounds; pyrazine compounds; compounds having a fused aryl ring, such as naphthacene and dibenzodiindenoperylene; derivatives thereof; and organic metal complex compounds. However, the second organic light-emitting material is not particularly limited thereto.

Among the above-described compounds, a pyrromethene compound is preferable because it provides an excellent emission quantum yield and has good durability. As the pyrromethene compound, for example, the compound represented by General Formula (1) described above is preferable because it exhibits light emission with excellent color purity.

For the above-described reasons, it is preferable that at least one of the first organic light-emitting material or the second organic light-emitting material is the pyrromethene compound.

As the pyrromethene compound, for example, a compound represented by General Formula (1) described below is preferable because it exhibits light emission with excellent color purity.

(Compound Represented by General Formula (1))

The organic light-emitting material is preferably a compound represented by General Formula (1). Even in a case where the organic light-emitting material is represented by General Formula (1), the composition for a color conversion film can contain an organic light-emitting material other than the organic light-emitting material represented by General Formula (1).

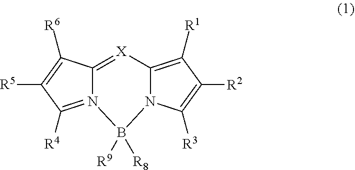

In General Formula (1), X is C—R⁷ or N. R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring.

In all the above-described groups, the hydrogen atom may be a deuterium atom.

This also applies to the compound described below or a partial structure thereof. In addition, in the following description, for example, a substituted or unsubstituted aryl group having 6 to 40 carbon atoms is an aryl group in which the number of carbon atoms including the substituent substituted on the aryl group is 6 to 40 carbon atoms. The same applies to other substituents which specify the number of carbon atoms.

In addition, in all the above-described groups, as a substituent in a case of being substituted, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group is preferable, and furthermore, a specific substituent that is preferred in the description of each substituent is preferable. In addition, these substituents may be further substituted with the above-described substituent.

The term “unsubstituted” in the case of “substituted or unsubstituted” means that a hydrogen atom or a deuterium atom has been substituted. The same applies to a case where the compound described below or a partial structure thereof is “substituted or unsubstituted”.

In all the above-described groups, the alkyl group represents, for example, a saturated aliphatic hydrocarbon group such as a methyl group, an ethyl group, an n-propyl group, an isopropyl group, an n-butyl group, an sec-butyl group, and a tert-butyl group, and the alkyl group may or may not have a substituent. The additional substituent in a case of being substituted is not particularly limited, and examples thereof an alkyl group, halogen, an aryl group, and a heteroaryl group. This point is also common to the following description. In addition, the number of carbon atoms in the alkyl group is not particularly limited, but from the viewpoint of availability and cost, it is preferably in a range of 1 or more and 20 or less, and more preferably in a range of 1 or more and 8 or less.

The cycloalkyl group represents, for example, a saturated alicyclic hydrocarbon group such as a cyclopropyl group, a cyclohexyl group, a norbornyl group, and an adamantyl group, and the cycloalkyl group may or may not have a substituent. The number of carbon atoms in an alkyl group moiety is not particularly limited, but is preferably in a range of 3 or more and 20 or less.

The heterocyclic group represents, for example, an aliphatic ring having a non-carbon atom in the ring, such as a pyran ring, a piperidine ring, and a cyclic amide, and the heterocyclic group may or may not have a substituent.

The number of carbon atoms in the heterocyclic group is not particularly limited, but is preferably in a range of 2 or more and 20 or less.

The alkenyl group represents, for example, an unsaturated aliphatic hydrocarbon group containing a double bond, such as a vinyl group, an allyl group, and a butadienyl group, and the alkenyl group may or may not have a substituent. The number of carbon atoms in the alkenyl group is not particularly limited, but is preferably in a range of 2 or more and 20 or less.

The cycloalkenyl group represents, for example, an unsaturated alicyclic hydrocarbon group containing a double bond, such as a cyclopentenyl group, a cyclopentadienyl group, and a cyclohexenyl group, and the cycloalkenyl group may or may not have a substituent.

The alkynyl group represents, for example, an unsaturated aliphatic hydrocarbon group containing a triple bond, such as an ethynyl group, and the alkynyl group may or may not have a substituent. The number of carbon atoms in the alkynyl group is not particularly limited, but is preferably in a range of 2 or more and 20 or less.

The alkoxy group represents, for example, a functional group in which an aliphatic hydrocarbon group is bonded through an ether bond, such as a methoxy group, an ethoxy group, and a propoxy group, and the aliphatic hydrocarbon group may or may not have a substituent. The number of carbon atoms in the alkoxy group is not particularly limited, but is preferably in a range of 1 or more and 20 or less.

The alkylthio group is a group in which an oxygen atom of the ether bond of the alkoxy group is replaced with a sulfur atom. A hydrocarbon group of the alkylthio group may or may not have a substituent. The number of carbon atoms in the alkylthio group is not particularly limited, but is preferably in a range of 1 or more and 20 or less.

The arylether group represents, for example, a functional group in which an aromatic hydrocarbon group is bonded through an ether bond, such as a phenoxy group, and the aromatic hydrocarbon group may or may not have a substituent. The number of carbon atoms in the arylether group is not particularly limited, but is preferably in a range of 6 or more and 40 or less.

The arylthioether group is a group in which an oxygen atom of the ether bond of the arylether group is replaced with a sulfur atom. The aromatic hydrocarbon group in the arylthioether group may or may not have a substituent. The number of carbon atoms in the arylthioether group is not particularly limited, but is preferably in a range of 6 or more and 40 or less.

The aryl group represents, for example, an aromatic hydrocarbon group such as a phenyl group, a biphenyl group, a terphenyl group, a naphthyl group, a fluorenyl group, a benzofluorenyl group, a dibenzofluorenyl group, a phenanthryl group, an anthracenyl group, a benzophenanthryl group, a benzoanthracenyl group, a chrysenyl group, a pyrenyl group, a fluoranthenyl group, a triphenylenyl group, a benzofluoranthenyl group, a dibenzoanthracenyl group, a perylenyl group, and a helicenyl group. Among the above, a phenyl group, a biphenyl group, a terphenyl group, a naphthyl group, a fluorenyl group, a phenanthryl group, an anthracenyl group, a pyrenyl group, a fluoranthenyl group, or a triphenylenyl group is preferable. The aryl group may or may not have a substituent. The number of carbon atoms in the aryl group is not particularly limited, but is preferably in a range of 6 or more and 40 or less and more preferably in a range of 6 or more and 30 or less.

In a case where R¹ to R⁹ represent a substituted or unsubstituted aryl group, as the aryl group, a phenyl group, a biphenyl group, a terphenyl group, a naphthyl group, a fluorenyl group, a phenanthryl group, or an anthracenyl group is preferable, a phenyl group, a biphenyl group, a terphenyl group, or a naphthyl group is more preferable. A phenyl group, a biphenyl group, or a terphenyl group is still more preferable, and a phenyl group is particularly preferable.

In a case where each substituent is further substituted with an aryl group, as the aryl group, a phenyl group, a biphenyl group, a terphenyl group, a naphthyl group, a fluorenyl group, a phenanthryl group, or an anthracenyl group is preferable, a phenyl group, a biphenyl group, a terphenyl group, or a naphthyl group is more preferable. A phenyl group is particularly preferable.

The heteroaryl group represents, for example, a cyclic aromatic group having one or more atoms other than carbon in the ring, such as a pyridyl group, a furanyl group, a thienyl group, a quinolinyl group, an isoquinolinyl group, a pyrazinyl group, a pyrimidyl group, a pyridazinyl group, a triazinyl group, a naphthyridinyl group, a cinnolinyl group, a phthalazinyl group, a quinoxalinyl group, a quinazolinyl group, a benzofuranyl group, a benzothienyl group, an indolyl group, a dibenzofuranyl group, a dibenzothienyl group, a carbazolyl group, a benzocarbazolyl group, a carbolinyl group, an indolocarbazolyl group, a benzofurocarbazolyl group, a benzothienocarbazolyl group, a dihydroindenocarbazolyl group, a benzoquinolinyl group, acridinyl group, a dibenzoacridinyl group, a benzimidazolyl group, an imidazopyridyl group, a benzoxazolyl group, a benzothiazolyl group, and a phenanthrolinyl group.

The naphthyridinyl group represents any of a 1,5-naphthyridinyl group, a 1,6-naphthyridinyl group, a 1,7-naphthyridinyl group, a 1,8-naphthyridinyl group, a 2,6-naphthyridinyl group, or a 2,7-naphthyridinyl group. The heteroaryl group may or may not have a substituent. The number of carbon atoms in the heteroaryl group is not particularly limited, but is preferably in a range of 2 or more and 40 or less and more preferably in a range of 2 or more and 30 or less.

In a case where R¹ to R⁹ represent a substituted or unsubstituted heteroaryl group, as the heteroaryl group, a pyridyl group, a furanyl group, a thienyl group, a quinolinyl group, a pyrimidyl group, a triazinyl group, a benzofuranyl group, a benzothienyl group, an indolyl group, a dibenzofuranyl group, a dibenzothienyl group, a carbazolyl group, a benzimidazolyl group, an imidazopyridyl group, a benzoxazolyl group, a benzothiazolyl group, or a phenanthrolinyl group is preferable, and a pyridyl group, a furanyl group, a thienyl group, or a quinolinyl group is more preferable. A pyridyl group is particularly preferable.

In a case where each substituent is further substituted with a heteroaryl group, as the heteroaryl group, a pyridyl group, a furanyl group, a thienyl group, a quinolinyl group, a pyrimidyl group, a triazinyl group, a benzofuranyl group, a benzothienyl group, an indolyl group, a dibenzofuranyl group, a dibenzothienyl group, a carbazolyl group, a benzimidazolyl group, an imidazopyridyl group, a benzoxazolyl group, a benzothiazolyl group, or a phenanthrolinyl group is preferable, and a pyridyl group, a furanyl group, a thienyl group, or a quinolinyl group is more preferable. A pyridyl group is particularly preferable.

The halogen represents an atom selected from fluorine, chlorine, bromine, or iodine. In addition, the carbonyl group, the carboxyl group, the oxycarbonyl group, and the carbamoyl group may or may not have a substituent. Here, examples of the substituent include an alkyl group, a cycloalkyl group, an aryl group, and a heteroaryl group, and these substituents may be further substituted.

The amino group is a substituted or unsubstituted amino group. Examples of the substituent in a case of being substituted include an aryl group, a heteroaryl group, a linear alkyl group, and a branched alkyl group. As the aryl group and the heteroaryl group, a phenyl group, a naphthyl group, a pyridyl group, or a quinolinyl group is preferable. These substituents may be further substituted. The number of carbon atoms is not particularly limited, but is preferably in a range of 2 or more and 50 or less, more preferably in a range of 6 or more and 40 or less, and particularly preferably in a range of 6 or more and 30 or less.

The silyl group represents, for example, an alkylsilyl group such as a trimethylsilyl group, a triethylsilyl group, a tert-butyldimethylsilyl group, a propyldimethylsilyl group, and a vinyldimethylsilyl group; or an arylsilyl group such as a phenyldimethylsilyl group, a tert-butyldiphenylsilyl group, a triphenylsilyl group, and a trinaphthylsilyl group. A substituent on silicon may be further substituted. The number of carbon atoms in the silyl group is not particularly limited, but is preferably in a range of 1 or more and 30 or less.

The siloxanyl group represents, for example, a silicon compound group through an ether bond, such as a trimethylsiloxanyl group. A substituent on silicon may be further substituted.

In addition, the boryl group is a substituted or unsubstituted boryl group. Examples of the substituent in a case of being substituted include an aryl group, a heteroaryl group, a linear alkyl group, a branched alkyl group, an arylether group, an alkoxy group, and a hydroxyl group. Among the above, an aryl group or an arylether group is preferable. In addition, the phosphine oxide group is a group represented by —P(═O)R¹⁰R¹¹. R¹⁰ and R¹¹ are selected from the same groups as R¹ to R⁹.

The fused ring and the aliphatic ring formed between the adjacent substituents means that any two adjacent substituents (for example, R¹ and R² in General Formula (1)) are bonded to each other to form a conjugated or non-conjugated cyclic skeleton. Examples of a constituent element of such a fused ring and an aliphatic ring include carbon, nitrogen, oxygen, sulfur, phosphorus, and silicon. In addition, the fused ring and the aliphatic ring may be fused with another ring.

Since the compound represented by General Formula (1) exhibits excellent emission quantum yield and has a small half-width of the emission spectrum, it is possible to achieve both efficient color conversion and excellent color purity. Furthermore, in the compound represented by General Formula (1), by introducing an appropriate substituent at an appropriate position, various characteristics and physical properties such as light emission efficiency, color purity, thermal stability, photostability, and dispersibility can be adjusted.

For example, as compared with a case where R¹, R³, R⁴, and R⁶ all represent hydrogen atoms, a case where at least one of R¹, R³, R⁴, or R⁶ represents a group selected from the group including a substituted or unsubstituted alkyl group, a substituted or unsubstituted aryl group, and a substituted or unsubstituted heteroaryl group exhibits more excellent thermal stability and photostability.

In a case where at least one of R¹, R³, R⁴, or R⁶ represents a substituted or unsubstituted alkyl group, as the alkyl group, an alkyl group having 1 to 6 carbon atoms, such as a methyl group, an ethyl group, an n-propyl group, an isopropyl group, an n-butyl group, a sec-butyl group, a tert-butyl group, a pentyl group, and a hexyl group, is preferable.

Further, from the viewpoint of excellent thermal stability, the above-described alkyl group is preferably a methyl group, an ethyl group, an n-propyl group, an isopropyl group, an n-butyl group, an sec-butyl group, or a tert-butyl group. In addition, from the viewpoint of preventing concentration quenching and improving the emission quantum yield, the above-described alkyl group is more preferably a sterically bulky tert-butyl group. In addition, from the viewpoint of ease of synthesis and availability of raw materials, a methyl group is also preferably used as the above-described alkyl group.

In a case where at least one of R¹, R³, R⁴, or R⁶ represents a substituted or unsubstituted aryl group, as the aryl group, a phenyl group, a biphenyl group, a terphenyl group, or a naphthyl group is preferable, a phenyl group or a biphenyl group is more preferable. It is particularly preferable to represent a phenyl group.

In a case where at least one of R¹, R³, R⁴, or R⁶ represents a substituted or unsubstituted heteroaryl group, as the heteroaryl group, a pyridyl group, a quinolinyl group, or a thienyl group is preferable, and a pyridyl group or a quinolinyl group is more preferable. It is particularly preferable to represent a pyridyl group.

A case where all of R¹, R³, R⁴, and R⁶ each independently represent a substituted or unsubstituted alkyl group is preferable because of its good solubility in a binder resin or a solvent. In this case, from the viewpoint of ease of synthesis and availability of raw materials, the alkyl group is preferably a methyl group.

A case where all of R¹, R³, R⁴, and R⁶ each independently represent a substituted or unsubstituted aryl group or a substituted or unsubstituted heteroaryl group is preferable because it exhibits better thermal stability and photostability. In this case, it is more preferable that all of R¹, R³, R⁴, and R⁶ each independently represent a substituted or unsubstituted aryl group.

Although there are a plurality of substituents which improve properties, the substituents which exhibit sufficient performance in all of them are limited. In particular, it is difficult to achieve both high light emission efficiency and high color purity. Therefore, by introducing a plurality of types of substituents into the compound represented by General Formula (1), it is possible to obtain a compound having balanced emission characteristics, color purity, and the like.

In particular, in a case where all of R¹, R³, R⁴, and R⁶ each independently represent a substituted or unsubstituted aryl group, for example, it is preferable to introduce a plurality of types of substituents, such as R¹≠R⁴, R³≠R⁶, R¹≠R³, or R⁴≠R⁶.

Here, “≠” indicates that the groups have different structures. For example, R¹≠R⁴ indicates that R¹ and R⁴ are groups having different structures. By introducing a plurality of types of substituents as described above, an aryl group which affects the color purity and an aryl group which affects the light emission efficiency can be simultaneously introduced, so that fine adjustment is possible.

A case where R¹≠R³ or R⁴≠R⁶ is preferable because the light emission efficiency and the color purity can be improved in a balanced manner. In this case, with respect to the compound represented by General Formula (1), since one or more aryl groups which affect the color purity are introduced to each of pyrrole rings on both side and aryl groups which affect the light emission efficiency are introduced at other positions, both of these properties can be improved. In addition, in the case where R¹≠R³ or R⁴≠R⁶, from the viewpoint of improving both the heat resistance and the color purity, it is more preferable that R¹ ═R⁴ and R³═R⁶.

As the aryl group which affects the color purity, an aryl group substituted with an electron-donating group is preferable. The electron-donating group is an atomic group which donates an electron to the substituted atomic group by an inductive effect or a resonance effect in organic electron theory. Examples of the electron-donating group include groups having a negative value as the substituent constant (σp (para)) of Hammett's law. The substituent constant (σp (para)) of Hammett's law can be quoted from the 5th edition of the Basics of Chemistry Handbook (page 380 of II).

Specific examples of the electron-donating group include an alkyl group (σp of methyl group: −0.17), an alkoxy group (σp of methoxy group: −0.27), and an amino group (σp of −NH2: −0.66).

In particular, an alkyl group having 1 to 8 carbon atoms or an alkoxy group having 1 to 8 carbon atoms is preferable, and a methyl group, an ethyl group, a tert-butyl group, or a methoxy group is more preferable. From the viewpoint of dispersibility, a tert-butyl group or a methoxy group is particularly preferable, and in a case where these are used as the above-described electron-donating group, in the compound represented by General Formula (1), quenching due to aggregation of molecules can be prevented.

The substitution position of the substituent is not particularly limited, but since it is necessary to suppress torsion of a bond in order to increase the photostability of the compound represented by General Formula (1), it is preferable that the substituent is bonded at a meta-position or para-position with respect to the bonding position with the pyrromethene skeleton. On the other hand, as the aryl group which mainly affects the light emission efficiency, an aryl group having a bulky substituent such as a tert-butyl group, an adamantyl group, or a methoxy group is preferable.

In a case where R¹, R³, R⁴, and R⁶ each independently represent a substituted or unsubstituted aryl group, it is preferable that R¹, R³, R⁴, and R⁶ each independently represent a substituted or unsubstituted phenyl group. In this case, it is more preferable that R¹, R³, R⁴, and R⁶ are each selected from the following Ar-1 to Ar-6. In this case, examples of a preferred combination of R¹, R³, R⁴, and R⁶ include combinations shown in Tables 1-1 to 1-11, but the preferred combination thereof is not limited thereto.

The black circle means a bonding portion with the main skeleton.

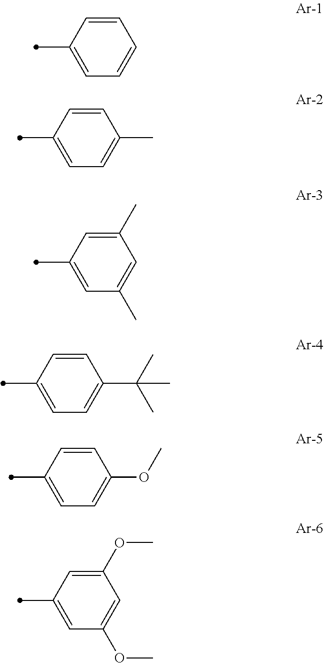

TABLE 1

| R1 | R3 | R4 | R6 |
|---|---|---|---|
| Ar-1 | Ar-1 | Ar-1 | Ar-1 |
| Ar-1 | Ar-1 | Ar-1 | Ar-2 |
| Ar-1 | Ar-1 | Ar-1 | Ar-3 |
| Ar-1 | Ar-1 | Ar-1 | Ar-4 |
| Ar-1 | Ar-1 | Ar-1 | Ar-5 |
| Ar-1 | Ar-1 | Ar-1 | Ar-6 |
| Ar-1 | Ar-1 | Ar-2 | Ar-1 |
| Ar-1 | Ar-1 | Ar-2 | Ar-2 |
| Ar-1 | Ar-1 | Ar-2 | Ar-3 |
| Ar-1 | Ar-1 | Ar-2 | Ar-4 |
| Ar-1 | Ar-1 | Ar-2 | Ar-5 |
| Ar-1 | Ar-1 | Ar-2 | Ar-6 |
| Ar-1 | Ar-1 | Ar-3 | Ar-1 |
| Ar-1 | Ar-1 | Ar-3 | Ar-2 |
| Ar-1 | Ar-1 | Ar-3 | Ar-3 |
| Ar-1 | Ar-1 | Ar-3 | Ar-4 |
| Ar-1 | Ar-1 | Ar-3 | Ar-5 |
| Ar-1 | Ar-1 | Ar-3 | Ar-6 |
| Ar-1 | Ar-1 | Ar-4 | Ar-1 |
| Ar-1 | Ar-1 | Ar-4 | Ar-2 |
| Ar-1 | Ar-1 | Ar-4 | Ar-3 |
| Ar-1 | Ar-1 | Ar-4 | Ar-4 |
| Ar-1 | Ar-1 | Ar-4 | Ar-5 |
| Ar-1 | Ar-1 | Ar-4 | Ar-6 |
| Ar-1 | Ar-1 | Ar-5 | Ar-1 |
| Ar-1 | Ar-1 | Ar-5 | Ar-2 |
| Ar-1 | Ar-1 | Ar-5 | Ar-3 |
| Ar-1 | Ar-1 | Ar-5 | Ar-4 |
| Ar-1 | Ar-1 | Ar-5 | Ar-5 |
| Ar-1 | Ar-1 | Ar-5 | Ar-6 |

TABLE 2

| R1 | R3 | R4 | R6 |
|---|---|---|---|
| Ar-1 | Ar-1 | Ar-6 | Ar-1 |
| Ar-1 | Ar-1 | Ar-6 | Ar-2 |
| Ar-1 | Ar-1 | Ar-6 | Ar-3 |
| Ar-1 | Ar-1 | Ar-6 | Ar-4 |
| Ar-1 | Ar-1 | Ar-6 | Ar-5 |
| Ar-1 | Ar-1 | Ar-6 | Ar-6 |
| Ar-1 | Ar-2 | Ar-1 | Ar-2 |
| Ar-1 | Ar-2 | Ar-1 | Ar-3 |
| Ar-1 | Ar-2 | Ar-1 | Ar-4 |
| Ar-1 | Ar-2 | Ar-1 | Ar-5 |
| Ar-1 | Ar-2 | Ar-1 | Ar-6 |
| Ar-1 | Ar-2 | Ar-2 | Ar-1 |
| Ar-1 | Ar-2 | Ar-2 | Ar-2 |
| Ar-1 | Ar-2 | Ar-2 | Ar-3 |
| Ar-1 | Ar-2 | Ar-2 | Ar-4 |
| Ar-1 | Ar-2 | Ar-2 | Ar-5 |
| Ar-1 | Ar-2 | Ar-2 | Ar-6 |
| Ar-1 | Ar-2 | Ar-3 | Ar-1 |
| Ar-1 | Ar-2 | Ar-3 | Ar-2 |
| Ar-1 | Ar-2 | Ar-3 | Ar-3 |
| Ar-1 | Ar-2 | Ar-3 | Ar-4 |
| Ar-1 | Ar-2 | Ar-3 | Ar-5 |
| Ar-1 | Ar-2 | Ar-3 | Ar-6 |
| Ar-1 | Ar-2 | Ar-4 | Ar-1 |
| Ar-1 | Ar-2 | Ar-4 | Ar-2 |
| Ar-1 | Ar-2 | Ar-4 | Ar-3 |
| Ar-1 | Ar-2 | Ar-4 | Ar-4 |
| Ar-1 | Ar-2 | Ar-4 | Ar-5 |
| Ar-1 | Ar-2 | Ar-4 | Ar-6 |

TABLE 3

| R1 | R3 | R4 | R6 |
|---|---|---|---|
| Ar-1 | Ar-2 | Ar-5 | Ar-1 |
| Ar-1 | Ar-2 | Ar-5 | Ar-2 |
| Ar-1 | Ar-2 | Ar-5 | Ar-3 |
| Ar-1 | Ar-2 | Ar-5 | Ar-4 |
| Ar-1 | Ar-2 | Ar-5 | Ar-5 |
| Ar-1 | Ar-2 | Ar-5 | Ar-6 |
| Ar-1 | Ar-2 | Ar-6 | Ar-1 |
| Ar-1 | Ar-2 | Ar-6 | Ar-2 |
| Ar-1 | Ar-2 | Ar-6 | Ar-3 |
| Ar-1 | Ar-2 | Ar-6 | Ar-4 |
| Ar-1 | Ar-2 | Ar-6 | Ar-5 |
| Ar-1 | Ar-2 | Ar-6 | Ar-6 |
| Ar-1 | Ar-3 | Ar-1 | Ar-2 |
| Ar-1 | Ar-3 | Ar-1 | Ar-3 |
| Ar-1 | Ar-3 | Ar-1 | Ar-4 |
| Ar-1 | Ar-3 | Ar-1 | Ar-5 |
| Ar-1 | Ar-3 | Ar-1 | Ar-6 |
| Ar-1 | Ar-3 | Ar-2 | Ar-2 |
| Ar-1 | Ar-3 | Ar-2 | Ar-3 |
| Ar-1 | Ar-3 | Ar-2 | Ar-4 |
| Ar-1 | Ar-3 | Ar-2 | Ar-5 |
| Ar-1 | Ar-3 | Ar-2 | Ar-6 |
| Ar-1 | Ar-3 | Ar-3 | Ar-1 |
| Ar-1 | Ar-3 | Ar-3 | Ar-2 |
| Ar-1 | Ar-3 | Ar-3 | Ar-3 |
| Ar-1 | Ar-3 | Ar-3 | Ar-4 |
| Ar-1 | Ar-3 | Ar-3 | Ar-5 |
| Ar-1 | Ar-3 | Ar-3 | Ar-6 |
| Ar-1 | Ar-3 | Ar-4 | Ar-1 |
| Ar-1 | Ar-3 | Ar-4 | Ar-2 |
| Ar-1 | Ar-3 | Ar-4 | Ar-3 |

TABLE 4

| R1 | R3 | R4 | R6 |
|---|---|---|---|
| Ar-1 | Ar-3 | Ar-4 | Ar-4 |
| Ar-1 | Ar-3 | Ar-4 | Ar-5 |
| Ar-1 | Ar-3 | Ar-4 | Ar-6 |
| Ar-1 | Ar-3 | Ar-5 | Ar-1 |
| Ar-1 | Ar-3 | Ar-5 | Ar-2 |
| Ar-1 | Ar-3 | Ar-5 | Ar-3 |
| Ar-1 | Ar-3 | Ar-5 | Ar-4 |
| Ar-1 | Ar-3 | Ar-5 | Ar-5 |
| Ar-1 | Ar-3 | Ar-5 | Ar-6 |
| Ar-1 | Ar-3 | Ar-6 | Ar-1 |
| Ar-1 | Ar-3 | Ar-6 | Ar-2 |
| Ar-1 | Ar-3 | Ar-6 | Ar-3 |
| Ar-1 | Ar-3 | Ar-6 | Ar-4 |
| Ar-1 | Ar-3 | Ar-6 | Ar-5 |
| Ar-1 | Ar-3 | Ar-6 | Ar-6 |
| Ar-1 | Ar-4 | Ar-1 | Ar-2 |
| Ar-1 | Ar-4 | Ar-1 | Ar-3 |
| Ar-1 | Ar-4 | Ar-1 | Ar-4 |
| Ar-1 | Ar-4 | Ar-1 | Ar-5 |
| Ar-1 | Ar-4 | Ar-1 | Ar-6 |
| Ar-1 | Ar-4 | Ar-2 | Ar-2 |
| Ar-1 | Ar-4 | Ar-2 | Ar-3 |
| Ar-1 | Ar-4 | Ar-2 | Ar-4 |
| Ar-1 | Ar-4 | Ar-2 | Ar-5 |
| Ar-1 | Ar-4 | Ar-2 | Ar-6 |
| Ar-1 | Ar-4 | Ar-3 | Ar-2 |
| Ar-1 | Ar-4 | Ar-3 | Ar-3 |
| Ar-1 | Ar-4 | Ar-3 | Ar-4 |
| Ar-1 | Ar-4 | Ar-3 | Ar-5 |
| Ar-1 | Ar-4 | Ar-3 | Ar-6 |

TABLE 5

| R1 | R3 | R4 | R6 |
|---|---|---|---|
| Ar-1 | Ar-4 | Ar-4 | Ar-1 |
| Ar-1 | Ar-4 | Ar-4 | Ar-2 |
| Ar-1 | Ar-4 | Ar-4 | Ar-3 |
| Ar-1 | Ar-4 | Ar-4 | Ar-4 |
| Ar-1 | Ar-4 | Ar-4 | Ar-5 |
| Ar-1 | Ar-4 | Ar-4 | Ar-6 |
| Ar-1 | Ar-4 | Ar-5 | Ar-1 |
| Ar-1 | Ar-4 | Ar-5 | Ar-2 |
| Ar-1 | Ar-4 | Ar-5 | Ar-3 |
| Ar-1 | Ar-4 | Ar-5 | Ar-4 |
| Ar-1 | Ar-4 | Ar-5 | Ar-5 |
| Ar-1 | Ar-4 | Ar-5 | Ar-6 |
| Ar-1 | Ar-4 | Ar-6 | Ar-1 |
| Ar-1 | Ar-4 | Ar-6 | Ar-2 |
| Ar-1 | Ar-4 | Ar-6 | Ar-3 |
| Ar-1 | Ar-4 | Ar-6 | Ar-4 |
| Ar-1 | Ar-4 | Ar-6 | Ar-5 |
| Ar-1 | Ar-4 | Ar-6 | Ar-6 |
| Ar-1 | Ar-5 | Ar-1 | Ar-2 |
| Ar-1 | Ar-5 | Ar-1 | Ar-3 |
| Ar-1 | Ar-5 | Ar-1 | Ar-4 |
| Ar-1 | Ar-5 | Ar-1 | Ar-5 |
| Ar-1 | Ar-5 | Ar-1 | Ar-6 |
| Ar-1 | Ar-5 | Ar-2 | Ar-2 |
| Ar-1 | Ar-5 | Ar-2 | Ar-3 |
| Ar-1 | Ar-5 | Ar-2 | Ar-4 |
| Ar-1 | Ar-5 | Ar-2 | Ar-5 |
| Ar-1 | Ar-5 | Ar-2 | Ar-6 |
| Ar-1 | Ar-5 | Ar-3 | Ar-2 |
| Ar-1 | Ar-5 | Ar-3 | Ar-3 |

TABLE 6

| R1 | R3 | R4 | R6 |
|---|---|---|---|
| Ar-1 | Ar-5 | Ar-3 | Ar-4 |
| Ar-1 | Ar-5 | Ar-3 | Ar-5 |
| Ar-1 | Ar-5 | Ar-3 | Ar-6 |
| Ar-1 | Ar-5 | Ar-4 | Ar-2 |
| Ar-1 | Ar-5 | Ar-4 | Ar-3 |
| Ar-1 | Ar-5 | Ar-4 | Ar-4 |
| Ar-1 | Ar-5 | Ar-4 | Ar-5 |
| Ar-1 | Ar-5 | Ar-4 | Ar-6 |
| Ar-1 | Ar-5 | Ar-5 | Ar-1 |
| Ar-1 | Ar-5 | Ar-5 | Ar-2 |
| Ar-1 | Ar-5 | Ar-5 | Ar-3 |
| Ar-1 | Ar-5 | Ar-5 | Ar-4 |
| Ar-1 | Ar-5 | Ar-5 | Ar-5 |
| Ar-1 | Ar-5 | Ar-5 | Ar-6 |
| Ar-1 | Ar-5 | Ar-6 | Ar-1 |
| Ar-1 | Ar-5 | Ar-6 | Ar-2 |
| Ar-1 | Ar-5 | Ar-6 | Ar-3 |
| Ar-1 | Ar-5 | Ar-6 | Ar-4 |
| Ar-1 | Ar-5 | Ar-6 | Ar-5 |
| Ar-1 | Ar-5 | Ar-6 | Ar-6 |
| Ar-1 | Ar-6 | Ar-1 | Ar-2 |
| Ar-1 | Ar-6 | Ar-1 | Ar-3 |
| Ar-1 | Ar-6 | Ar-1 | Ar-4 |
| Ar-1 | Ar-6 | Ar-1 | Ar-5 |
| Ar-1 | Ar-6 | Ar-1 | Ar-6 |
| Ar-1 | Ar-6 | Ar-2 | Ar-2 |
| Ar-1 | Ar-6 | Ar-2 | Ar-3 |
| Ar-1 | Ar-6 | Ar-2 | Ar-4 |
| Ar-1 | Ar-6 | Ar-2 | Ar-5 |
| Ar-1 | Ar-6 | Ar-2 | Ar-6 |

TABLE 7

| R1 | R3 | R4 | R6 |
|---|---|---|---|
| Ar-1 | Ar-6 | Ar-3 | Ar-2 |
| Ar-1 | Ar-6 | Ar-3 | Ar-3 |
| Ar-1 | Ar-6 | Ar-3 | Ar-4 |
| Ar-1 | Ar-6 | Ar-3 | Ar-5 |
| Ar-1 | Ar-6 | Ar-3 | Ar-6 |
| Ar-1 | Ar-6 | Ar-4 | Ar-2 |
| Ar-1 | Ar-6 | Ar-4 | Ar-3 |
| Ar-1 | Ar-6 | Ar-4 | Ar-4 |
| Ar-1 | Ar-6 | Ar-4 | Ar-5 |
| Ar-1 | Ar-6 | Ar-4 | Ar-6 |
| Ar-1 | Ar-6 | Ar-5 | Ar-2 |
| Ar-1 | Ar-6 | Ar-5 | Ar-3 |
| Ar-1 | Ar-6 | Ar-5 | Ar-4 |
| Ar-1 | Ar-6 | Ar-5 | Ar-5 |
| Ar-1 | Ar-6 | Ar-5 | Ar-6 |
| Ar-1 | Ar-6 | Ar-6 | Ar-1 |
| Ar-1 | Ar-6 | Ar-6 | Ar-2 |
| Ar-1 | Ar-6 | Ar-6 | Ar-3 |
| Ar-1 | Ar-6 | Ar-6 | Ar-4 |
| Ar-1 | Ar-6 | Ar-6 | Ar-5 |
| Ar-1 | Ar-6 | Ar-6 | Ar-6 |
| Ar-2 | Ar-1 | Ar-1 | Ar-2 |
| Ar-2 | Ar-1 | Ar-1 | Ar-3 |
| Ar-2 | Ar-1 | Ar-1 | Ar-4 |
| Ar-2 | Ar-1 | Ar-1 | Ar-5 |
| Ar-2 | Ar-1 | Ar-1 | Ar-6 |
| Ar-2 | Ar-1 | Ar-2 | Ar-2 |
| Ar-2 | Ar-1 | Ar-2 | Ar-3 |
| Ar-2 | Ar-1 | Ar-2 | Ar-4 |
| Ar-2 | Ar-1 | Ar-2 | Ar-5 |

TABLE 8

| R1 | R3 | R4 | R6 |
|---|---|---|---|
| Ar-2 | Ar-1 | Ar-2 | Ar-6 |
| Ar-2 | Ar-1 | Ar-3 | Ar-2 |
| Ar-2 | Ar-1 | Ar-3 | Ar-3 |
| Ar-2 | Ar-1 | Ar-3 | Ar-4 |
| Ar-2 | Ar-1 | Ar-3 | Ar-5 |
| Ar-2 | Ar-1 | Ar-3 | Ar-6 |
| Ar-2 | Ar-1 | Ar-4 | Ar-2 |
| Ar-2 | Ar-1 | Ar-4 | Ar-3 |
| Ar-2 | Ar-1 | Ar-4 | Ar-4 |
| Ar-2 | Ar-1 | Ar-4 | Ar-5 |
| Ar-2 | Ar-1 | Ar-4 | Ar-6 |
| Ar-2 | Ar-1 | Ar-5 | Ar-2 |
| Ar-2 | Ar-1 | Ar-5 | Ar-3 |
| Ar-2 | Ar-1 | Ar-5 | Ar-4 |
| Ar-2 | Ar-1 | Ar-5 | Ar-5 |
| Ar-2 | Ar-1 | Ar-5 | Ar-6 |
| Ar-2 | Ar-1 | Ar-6 | Ar-2 |
| Ar-2 | Ar-1 | Ar-6 | Ar-3 |
| Ar-2 | Ar-1 | Ar-6 | Ar-4 |
| Ar-2 | Ar-1 | Ar-6 | Ar-5 |
| Ar-2 | Ar-1 | Ar-6 | Ar-6 |
| Ar-2 | Ar-2 | Ar-1 | Ar-3 |
| Ar-2 | Ar-2 | Ar-1 | Ar-4 |
| Ar-2 | Ar-2 | Ar-1 | Ar-5 |
| Ar-2 | Ar-2 | Ar-1 | Ar-6 |
| Ar-2 | Ar-2 | Ar-2 | Ar-2 |
| Ar-2 | Ar-2 | Ar-2 | Ar-3 |
| Ar-2 | Ar-2 | Ar-2 | Ar-4 |
| Ar-2 | Ar-2 | Ar-2 | Ar-5 |
| Ar-2 | Ar-2 | Ar-2 | Ar-6 |

TABLE 9

| R1 | R3 | R4 | R6 |
|---|---|---|---|
| Ar-2 | Ar-2 | Ar-3 | Ar-2 |
| Ar-2 | Ar-2 | Ar-3 | Ar-3 |
| Ar-2 | Ar-2 | Ar-3 | Ar-4 |
| Ar-2 | Ar-2 | Ar-3 | Ar-5 |
| Ar-2 | Ar-2 | Ar-3 | Ar-6 |
| Ar-2 | Ar-2 | Ar-4 | Ar-2 |
| Ar-2 | Ar-2 | Ar-4 | Ar-3 |
| Ar-2 | Ar-2 | Ar-4 | Ar-4 |
| Ar-2 | Ar-2 | Ar-4 | Ar-5 |
| Ar-2 | Ar-2 | Ar-4 | Ar-6 |
| Ar-2 | Ar-2 | Ar-5 | Ar-2 |
| Ar-2 | Ar-2 | Ar-5 | Ar-3 |
| Ar-2 | Ar-2 | Ar-5 | Ar-4 |
| Ar-2 | Ar-2 | Ar-5 | Ar-5 |
| Ar-2 | Ar-2 | Ar-6 | Ar-6 |
| Ar-2 | Ar-2 | Ar-6 | Ar-2 |
| Ar-2 | Ar-2 | Ar-6 | Ar-3 |
| Ar-2 | Ar-2 | Ar-6 | Ar-4 |
| Ar-2 | Ar-2 | Ar-6 | Ar-5 |
| Ar-2 | Ar-2 | Ar-6 | Ar-6 |
| Ar-2 | Ar-3 | Ar-1 | Ar-3 |
| Ar-2 | Ar-3 | Ar-1 | Ar-4 |
| Ar-2 | Ar-3 | Ar-1 | Ar-5 |
| Ar-2 | Ar-3 | Ar-2 | Ar-6 |
| Ar-2 | Ar-3 | Ar-2 | Ar-3 |
| Ar-2 | Ar-3 | Ar-2 | Ar-4 |
| Ar-2 | Ar-3 | Ar-2 | Ar-5 |
| Ar-2 | Ar-3 | Ar-2 | Ar-6 |
| Ar-2 | Ar-3 | Ar-3 | Ar-2 |
| Ar-2 | Ar-3 | Ar-3 | Ar-3 |

TABLE 10

| R1 | R3 | R4 | R6 |
|---|---|---|---|
| Ar-2 | Ar-3 | Ar-3 | Ar-4 |
| Ar-2 | Ar-3 | Ar-3 | Ar-5 |
| Ar-2 | Ar-3 | Ar-3 | Ar-6 |
| Ar-2 | Ar-3 | Ar-4 | Ar-2 |
| Ar-2 | Ar-3 | Ar-4 | Ar-3 |
| Ar-2 | Ar-3 | Ar-4 | Ar-4 |
| Ar-2 | Ar-3 | Ar-4 | Ar-5 |
| Ar-2 | Ar-3 | Ar-4 | Ar-6 |
| Ar-2 | Ar-3 | Ar-5 | Ar-2 |
| Ar-2 | Ar-3 | Ar-5 | Ar-3 |
| Ar-2 | Ar-3 | Ar-5 | Ar-4 |
| Ar-2 | Ar-3 | Ar-5 | Ar-5 |
| Ar-2 | Ar-3 | Ar-5 | Ar-6 |
| Ar-2 | Ar-3 | Ar-6 | Ar-2 |
| Ar-2 | Ar-3 | Ar-6 | Ar-3 |
| Ar-2 | Ar-3 | Ar-6 | Ar-4 |
| Ar-2 | Ar-3 | Ar-6 | Ar-5 |
| Ar-2 | Ar-3 | Ar-6 | Ar-6 |
| Ar-2 | Ar-4 | Ar-1 | Ar-3 |
| Ar-2 | Ar-4 | Ar-1 | Ar-4 |
| Ar-2 | Ar-4 | Ar-1 | Ar-5 |
| Ar-2 | Ar-4 | Ar-1 | Ar-6 |
| Ar-2 | Ar-4 | Ar-2 | Ar-3 |
| Ar-2 | Ar-4 | Ar-2 | Ar-4 |
| Ar-2 | Ar-4 | Ar-2 | Ar-5 |
| Ar-2 | Ar-4 | Ar-2 | Ar-6 |
| Ar-2 | Ar-4 | Ar-3 | Ar-3 |
| Ar-2 | Ar-4 | Ar-3 | Ar-4 |
| Ar-2 | Ar-4 | Ar-3 | Ar-5 |
| Ar-2 | Ar-4 | Ar-3 | Ar-6 |

TABLE 11

| R1 | R3 | R4 | R6 |
|---|---|---|---|
| Ar-2 | Ar-4 | Ar-4 | Ar-2 |
| Ar-2 | Ar-4 | Ar-4 | Ar-3 |
| Ar-2 | Ar-4 | Ar-4 | Ar-4 |
| Ar-2 | Ar-4 | Ar-4 | Ar-5 |
| Ar-2 | Ar-4 | Ar-4 | Ar-6 |
| Ar-2 | Ar-4 | Ar-5 | Ar-2 |
| Ar-2 | Ar-4 | Ar-5 | Ar-3 |
| Ar-2 | Ar-4 | Ar-5 | Ar-4 |
| Ar-2 | Ar-4 | Ar-5 | Ar-5 |
| Ar-2 | Ar-4 | Ar-5 | Ar-6 |
| Ar-2 | Ar-4 | Ar-6 | Ar-2 |
| Ar-2 | Ar-4 | Ar-6 | Ar-3 |
| Ar-2 | Ar-4 | Ar-6 | Ar-4 |
| Ar-2 | Ar-4 | Ar-6 | Ar-5 |
| Ar-2 | Ar-4 | Ar-6 | Ar-6 |
| Ar-2 | Ar-5 | Ar-1 | Ar-3 |
| Ar-2 | Ar-5 | Ar-1 | Ar-4 |
| Ar-2 | Ar-5 | Ar-1 | Ar-5 |
| Ar-2 | Ar-5 | Ar-1 | Ar-6 |
| Ar-2 | Ar-5 | Ar-2 | Ar-3 |
| Ar-2 | Ar-5 | Ar-2 | Ar-4 |
| Ar-2 | Ar-5 | Ar-2 | Ar-5 |
| Ar-2 | Ar-5 | Ar-2 | Ar-6 |
| Ar-2 | Ar-5 | Ar-3 | Ar-3 |
| Ar-2 | Ar-5 | Ar-3 | Ar-4 |
| Ar-2 | Ar-5 | Ar-3 | Ar-5 |
| Ar-2 | Ar-5 | Ar-3 | Ar-6 |
| Ar-2 | Ar-5 | Ar-4 | Ar-3 |
| Ar-2 | Ar-5 | Ar-4 | Ar-4 |
| Ar-2 | Ar-5 | Ar-4 | Ar-5 |
| Ar-2 | Ar-5 | Ar-4 | Ar-6 |

TABLE 12

| R1 | R3 | R4 | R6 |
|---|---|---|---|
| Ar-2 | Ar-5 | Ar-5 | Ar-2 |
| Ar-2 | Ar-5 | Ar-5 | Ar-3 |
| Ar-2 | Ar-5 | Ar-5 | Ar-4 |
| Ar-2 | Ar-5 | Ar-5 | Ar-5 |
| Ar-2 | Ar-5 | Ar-5 | Ar-6 |
| Ar-2 | Ar-5 | Ar-6 | Ar-2 |
| Ar-2 | Ar-5 | Ar-6 | Ar-3 |
| Ar-2 | Ar-5 | Ar-6 | Ar-4 |
| Ar-2 | Ar-5 | Ar-6 | Ar-5 |
| Ar-2 | Ar-5 | Ar-6 | Ar-6 |
| Ar-2 | Ar-6 | Ar-1 | Ar-3 |
| Ar-2 | Ar-6 | Ar-1 | Ar-4 |
| Ar-2 | Ar-6 | Ar-1 | Ar-5 |
| Ar-2 | Ar-6 | Ar-1 | Ar-6 |
| Ar-2 | Ar-6 | Ar-2 | Ar-3 |
| Ar-2 | Ar-6 | Ar-2 | Ar-4 |
| Ar-2 | Ar-6 | Ar-2 | Ar-5 |
| Ar-2 | Ar-6 | Ar-2 | Ar-6 |
| Ar-2 | Ar-6 | Ar-3 | Ar-3 |
| Ar-2 | Ar-6 | Ar-3 | Ar-4 |
| Ar-2 | Ar-6 | Ar-3 | Ar-5 |
| Ar-2 | Ar-6 | Ar-3 | Ar-6 |
| Ar-2 | Ar-6 | Ar-4 | Ar-3 |
| Ar-2 | Ar-6 | Ar-4 | Ar-4 |
| Ar-2 | Ar-6 | Ar-4 | Ar-5 |
| Ar-2 | Ar-6 | Ar-4 | Ar-6 |
| Ar-2 | Ar-6 | Ar-5 | Ar-3 |
| Ar-2 | Ar-6 | Ar-5 | Ar-4 |
| Ar-2 | Ar-6 | Ar-5 | Ar-5 |
| Ar-2 | Ar-6 | Ar-5 | Ar-6 |

TABLE 13

| R1 | R3 | R4 | R6 |
|---|---|---|---|
| Ar-2 | Ar-6 | Ar-6 | Ar-2 |
| Ar-2 | Ar-6 | Ar-6 | Ar-3 |
| Ar-2 | Ar-6 | Ar-6 | Ar-4 |
| Ar-2 | Ar-6 | Ar-6 | Ar-5 |
| Ar-2 | Ar-6 | Ar-6 | Ar-6 |
| Ar-3 | Ar-1 | Ar-1 | Ar-3 |
| Ar-3 | Ar-1 | Ar-1 | Ar-4 |
| Ar-3 | Ar-1 | Ar-1 | Ar-5 |
| Ar-3 | Ar-1 | Ar-1 | Ar-6 |
| Ar-3 | Ar-1 | Ar-2 | Ar-3 |
| Ar-3 | Ar-1 | Ar-2 | Ar-4 |
| Ar-3 | Ar-1 | Ar-2 | Ar-5 |
| Ar-3 | Ar-1 | Ar-2 | Ar-6 |
| Ar-3 | Ar-1 | Ar-3 | Ar-3 |
| Ar-3 | Ar-1 | Ar-3 | Ar-4 |
| Ar-3 | Ar-1 | Ar-3 | Ar-5 |
| Ar-3 | Ar-1 | Ar-3 | Ar-6 |
| Ar-3 | Ar-1 | Ar-4 | Ar-3 |
| Ar-3 | Ar-1 | Ar-4 | Ar-4 |
| Ar-3 | Ar-1 | Ar-4 | Ar-5 |
| Ar-3 | Ar-1 | Ar-4 | Ar-6 |
| Ar-3 | Ar-1 | Ar-5 | Ar-3 |
| Ar-3 | Ar-1 | Ar-5 | Ar-4 |
| Ar-3 | Ar-1 | Ar-5 | Ar-5 |
| Ar-3 | Ar-1 | Ar-5 | Ar-6 |
| Ar-3 | Ar-1 | Ar-6 | Ar-3 |
| Ar-3 | Ar-1 | Ar-6 | Ar-4 |
| Ar-3 | Ar-1 | Ar-6 | Ar-5 |
| Ar-3 | Ar-1 | Ar-6 | Ar-6 |
| Ar-3 | Ar-2 | Ar-1 | Ar-4 |
| Ar-3 | Ar-2 | Ar-1 | Ar-5 |

TABLE 14

| R1 | R3 | R4 | R6 |
|---|---|---|---|
| Ar-3 | Ar-2 | Ar-1 | Ar-6 |
| Ar-3 | Ar-2 | Ar-2 | Ar-3 |
| Ar-3 | Ar-2 | Ar-2 | Ar-4 |
| Ar-3 | Ar-2 | Ar-2 | Ar-5 |
| Ar-3 | Ar-2 | Ar-2 | Ar-6 |
| Ar-3 | Ar-2 | Ar-3 | Ar-3 |
| Ar-3 | Ar-2 | Ar-3 | Ar-4 |
| Ar-3 | Ar-2 | Ar-3 | Ar-5 |
| Ar-3 | Ar-2 | Ar-3 | Ar-6 |
| Ar-3 | Ar-2 | Ar-4 | Ar-3 |
| Ar-3 | Ar-2 | Ar-4 | Ar-4 |
| Ar-3 | Ar-2 | Ar-4 | Ar-5 |
| Ar-3 | Ar-2 | Ar-4 | Ar-6 |
| Ar-3 | Ar-2 | Ar-5 | Ar-3 |
| Ar-3 | Ar-2 | Ar-5 | Ar-4 |
| Ar-3 | Ar-2 | Ar-5 | Ar-5 |
| Ar-3 | Ar-2 | Ar-5 | Ar-6 |
| Ar-3 | Ar-2 | Ar-6 | Ar-3 |
| Ar-3 | Ar-2 | Ar-6 | Ar-4 |
| Ar-3 | Ar-2 | Ar-6 | Ar-5 |
| Ar-3 | Ar-2 | Ar-6 | Ar-6 |
| Ar-3 | Ar-3 | Ar-1 | Ar-4 |
| Ar-3 | Ar-3 | Ar-1 | Ar-5 |
| Ar-3 | Ar-3 | Ar-1 | Ar-6 |
| Ar-3 | Ar-3 | Ar-2 | Ar-4 |
| Ar-3 | Ar-3 | Ar-2 | Ar-5 |
| Ar-3 | Ar-3 | Ar-2 | Ar-6 |
| Ar-3 | Ar-3 | Ar-3 | Ar-3 |
| Ar-3 | Ar-3 | Ar-3 | Ar-4 |
| Ar-3 | Ar-3 | Ar-3 | Ar-5 |

TABLE 15

| R1 | R3 | R4 | R6 |
|---|---|---|---|
| Ar-3 | Ar-3 | Ar-3 | Ar-6 |
| Ar-3 | Ar-3 | Ar-4 | Ar-3 |
| Ar-3 | Ar-3 | Ar-4 | Ar-4 |
| Ar-3 | Ar-3 | Ar-4 | Ar-5 |
| Ar-3 | Ar-3 | Ar-4 | Ar-6 |
| Ar-3 | Ar-3 | Ar-5 | Ar-3 |
| Ar-3 | Ar-3 | Ar-5 | Ar-4 |
| Ar-3 | Ar-3 | Ar-5 | Ar-5 |
| Ar-3 | Ar-3 | Ar-5 | Ar-6 |
| Ar-3 | Ar-3 | Ar-6 | Ar-3 |
| Ar-3 | Ar-3 | Ar-6 | Ar-4 |
| Ar-3 | Ar-3 | Ar-6 | Ar-5 |
| Ar-3 | Ar-3 | Ar-6 | Ar-6 |
| Ar-3 | Ar-4 | Ar-1 | Ar-4 |
| Ar-3 | Ar-4 | Ar-1 | Ar-5 |
| Ar-3 | Ar-4 | Ar-1 | Ar-6 |
| Ar-3 | Ar-4 | Ar-2 | Ar-4 |
| Ar-3 | Ar-4 | Ar-2 | Ar-5 |
| Ar-3 | Ar-4 | Ar-2 | Ar-6 |
| Ar-3 | Ar-4 | Ar-3 | Ar-4 |
| Ar-3 | Ar-4 | Ar-3 | Ar-5 |
| Ar-3 | Ar-4 | Ar-3 | Ar-6 |
| Ar-3 | Ar-4 | Ar-4 | Ar-3 |
| Ar-3 | Ar-4 | Ar-4 | Ar-4 |
| Ar-3 | Ar-4 | Ar-4 | Ar-5 |
| Ar-3 | Ar-4 | Ar-4 | Ar-6 |
| Ar-3 | Ar-4 | Ar-5 | Ar-3 |
| Ar-3 | Ar-4 | Ar-5 | Ar-4 |
| Ar-3 | Ar-4 | Ar-5 | Ar-5 |
| Ar-3 | Ar-4 | Ar-5 | Ar-6 |

TABLE 16

| R1 | R3 | R4 | R6 |
|---|---|---|---|
| Ar-3 | Ar-4 | Ar-6 | Ar-3 |
| Ar-3 | Ar-4 | Ar-6 | Ar-4 |
| Ar-3 | Ar-4 | Ar-6 | Ar-5 |
| Ar-3 | Ar-4 | Ar-6 | Ar-6 |
| Ar-3 | Ar-5 | Ar-1 | Ar-4 |
| Ar-3 | Ar-5 | Ar-1 | Ar-5 |
| Ar-3 | Ar-5 | Ar-1 | Ar-6 |
| Ar-3 | Ar-5 | Ar-2 | Ar-4 |
| Ar-3 | Ar-5 | Ar-2 | Ar-5 |
| Ar-3 | Ar-5 | Ar-2 | Ar-6 |
| Ar-3 | Ar-5 | Ar-3 | Ar-4 |
| Ar-3 | Ar-5 | Ar-3 | Ar-5 |
| Ar-3 | Ar-5 | Ar-3 | Ar-6 |
| Ar-3 | Ar-5 | Ar-4 | Ar-4 |
| Ar-3 | Ar-5 | Ar-4 | Ar-5 |
| Ar-3 | Ar-5 | Ar-4 | Ar-6 |
| Ar-3 | Ar-5 | Ar-5 | Ar-3 |
| Ar-3 | Ar-5 | Ar-5 | Ar-4 |
| Ar-3 | Ar-5 | Ar-5 | Ar-5 |
| Ar-3 | Ar-5 | Ar-5 | Ar-6 |
| Ar-3 | Ar-5 | Ar-6 | Ar-3 |
| Ar-3 | Ar-5 | Ar-6 | Ar-4 |
| Ar-3 | Ar-5 | Ar-6 | Ar-5 |
| Ar-3 | Ar-5 | Ar-6 | Ar-6 |
| Ar-3 | Ar-6 | Ar-1 | Ar-4 |
| Ar-3 | Ar-6 | Ar-1 | Ar-5 |
| Ar-3 | Ar-6 | Ar-1 | Ar-6 |
| Ar-3 | Ar-6 | Ar-2 | Ar-4 |
| Ar-3 | Ar-6 | Ar-2 | Ar-5 |
| Ar-3 | Ar-6 | Ar-2 | Ar-6 |

TABLE 17

| R1 | R3 | R4 | R6 |
|---|---|---|---|
| Ar-3 | Ar-6 | Ar-3 | Ar-4 |
| Ar-3 | Ar-6 | Ar-3 | Ar-5 |
| Ar-3 | Ar-6 | Ar-3 | Ar-6 |
| Ar-3 | Ar-6 | Ar-4 | Ar-4 |
| Ar-3 | Ar-6 | Ar-4 | Ar-5 |
| Ar-3 | Ar-6 | Ar-4 | Ar-6 |
| Ar-3 | Ar-6 | Ar-5 | Ar-4 |
| Ar-3 | Ar-6 | Ar-5 | Ar-5 |
| Ar-3 | Ar-6 | Ar-5 | Ar-6 |
| Ar-3 | Ar-6 | Ar-6 | Ar-3 |
| Ar-3 | Ar-6 | Ar-6 | Ar-4 |
| Ar-3 | Ar-6 | Ar-6 | Ar-5 |
| Ar-3 | Ar-6 | Ar-6 | Ar-6 |
| Ar-4 | Ar-1 | Ar-1 | Ar-4 |
| Ar-4 | Ar-1 | Ar-1 | Ar-5 |
| Ar-4 | Ar-1 | Ar-1 | Ar-6 |
| Ar-4 | Ar-1 | Ar-2 | Ar-4 |
| Ar-4 | Ar-1 | Ar-2 | Ar-5 |
| Ar-4 | Ar-1 | Ar-2 | Ar-6 |
| Ar-4 | Ar-1 | Ar-3 | Ar-4 |
| Ar-4 | Ar-1 | Ar-3 | Ar-5 |
| Ar-4 | Ar-1 | Ar-3 | Ar-6 |
| Ar-4 | Ar-1 | Ar-4 | Ar-4 |
| Ar-4 | Ar-1 | Ar-4 | Ar-5 |
| Ar-4 | Ar-1 | Ar-4 | Ar-6 |
| Ar-4 | Ar-1 | Ar-5 | Ar-4 |
| Ar-4 | Ar-1 | Ar-5 | Ar-6 |
| Ar-4 | Ar-1 | Ar-5 | Ar-6 |
| Ar-4 | Ar-1 | Ar-6 | Ar-4 |
| Ar-4 | Ar-1 | Ar-6 | Ar-5 |
| Ar-4 | Ar-1 | Ar-6 | Ar-6 |

TABLE 18

| R1 | R3 | R4 | R6 |
|---|---|---|---|
| Ar-4 | Ar-2 | Ar-1 | Ar-5 |
| Ar-4 | Ar-2 | Ar-1 | Ar-6 |
| Ar-4 | Ar-2 | Ar-2 | Ar-4 |
| Ar-4 | Ar-2 | Ar-2 | Ar-5 |
| Ar-4 | Ar-2 | Ar-2 | Ar-6 |
| Ar-4 | Ar-2 | Ar-3 | Ar-4 |
| Ar-4 | Ar-2 | Ar-3 | Ar-5 |
| Ar-4 | Ar-2 | Ar-3 | Ar-6 |
| Ar-4 | Ar-2 | Ar-4 | Ar-4 |
| Ar-4 | Ar-2 | Ar-4 | Ar-5 |
| Ar-4 | Ar-2 | Ar-4 | Ar-6 |
| Ar-4 | Ar-2 | Ar-5 | Ar-4 |
| Ar-4 | Ar-2 | Ar-5 | Ar-5 |
| Ar-4 | Ar-2 | Ar-5 | Ar-6 |
| Ar-4 | Ar-2 | Ar-6 | Ar-4 |
| Ar-4 | Ar-2 | Ar-6 | Ar-5 |
| Ar-4 | Ar-2 | Ar-6 | Ar-6 |
| Ar-4 | Ar-3 | Ar-1 | Ar-5 |
| Ar-4 | Ar-3 | Ar-1 | Ar-6 |
| Ar-4 | Ar-3 | Ar-2 | Ar-5 |
| Ar-4 | Ar-3 | Ar-2 | Ar-6 |
| Ar-4 | Ar-3 | Ar-3 | Ar-4 |
| Ar-4 | Ar-3 | Ar-3 | Ar-5 |
| Ar-4 | Ar-3 | Ar-3 | Ar-6 |
| Ar-4 | Ar-3 | Ar-4 | Ar-4 |
| Ar-4 | Ar-3 | Ar-4 | Ar-5 |
| Ar-4 | Ar-3 | Ar-4 | Ar-6 |
| Ar-4 | Ar-3 | Ar-5 | Ar-4 |
| Ar-4 | Ar-3 | Ar-5 | Ar-5 |
| Ar-4 | Ar-3 | Ar-5 | Ar-6 |

TABLE 19

| R1 | R3 | R4 | R6 |
|---|---|---|---|
| Ar-4 | Ar-3 | Ar-6 | Ar-4 |
| Ar-4 | Ar-3 | Ar-6 | Ar-5 |
| Ar-4 | Ar-3 | Ar-6 | Ar-6 |
| Ar-4 | Ar-4 | Ar-1 | Ar-5 |
| Ar-4 | Ar-4 | Ar-1 | Ar-6 |
| Ar-4 | Ar-4 | Ar-2 | Ar-5 |
| Ar-4 | Ar-4 | Ar-2 | Ar-6 |
| Ar-4 | Ar-4 | Ar-3 | Ar-5 |
| Ar-4 | Ar-4 | Ar-3 | Ar-6 |
| Ar-4 | Ar-4 | Ar-4 | Ar-4 |
| Ar-4 | Ar-4 | Ar-4 | Ar-5 |
| Ar-4 | Ar-4 | Ar-4 | Ar-6 |
| Ar-4 | Ar-4 | Ar-5 | Ar-4 |
| Ar-4 | Ar-4 | Ar-5 | Ar-5 |
| Ar-4 | Ar-4 | Ar-5 | Ar-6 |
| Ar-4 | Ar-4 | Ar-6 | Ar-4 |
| Ar-4 | Ar-4 | Ar-6 | Ar-5 |
| Ar-4 | Ar-4 | Ar-6 | Ar-6 |
| Ar-4 | Ar-5 | Ar-1 | Ar-5 |
| Ar-4 | Ar-5 | Ar-1 | Ar-6 |
| Ar-4 | Ar-5 | Ar-2 | Ar-5 |
| Ar-4 | Ar-5 | Ar-2 | Ar-6 |
| Ar-4 | Ar-5 | Ar-3 | Ar-5 |
| Ar-4 | Ar-5 | Ar-3 | Ar-6 |
| Ar-4 | Ar-5 | Ar-4 | Ar-5 |
| Ar-4 | Ar-5 | Ar-4 | Ar-6 |
| Ar-4 | Ar-5 | Ar-5 | Ar-4 |
| Ar-4 | Ar-5 | Ar-5 | Ar-5 |
| Ar-4 | Ar-5 | Ar-5 | Ar-6 |
| Ar-4 | Ar-5 | Ar-6 | Ar-4 |
| Ar-4 | Ar-5 | Ar-6 | Ar-5 |

TABLE 20

| R1 | R3 | R4 | R6 |
|---|---|---|---|
| Ar-4 | Ar-5 | Ar-6 | Ar-6 |
| Ar-4 | Ar-6 | Ar-1 | Ar-5 |
| Ar-4 | Ar-6 | Ar-1 | Ar-6 |
| Ar-4 | Ar-6 | Ar-2 | Ar-5 |
| Ar-4 | Ar-6 | Ar-2 | Ar-6 |
| Ar-4 | Ar-6 | Ar-3 | Ar-5 |
| Ar-4 | Ar-6 | Ar-3 | Ar-6 |
| Ar-4 | Ar-6 | Ar-4 | Ar-5 |
| Ar-4 | Ar-6 | Ar-4 | Ar-6 |
| Ar-4 | Ar-6 | Ar-5 | Ar-5 |
| Ar-4 | Ar-6 | Ar-5 | Ar-6 |
| Ar-4 | Ar-6 | Ar-6 | Ar-4 |
| Ar-4 | Ar-6 | Ar-6 | Ar-5 |
| Ar-4 | Ar-6 | Ar-6 | Ar-6 |
| Ar-5 | Ar-1 | Ar-1 | Ar-5 |
| Ar-5 | Ar-1 | Ar-1 | Ar-6 |
| Ar-5 | Ar-1 | Ar-2 | Ar-5 |
| Ar-5 | Ar-1 | Ar-2 | Ar-6 |
| Ar-5 | Ar-1 | Ar-3 | Ar-5 |
| Ar-5 | Ar-1 | Ar-3 | Ar-6 |
| Ar-5 | Ar-1 | Ar-4 | Ar-5 |
| Ar-5 | Ar-1 | Ar-4 | Ar-6 |
| Ar-5 | Ar-1 | Ar-5 | Ar-5 |
| Ar-5 | Ar-1 | Ar-5 | Ar-6 |
| Ar-5 | Ar-1 | Ar-6 | Ar-5 |
| Ar-5 | Ar-1 | Ar-6 | Ar-6 |
| Ar-5 | Ar-2 | Ar-1 | Ar-6 |
| Ar-5 | Ar-2 | Ar-2 | Ar-5 |
| Ar-5 | Ar-2 | Ar-2 | Ar-6 |
| Ar-5 | Ar-2 | Ar-3 | Ar-5 |
| Ar-5 | Ar-2 | Ar-3 | Ar-6 |

TABLE 21

| R1 | R3 | R4 | R6 |
|---|---|---|---|
| Ar-5 | Ar-2 | Ar-4 | Ar-5 |
| Ar-5 | Ar-2 | Ar-4 | Ar-6 |
| Ar-5 | Ar-2 | Ar-5 | Ar-5 |
| Ar-5 | Ar-2 | Ar-5 | Ar-6 |
| Ar-5 | Ar-2 | Ar-6 | Ar-5 |
| Ar-5 | Ar-2 | Ar-6 | Ar-6 |
| Ar-5 | Ar-3 | Ar-1 | Ar-6 |
| Ar-5 | Ar-3 | Ar-2 | Ar-6 |
| Ar-5 | Ar-3 | Ar-3 | Ar-5 |
| Ar-5 | Ar-3 | Ar-3 | Ar-6 |
| Ar-5 | Ar-3 | Ar-4 | Ar-5 |
| Ar-5 | Ar-3 | Ar-4 | Ar-6 |
| Ar-5 | Ar-3 | Ar-5 | Ar-5 |
| Ar-5 | Ar-3 | Ar-5 | Ar-6 |
| Ar-5 | Ar-3 | Ar-6 | Ar-5 |
| Ar-5 | Ar-3 | Ar-6 | Ar-6 |
| Ar-5 | Ar-4 | Ar-1 | Ar-6 |
| Ar-5 | Ar-4 | Ar-2 | Ar-6 |
| Ar-5 | Ar-4 | Ar-3 | Ar-6 |
| Ar-5 | Ar-4 | Ar-4 | Ar-5 |
| Ar-5 | Ar-4 | Ar-4 | Ar-6 |
| Ar-5 | Ar-4 | Ar-5 | Ar-5 |
| Ar-5 | Ar-4 | Ar-5 | Ar-6 |
| Ar-5 | Ar-4 | Ar-6 | Ar-5 |
| Ar-5 | Ar-4 | Ar-6 | Ar-6 |
| Ar-5 | Ar-5 | Ar-1 | Ar-6 |
| Ar-5 | Ar-5 | Ar-2 | Ar-6 |
| Ar-5 | Ar-5 | Ar-3 | Ar-6 |
| Ar-5 | Ar-5 | Ar-4 | Ar-6 |
| Ar-5 | Ar-5 | Ar-5 | Ar-5 |
| Ar-5 | Ar-5 | Ar-5 | Ar-6 |

TABLE 22

| R1 | R3 | R4 | R6 |
|---|---|---|---|
| Ar-5 | Ar-5 | Ar-6 | Ar-5 |
| Ar-5 | Ar-5 | Ar-6 | Ar-6 |
| Ar-5 | Ar-6 | Ar-1 | Ar-6 |
| Ar-5 | Ar-6 | Ar-2 | Ar-6 |
| Ar-5 | Ar-6 | Ar-3 | Ar-6 |
| Ar-5 | Ar-6 | Ar-4 | Ar-6 |
| Ar-5 | Ar-6 | Ar-5 | Ar-6 |
| Ar-5 | Ar-6 | Ar-6 | Ar-5 |
| Ar-5 | Ar-6 | Ar-6 | Ar-6 |
| Ar-6 | Ar-1 | Ar-1 | Ar-6 |
| Ar-6 | Ar-1 | Ar-2 | Ar-6 |
| Ar-6 | Ar-1 | Ar-3 | Ar-6 |
| Ar-6 | Ar-1 | Ar-4 | Ar-6 |
| Ar-6 | Ar-1 | Ar-5 | Ar-6 |
| Ar-6 | Ar-1 | Ar-6 | Ar-6 |
| Ar-6 | Ar-2 | Ar-2 | Ar-6 |
| Ar-6 | Ar-2 | Ar-3 | Ar-6 |
| Ar-6 | Ar-2 | Ar-4 | Ar-6 |
| Ar-6 | Ar-2 | Ar-5 | Ar-6 |
| Ar-6 | Ar-2 | Ar-6 | Ar-6 |
| Ar-6 | Ar-3 | Ar-3 | Ar-6 |
| Ar-6 | Ar-3 | Ar-4 | Ar-6 |
| Ar-6 | Ar-3 | Ar-5 | Ar-6 |
| Ar-6 | Ar-3 | Ar-6 | Ar-6 |
| Ar-6 | Ar-4 | Ar-4 | Ar-6 |
| Ar-6 | Ar-4 | Ar-5 | Ar-6 |
| Ar-6 | Ar-4 | Ar-6 | Ar-6 |
| Ar-6 | Ar-5 | Ar-5 | Ar-6 |
| Ar-6 | Ar-5 | Ar-6 | Ar-6 |
| Ar-6 | Ar-6 | Ar-6 | Ar-6 |

It is preferable that R² and R⁵ are any one of a hydrogen atom, an alkyl group, a carbonyl group, an oxycarbonyl group, or an aryl group. Among these, from the viewpoint of thermal stability, a hydrogen atom or an alkyl group is preferable, and from the viewpoint that it is easy to obtain a narrow half-width in the emission spectrum, a hydrogen atom is more preferable.

It is preferable that R⁸ and R⁹ are an alkyl group, an aryl group, a heteroaryl group, fluorine, a fluorine-containing alkyl group, a fluorine-containing heteroaryl group, or a fluorine-containing aryl group. In particular, since it is stable to the excitation light and a more excellent emission quantum yield is obtained, it is more preferable that R⁸ and R⁹ represent fluorine or a fluorine-containing aryl group. Furthermore, from the viewpoint of ease of synthesis, it is still more preferable that R⁸ and R⁹ are fluorine.

The fluorine-containing aryl group is an aryl group containing fluorine, and examples thereof include a fluorophenyl group, a trifluoromethylphenyl group, and a pentafluorophenyl group. The fluorine-containing heteroaryl group is a heteroaryl group containing fluorine, and examples thereof include a fluoropyridyl group, a trifluoromethylpyridyl group, and a trifluoropyridyl group. The fluorine-containing alkyl group is an alkyl group containing fluorine, and examples thereof include a trifluoromethyl group and a pentafluoroethyl group.

In General Formula (1), from the viewpoint of photostability, it is preferable that X is C—R⁷. In a case where X is C—R⁷, the substituent R⁷ has a great influence on durability of the compound represented by General Formula (1), that is, decrease in light emission intensity of the compound over time. Specifically, in a case where R⁷ is a hydrogen atom, since reactivity of this portion is high, moisture or oxygen in the air easily reacts with the portion. This may cause decomposition of the compound represented by General Formula (1). In addition, in a case where R⁷ represents a substituent having a high degree of freedom of molecular chain movement, such as an alkyl group, the reactivity is lowered, but the compounds aggregate with each other in the color conversion film over time, and as a result, concentration quenching may cause a decrease in light emission intensity. Therefore, it is preferable that R⁷ is a group which is rigid, has a small degree of freedom of movement, and is unlikely to cause aggregation, and specifically, it is preferable either a substituted or unsubstituted aryl group or a substituted or unsubstituted heteroaryl group.

From the viewpoint of providing more excellent emission quantum yield, less thermal decomposition, and photostability, it is preferable that X is C—R⁷ and R⁷ represents a substituted or unsubstituted aryl group. As the aryl group, from the viewpoint of not impairing a light emission wavelength, a phenyl group, a biphenyl group, a terphenyl group, a naphthyl group, a fluorenyl group, a phenanthryl group, or an anthracenyl group is preferable.

Further, in a case where the torsion is excessively large, in order to increase the photostability of the compound represented by General Formula (1), since the photostability decreases due to increased reactivity to the excitation light, it is preferable to moderately suppress torsion of the carbon-carbon bond between R⁷ and the pyrromethene skeleton.

From the above-described viewpoint, R⁷ preferably represents a substituted or unsubstituted phenyl group, a substituted or unsubstituted biphenyl group, a substituted or unsubstituted terphenyl group, or a substituted or unsubstituted naphthyl group, and more preferably represents a substituted or unsubstituted phenyl group, a substituted or unsubstituted biphenyl group, or a substituted or unsubstituted terphenyl group. R⁷ particularly preferably represents a substituted or unsubstituted phenyl group.

In addition, R⁷ preferably represents an appropriately bulky substituent. Since R⁷ has a certain degree of bulkiness, the aggregation of molecules can be prevented, and as a result, the light emission efficiency and durability of the compound represented by General Formula (1) are further improved.

More preferred examples of the bulky substituent include a structure of R⁷ represented by General Formula (2).

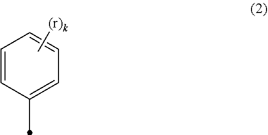

In General Formula (2), r is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, and a phosphine oxide group. k is an integer of 1 to 3. In a case where k is 2 or more, r's may be the same or different from each other.

From the viewpoint of emission quantum yield, r preferably represents a substituted or unsubstituted aryl group. Among the above-described aryl groups, particularly preferred examples of the aryl group include a phenyl group or a naphthyl group. In a case where r represents an aryl group, k in General Formula (2) is preferably 1 or 2, and from the viewpoint of further preventing aggregation of molecules, more preferably 2. Further, in a case where k is 2 or more, it is preferable that at least one of r is substituted with an alkyl group. From the viewpoint of thermal stability, particularly preferred examples of the alkyl group include a methyl group, an ethyl group, and a tert-butyl group.

From the viewpoint of control of fluorescence wavelength and absorption wavelength, and compatibility with the solvent, r is preferably a substituted or unsubstituted alkyl group, a substituted or unsubstituted alkoxy group, or halogen, and more preferably a methyl group, an ethyl group, a tert-butyl group, or a methoxy group. From the viewpoint of dispersibility, a tert-butyl group or a methoxy group is particularly preferable. The fact that r represents a tert-butyl group or a methoxy group is also effective from the viewpoint of preventing quenching due to the aggregation of molecules.

In addition, as another aspect of the compound represented by General Formula (1), it is preferable that at least one of R¹ to R⁷ represents an electron-attracting group.

In particular, it is preferable that (1) at least one of R¹ to R⁶ represents an electron-attracting group, (2) R⁷ represents an electron-attracting group, or (3) at least one of R¹ to R⁶ represents an electron-attracting group and R⁷ represents an electron-attracting group.

By introducing the electron-attracting group into the pyrromethene skeleton of the above-described compound, an electron density of the pyrromethene skeleton can be significantly reduced. Accordingly, the stability of the above-described compound with respect to oxygen is further improved, and as a result, the durability of the above-described compound can be further improved.

The electron-attracting group is also called as an electron-accepting group, and is an atomic group which attracts an electron from the substituted atomic group by an inductive effect or a resonance effect in organic electron theory. Examples of the electron-attracting group include groups having a positive value as the substituent constant (σp (para)) of Hammett's law. The substituent constant (σp (para)) of Hammett's law can be quoted from the 5th edition of the Basics of Chemistry Handbook (page 380 of II). In some cases, the phenyl group also takes a positive value as described above, but in the present disclosure, the electron-attracting group does not include the phenyl group.

Examples of the electron-attracting group include —F (σp: +0.06), —Cl (σp: +0.23), —Br (σp: +0.23), —I (σp: +0.18), —CO₂R¹² (σp: +0.45 in a case where R¹² is an ethyl group), —CONH₂ (σp: +0.38), —COR¹² (σp: +0.49 in a case where Rig is a methyl group), —CF₃ (σp: +0.50), —SO₂R¹² (σp: +0.69 in a case where R¹² is a methyl group), and —NO₂ (σp: +0.81).

Rig's each independently represent a hydrogen atom, a substituted or unsubstituted aromatic hydrocarbon group having 6 to 30 ring-forming carbon atoms, a substituted or unsubstituted heterocyclic group having 5 to 30 ring-forming carbon atoms, a substituted or unsubstituted alkyl group having 1 to 30 carbon atoms, or a substituted or unsubstituted cycloalkyl group having 1 to 30 carbon atoms. Specific examples of each of these groups include the same examples as described above.

From the viewpoint of decomposability, preferred examples of the electron-attracting group include fluorine, a fluorine-containing aryl group, a fluorine-containing heteroaryl group, a fluorine-containing alkyl group, a substituted or unsubstituted acyl group, a substituted or unsubstituted ester group, a substituted or unsubstituted amide group, a substituted or unsubstituted sulfonyl group, and a cyano group.

More preferred examples of the electron-attracting group include a fluorine-containing alkyl group, a fluorine-containing aryl group, a substituted or unsubstituted acyl group, a substituted or unsubstituted ester group, and a cyano group.

According to the electron-attracting group described above, the concentration quenching can be prevented and the emission quantum yield can be improved. The electron-attracting group is particularly preferably a substituted or unsubstituted ester group.

Preferred examples of the compound represented by General Formula (1), which can be suitably used as the organic light-emitting material, include a case where all of R¹, R³, R⁴, and R⁶ are each independently a substituted or unsubstituted alkyl group, X is C—R⁷, and R⁷ represents the group represented by General Formula (2). In this case, it is particularly preferable that R⁷ represents the group represented by General Formula (2), in which r is a substituted or unsubstituted phenyl group.

Examples of the compound represented by General Formula (1) are shown below, but the compound is not limited thereto.

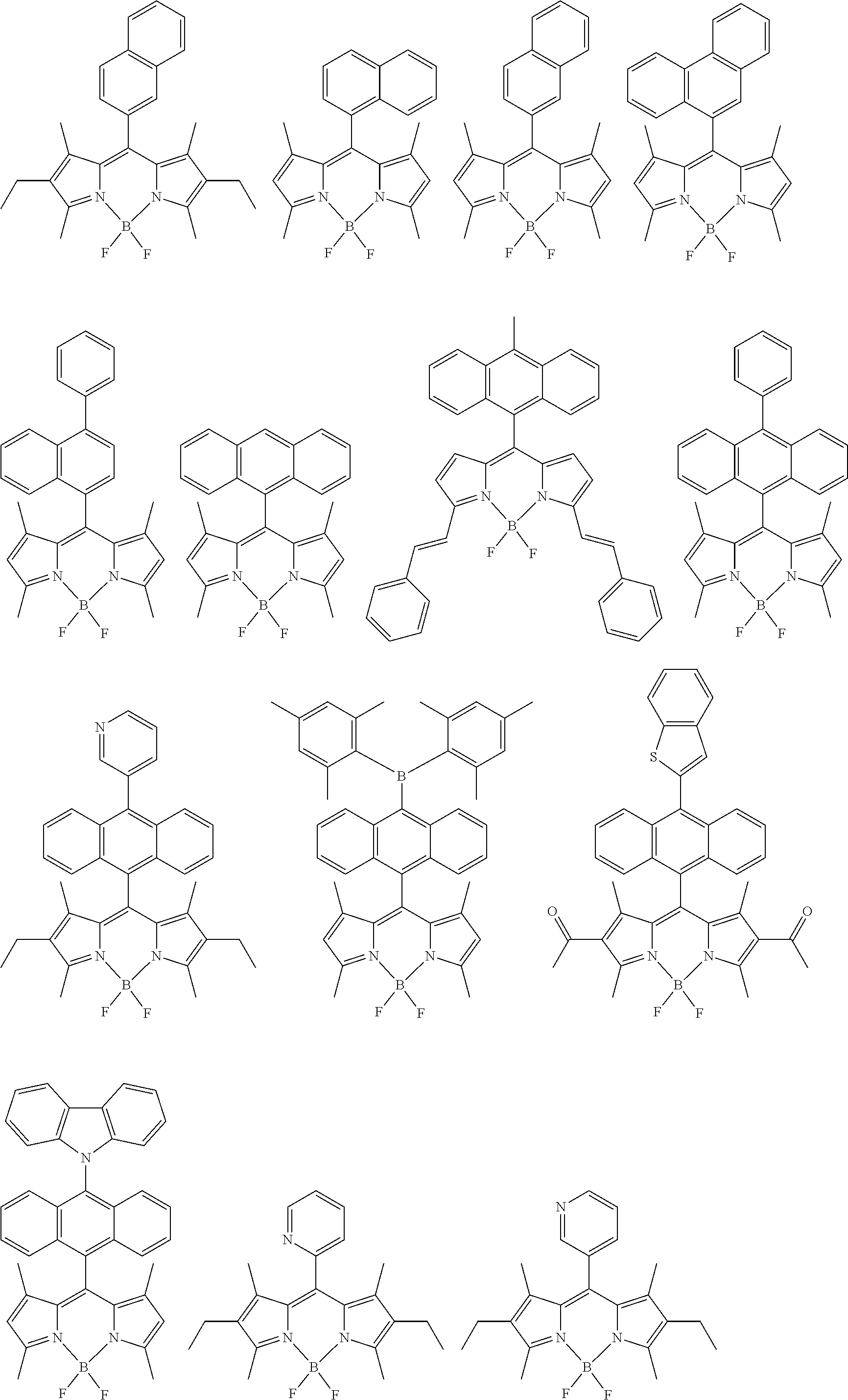

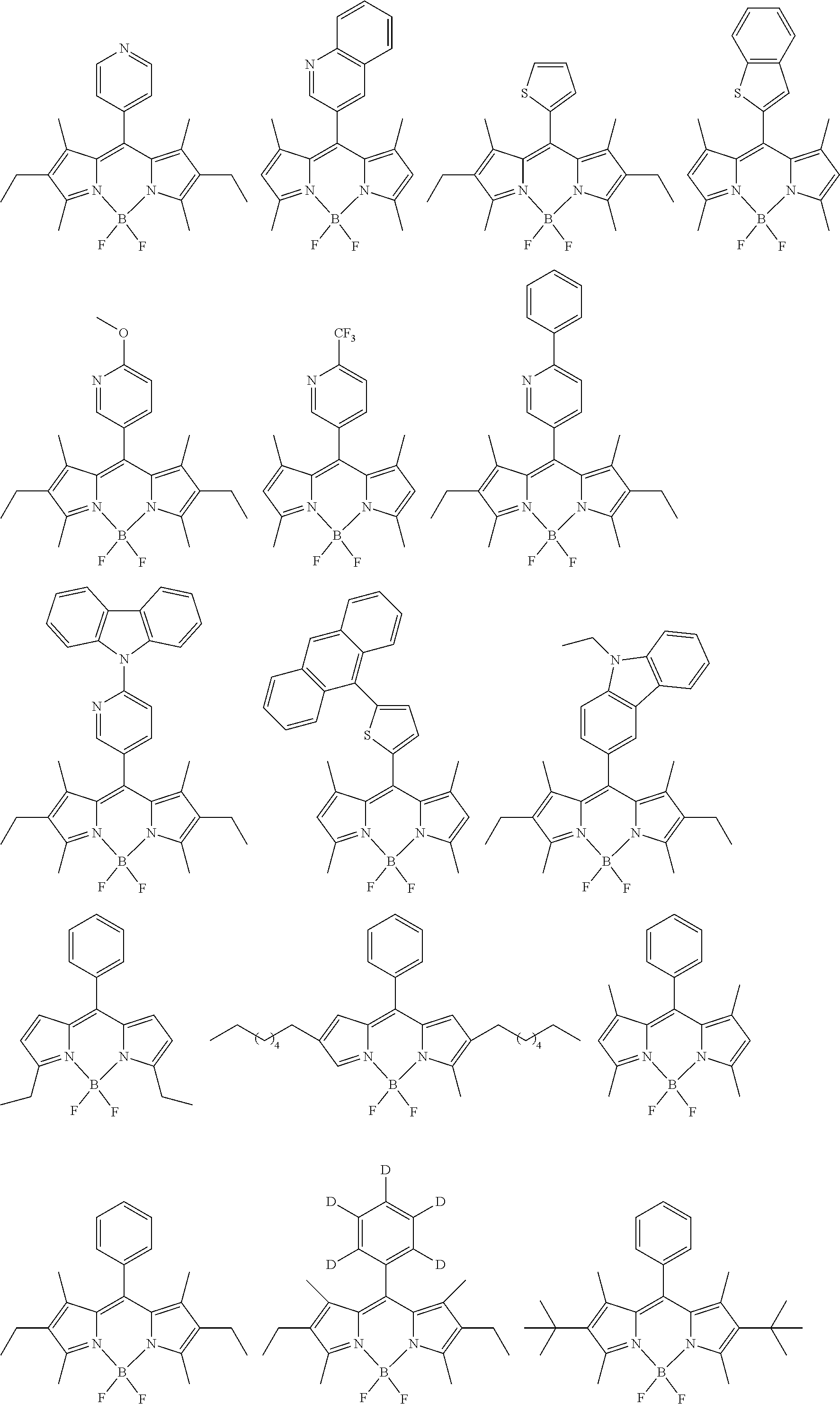

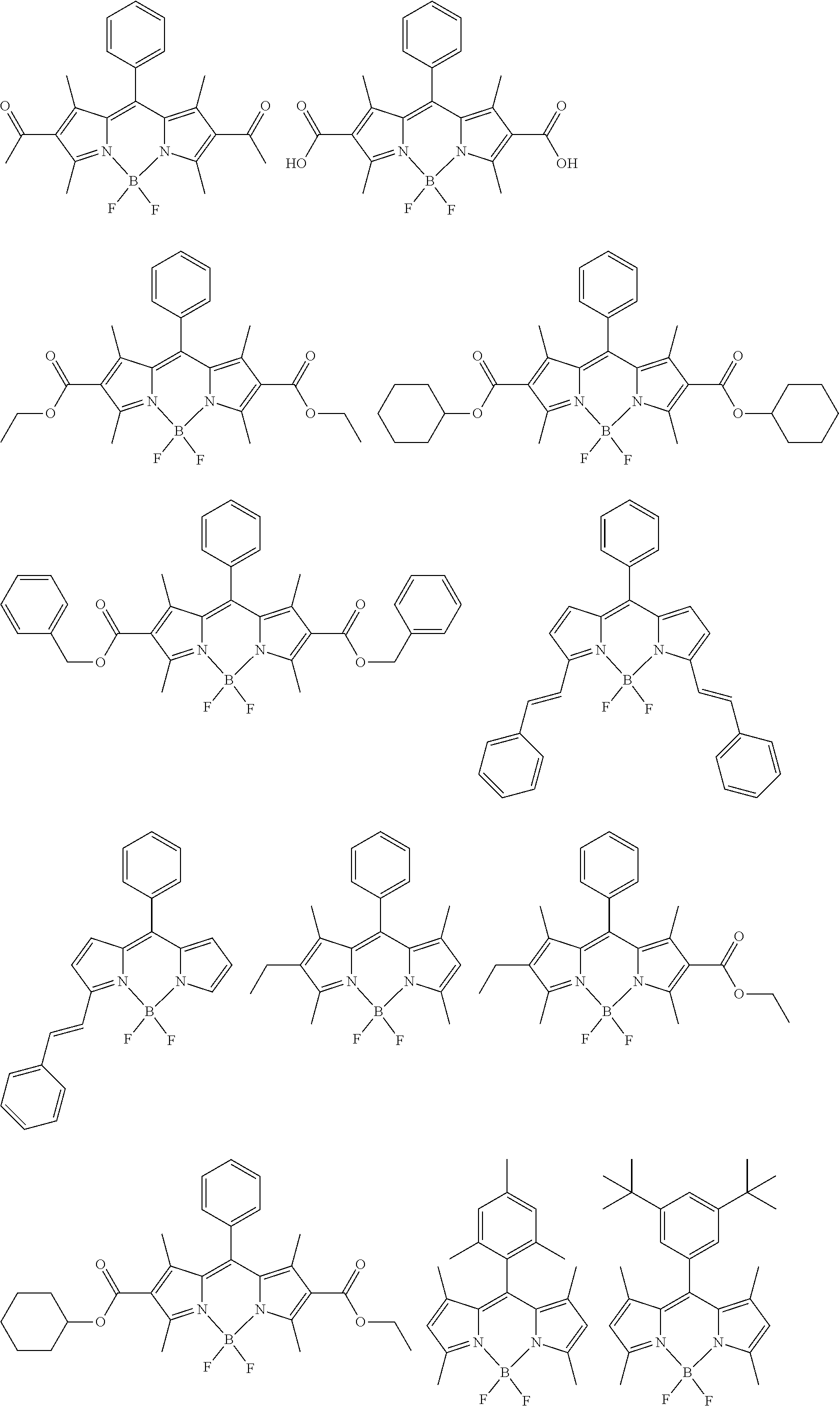

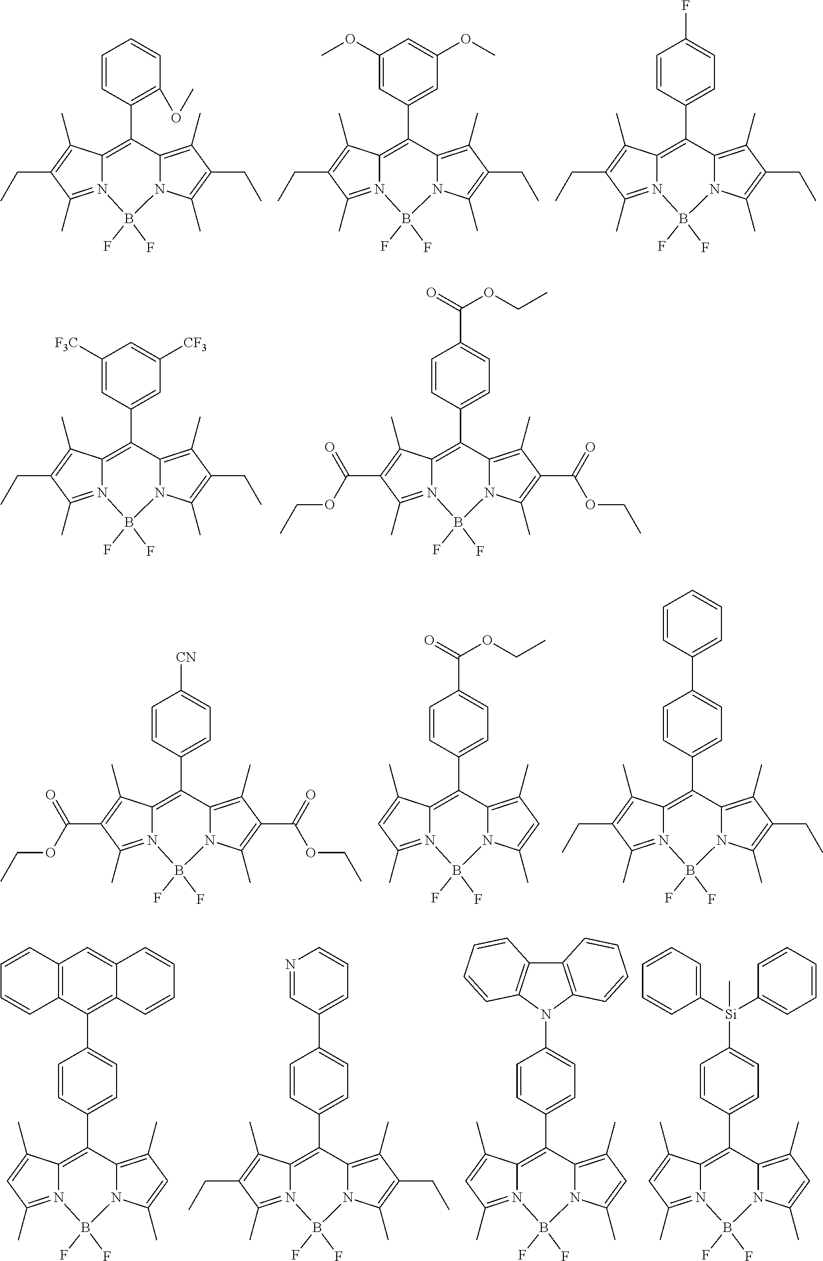

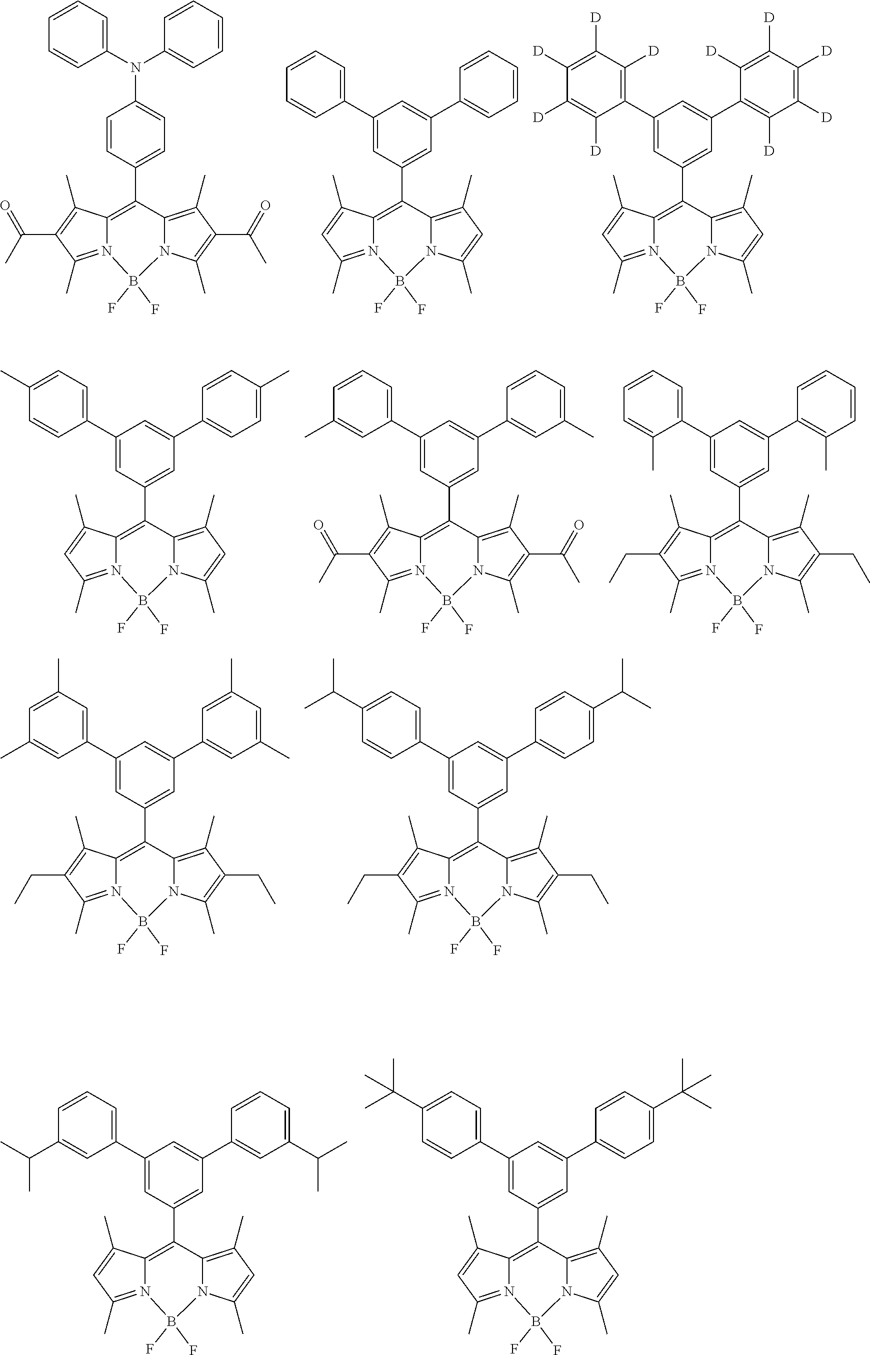

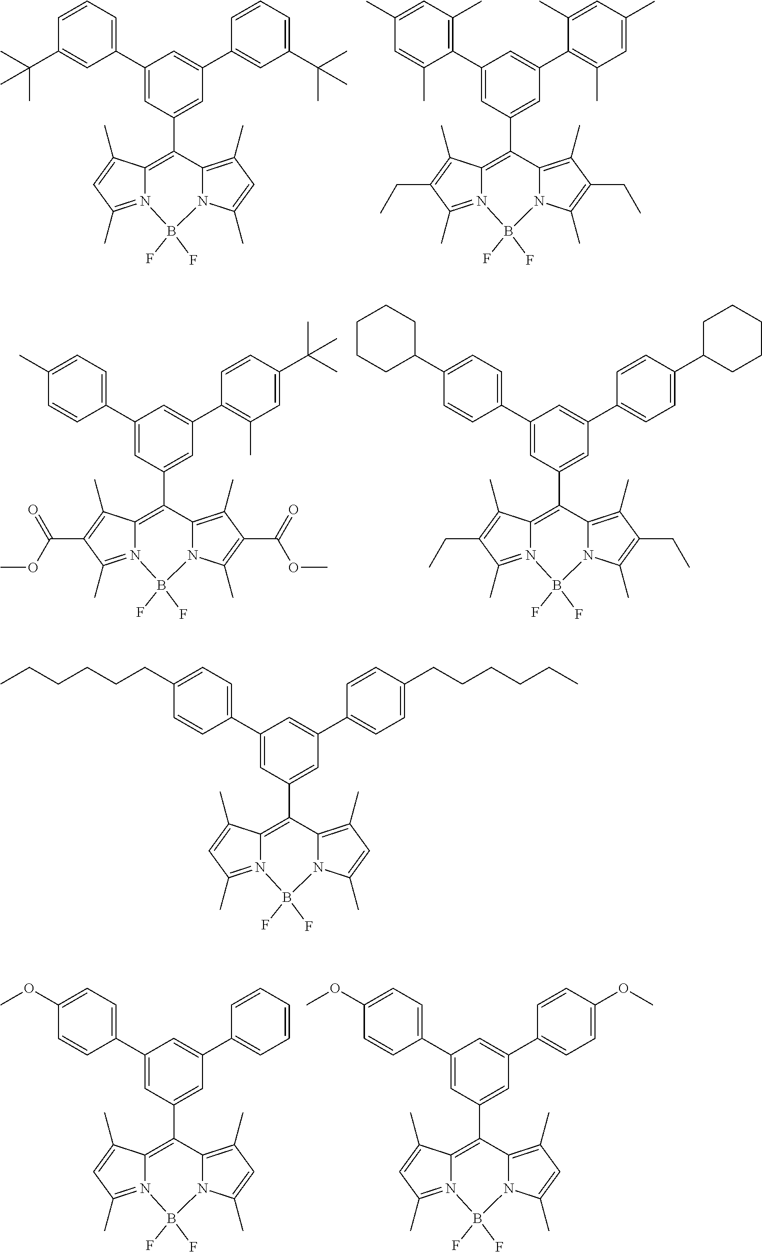

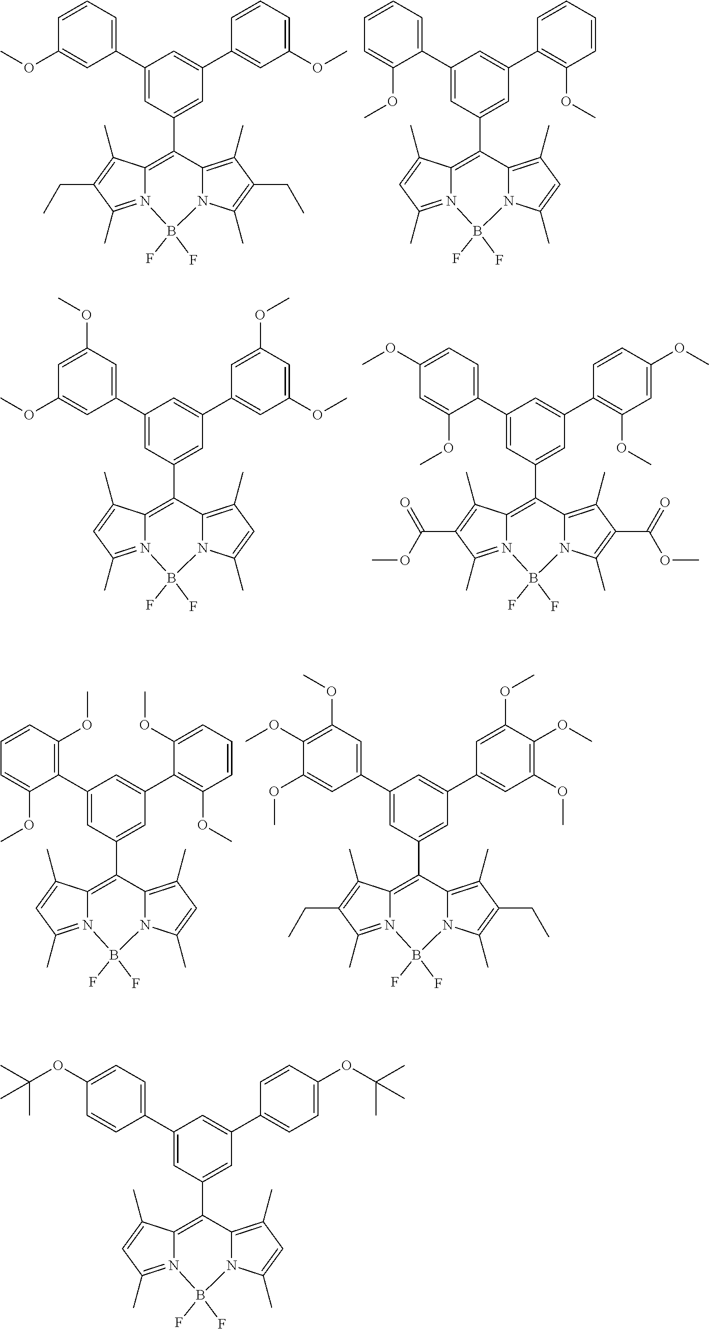

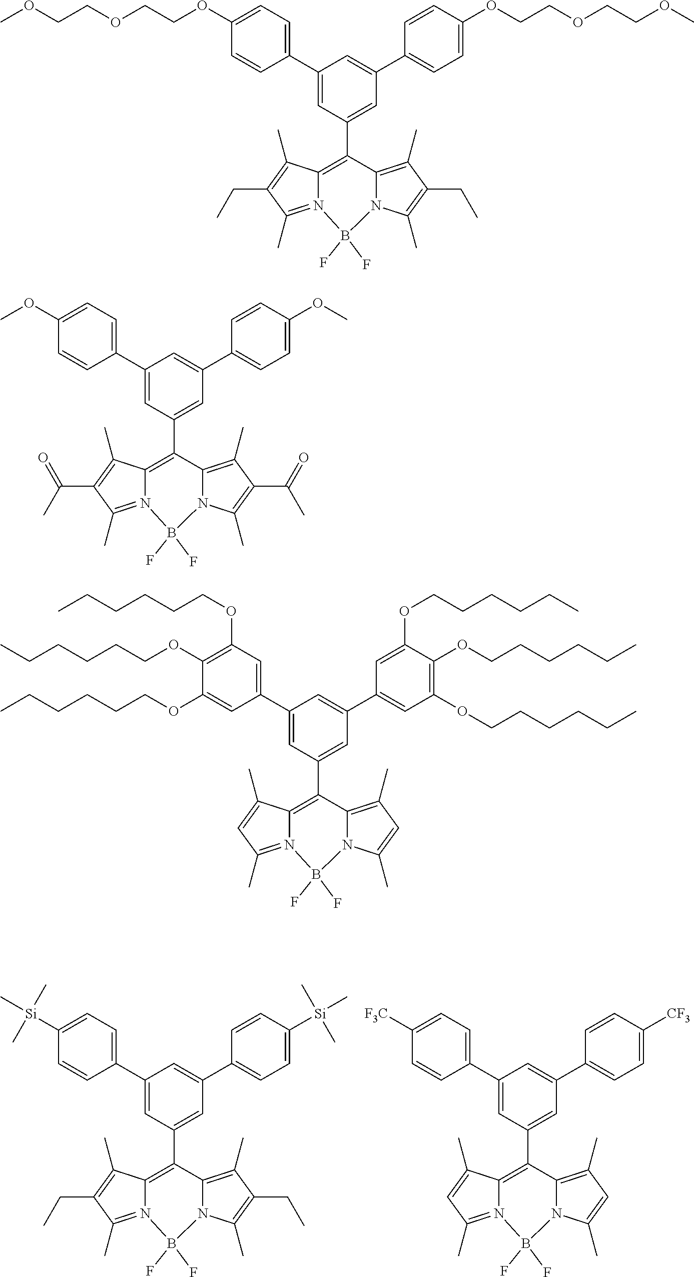

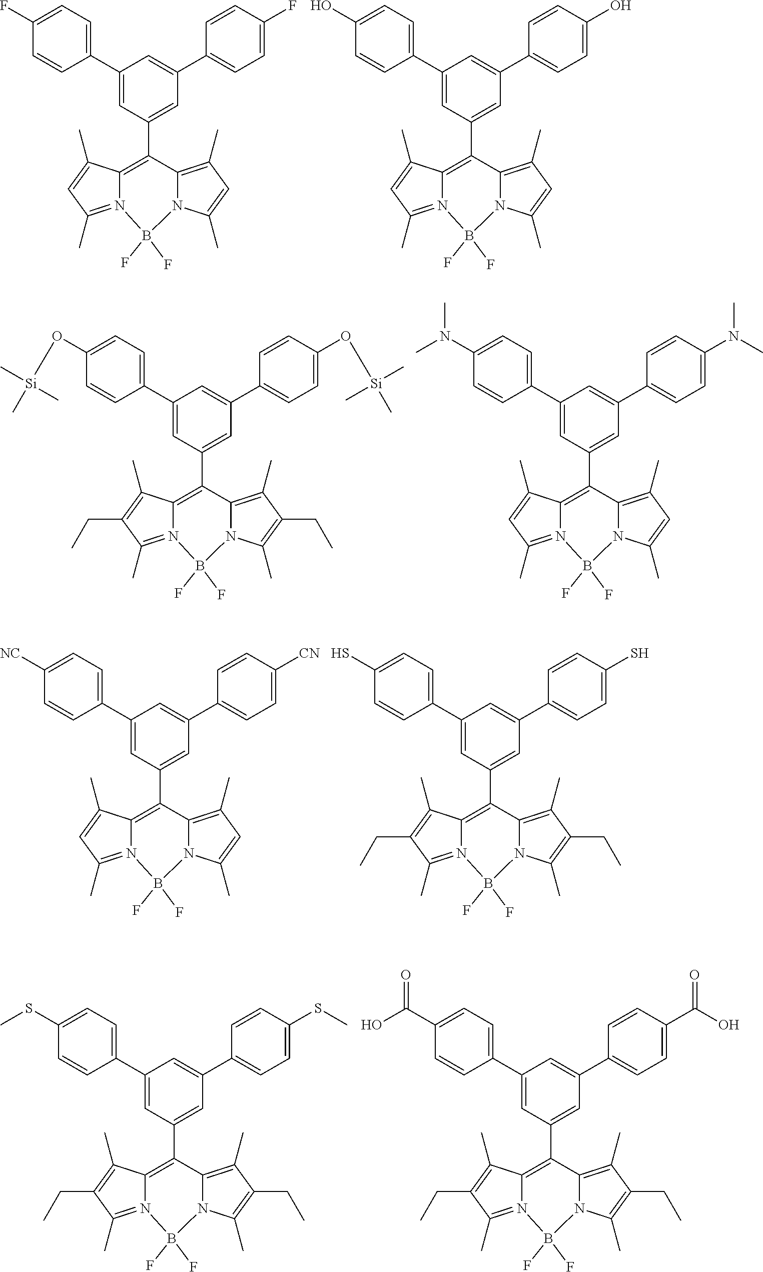

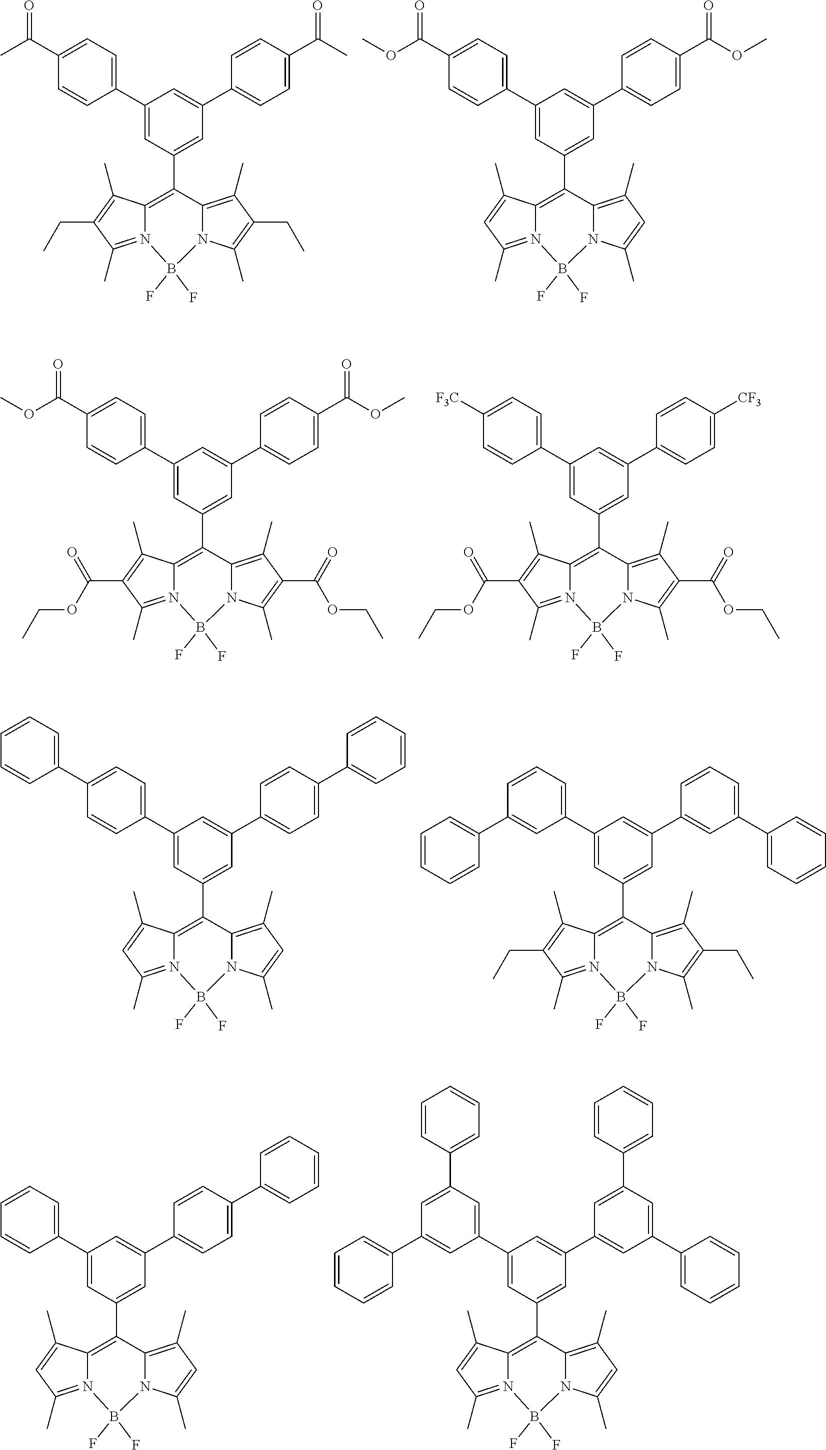

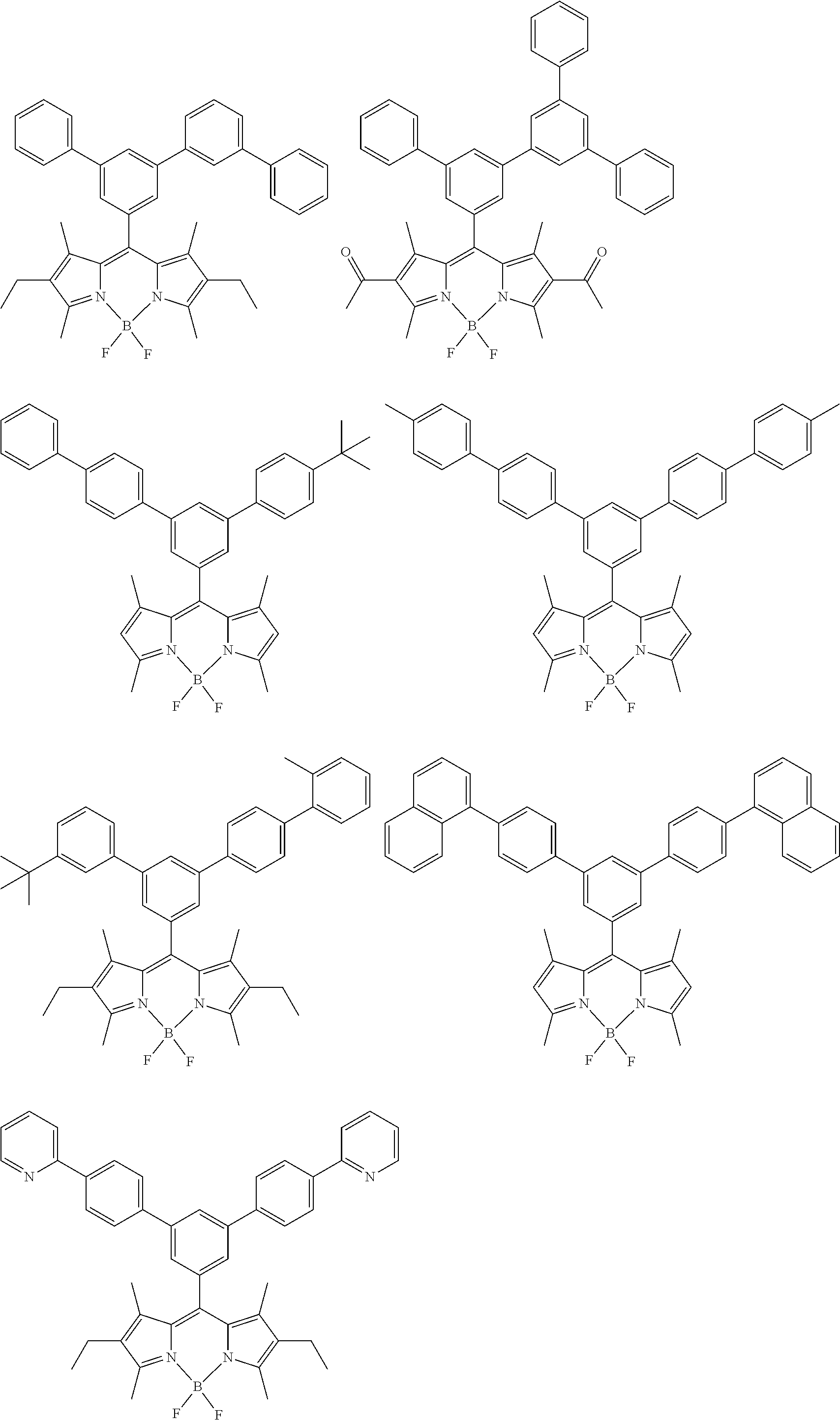

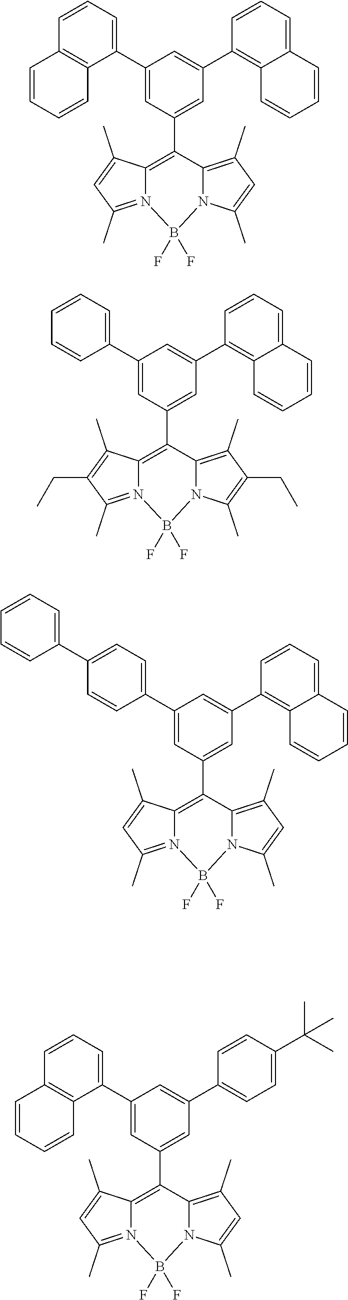

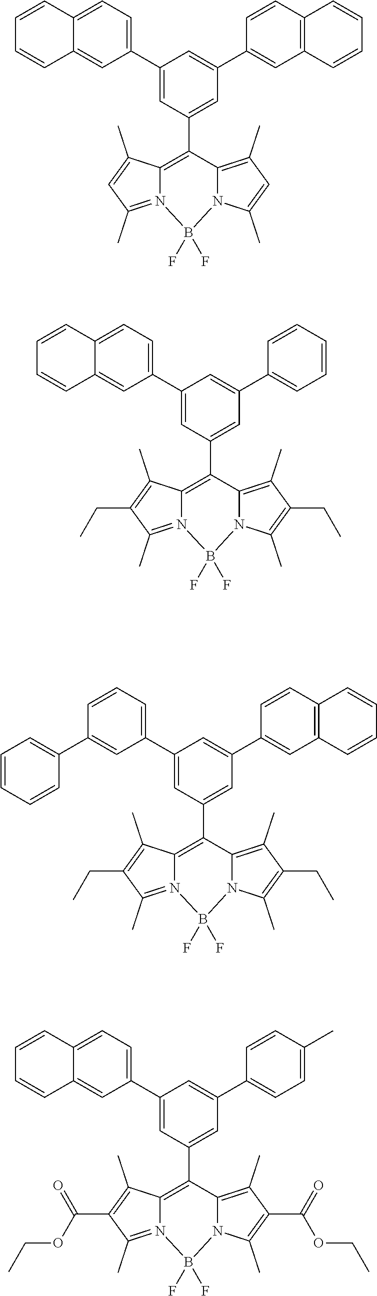

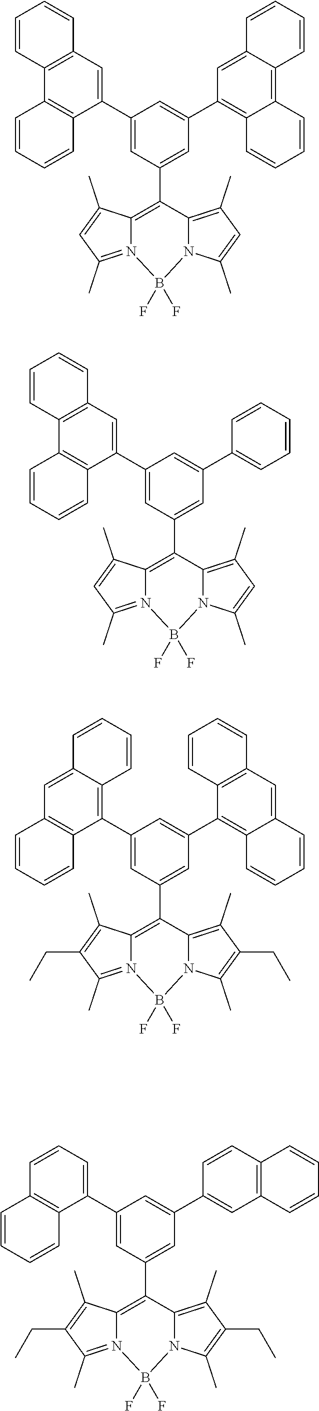

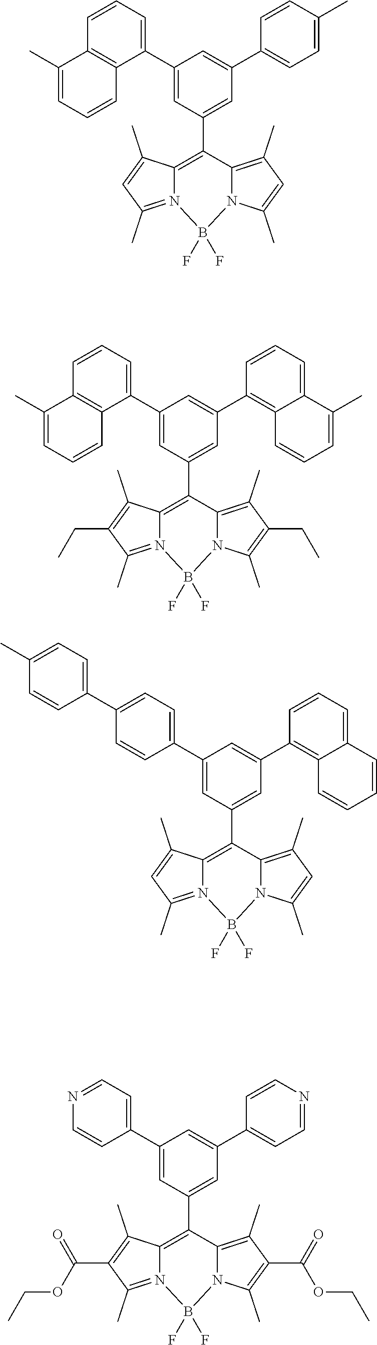

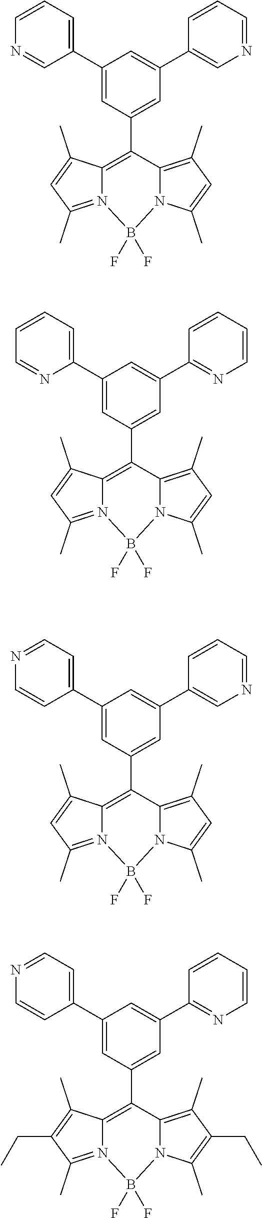

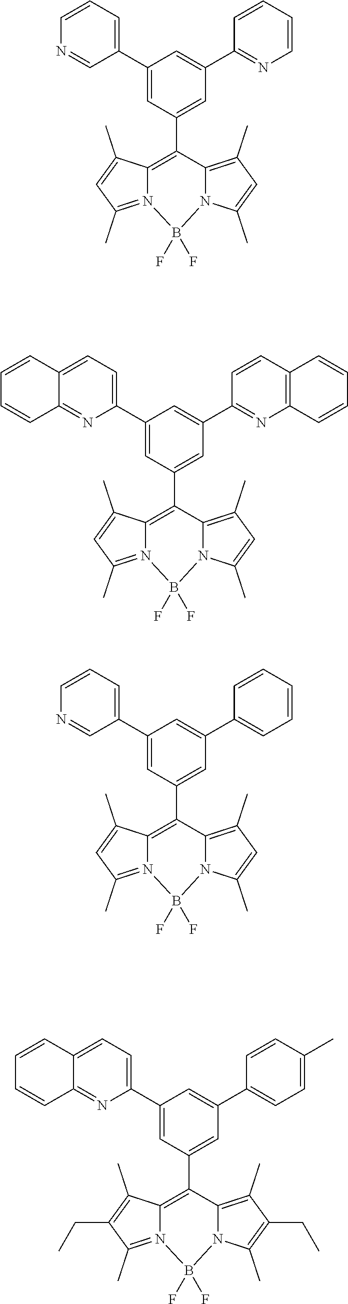

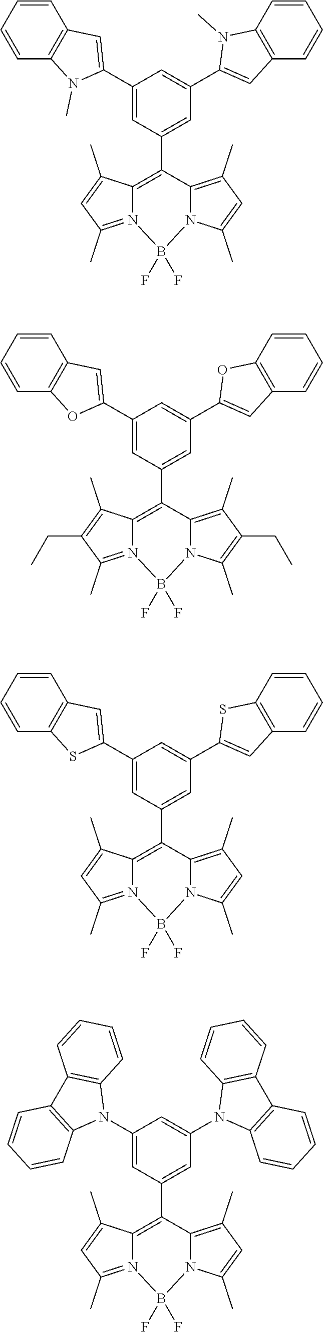

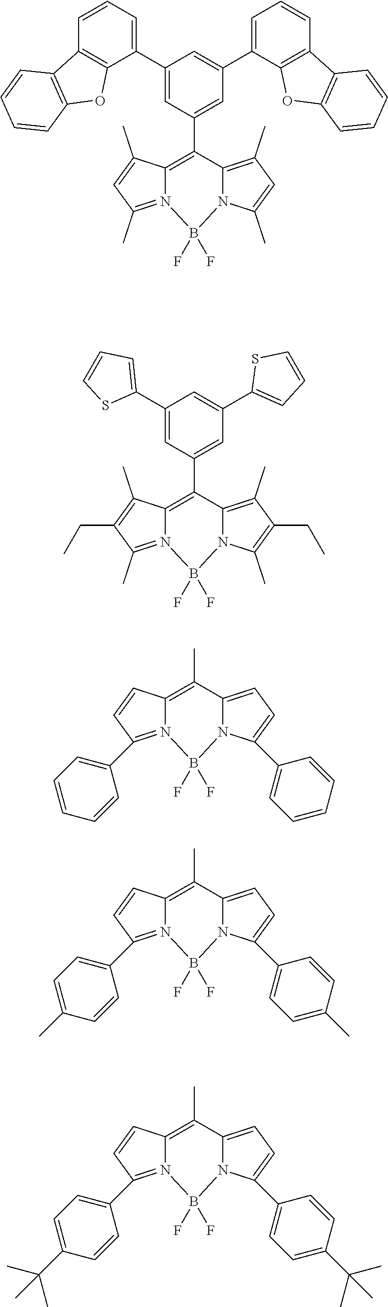

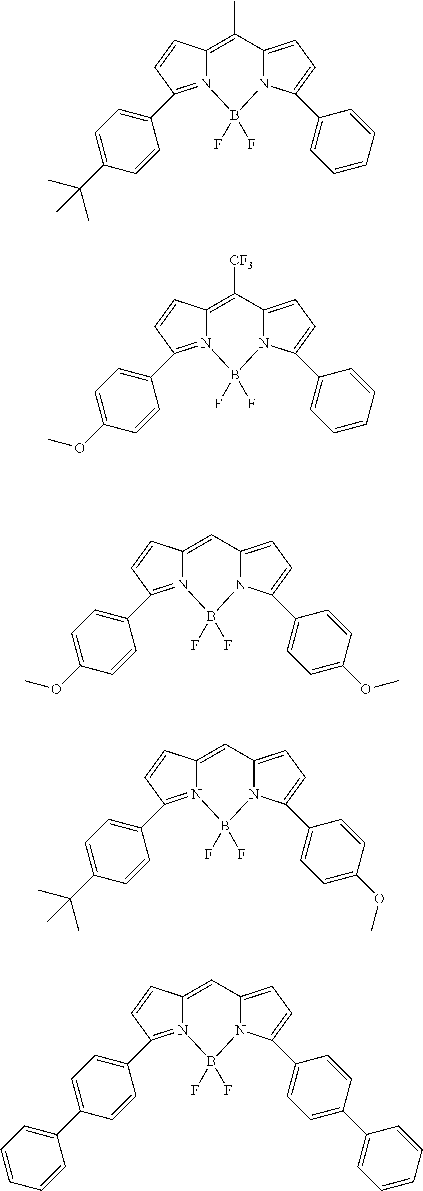

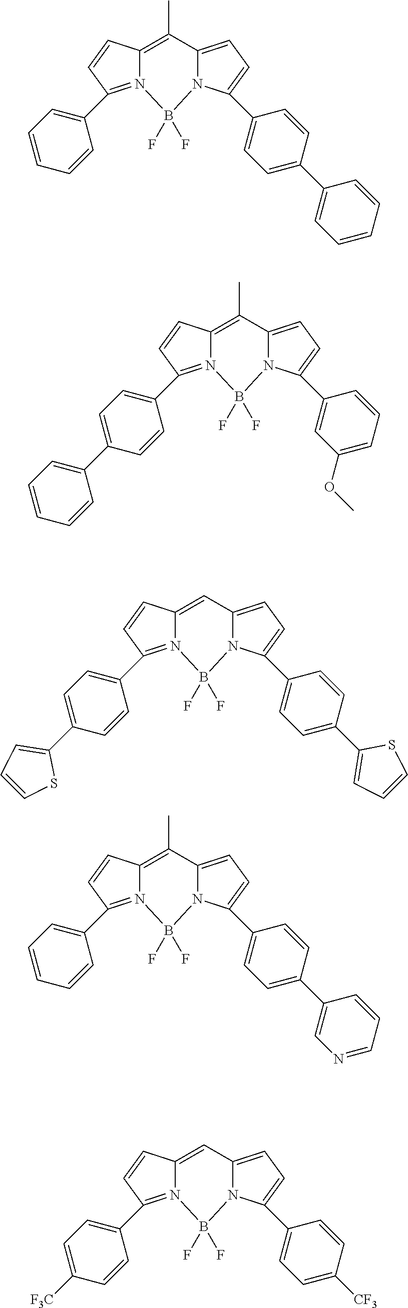

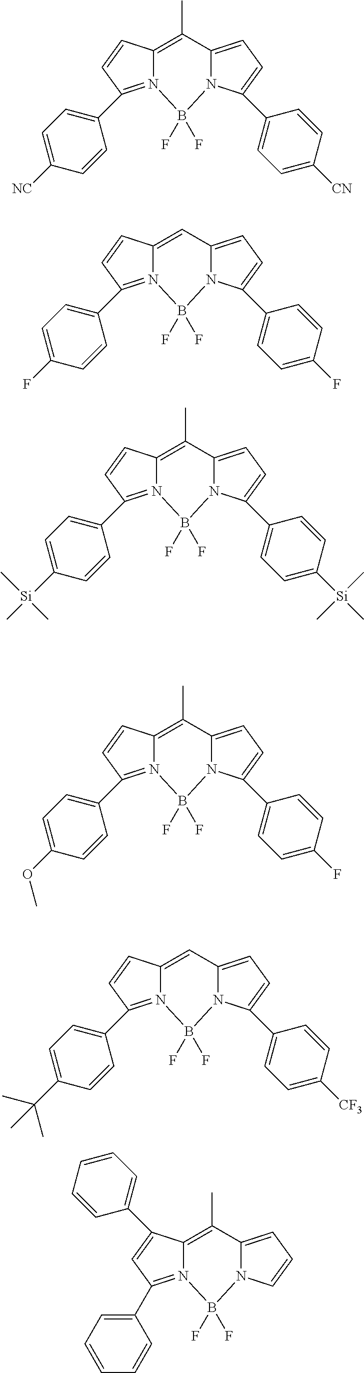

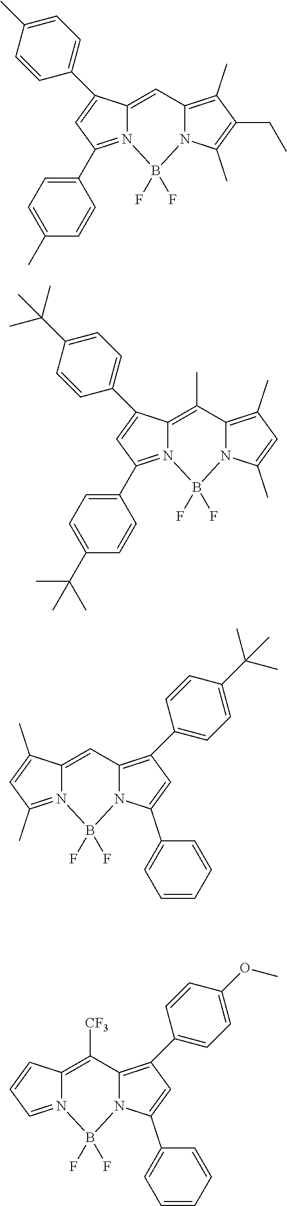

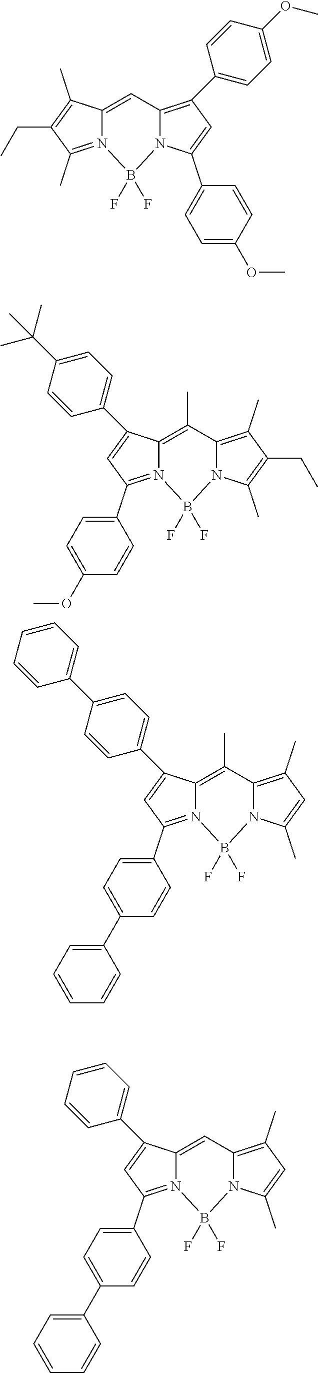

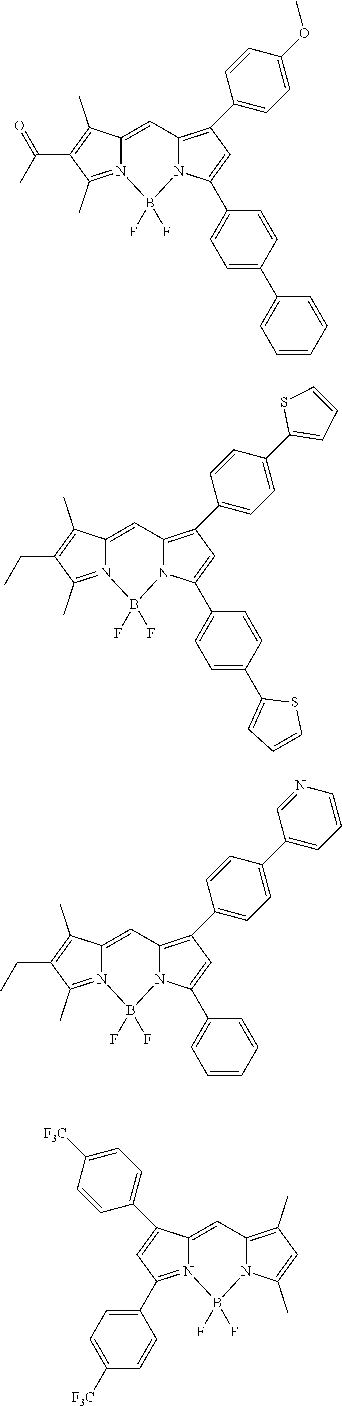

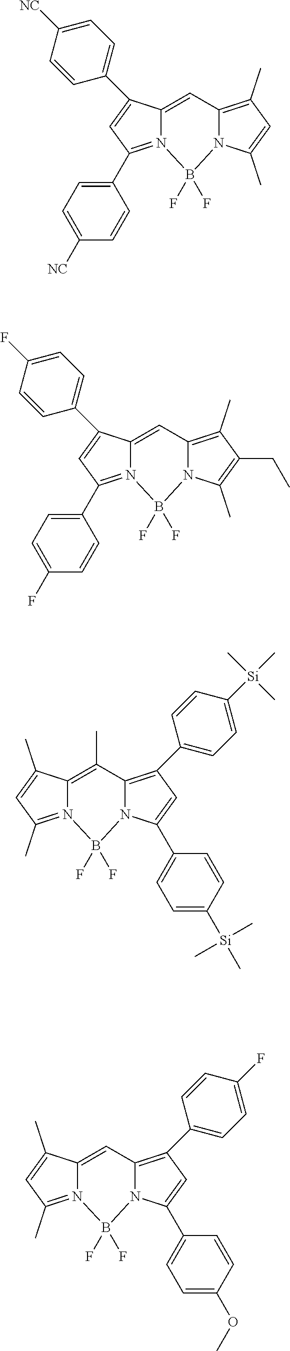

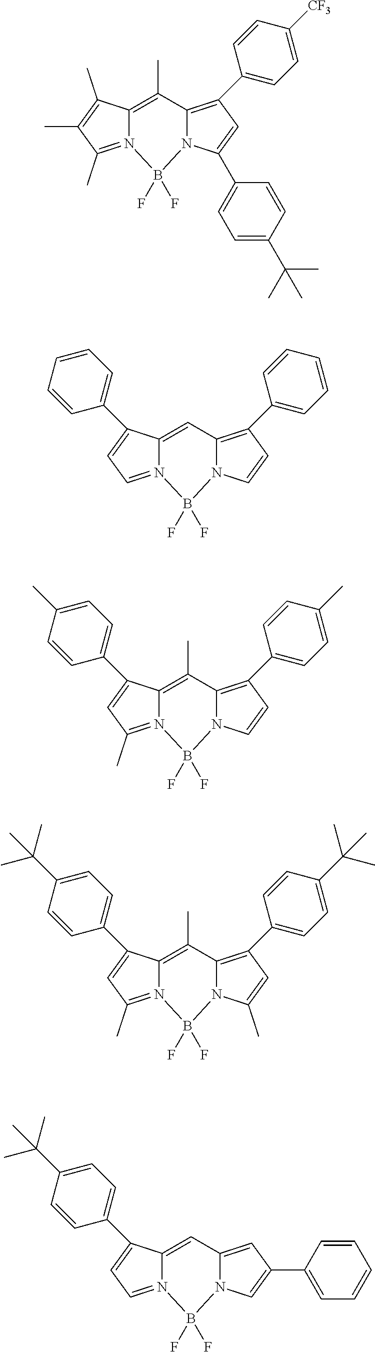

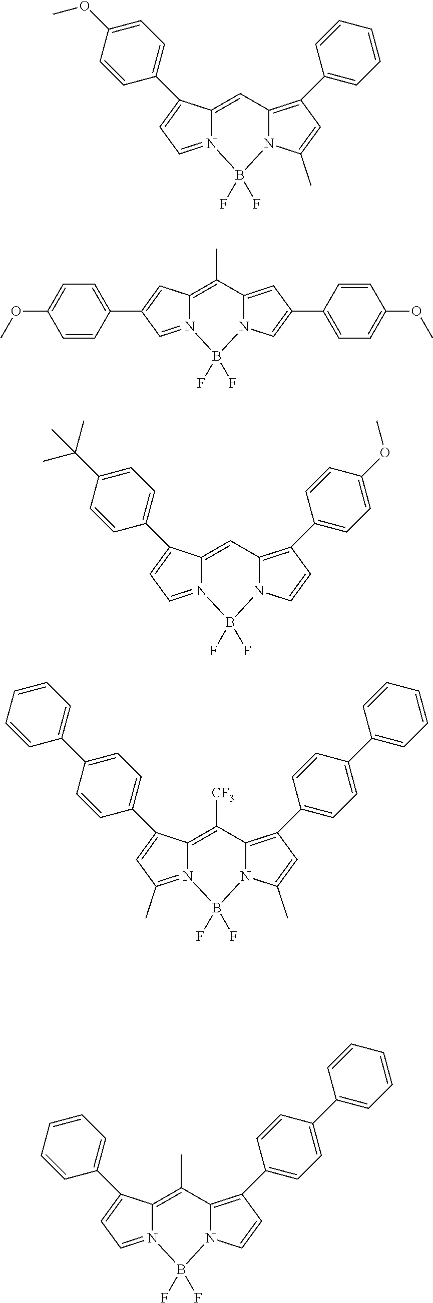

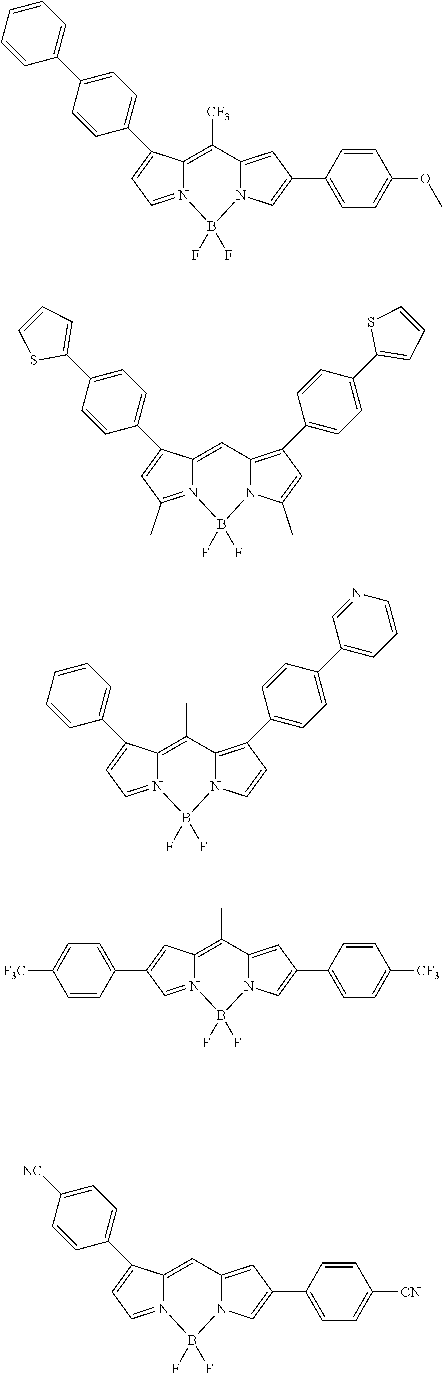

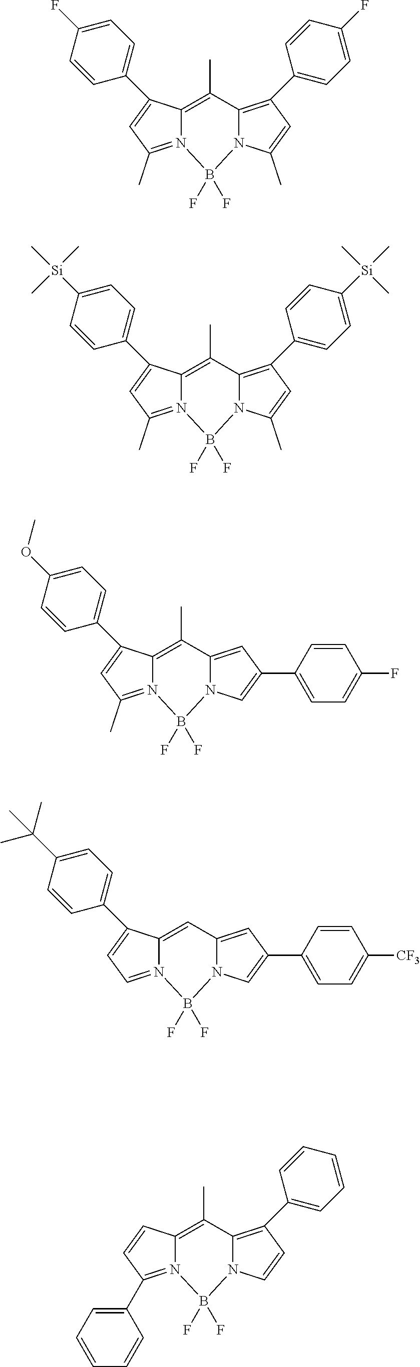

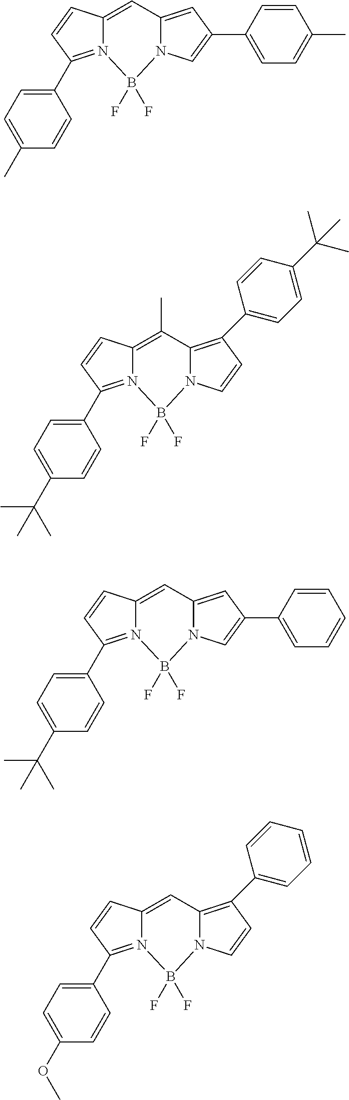

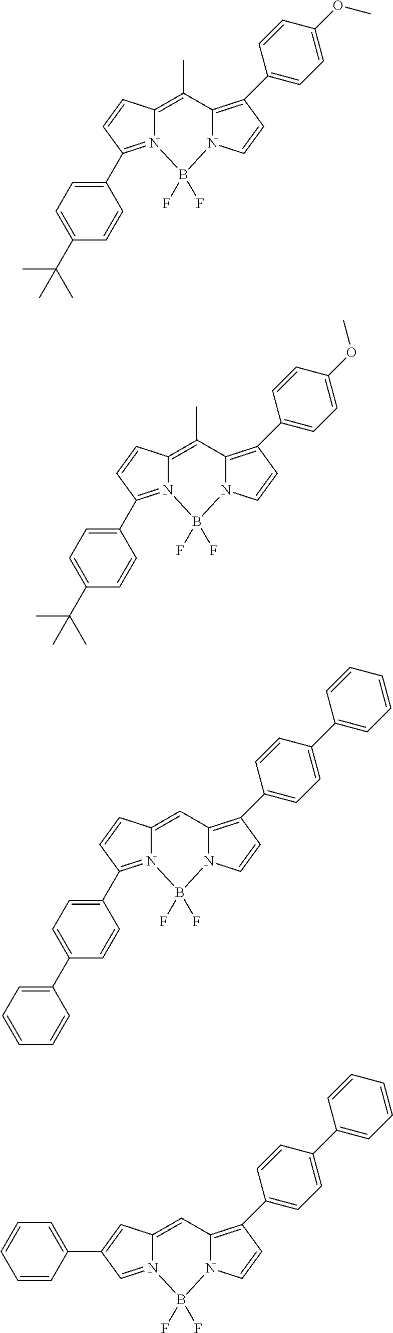

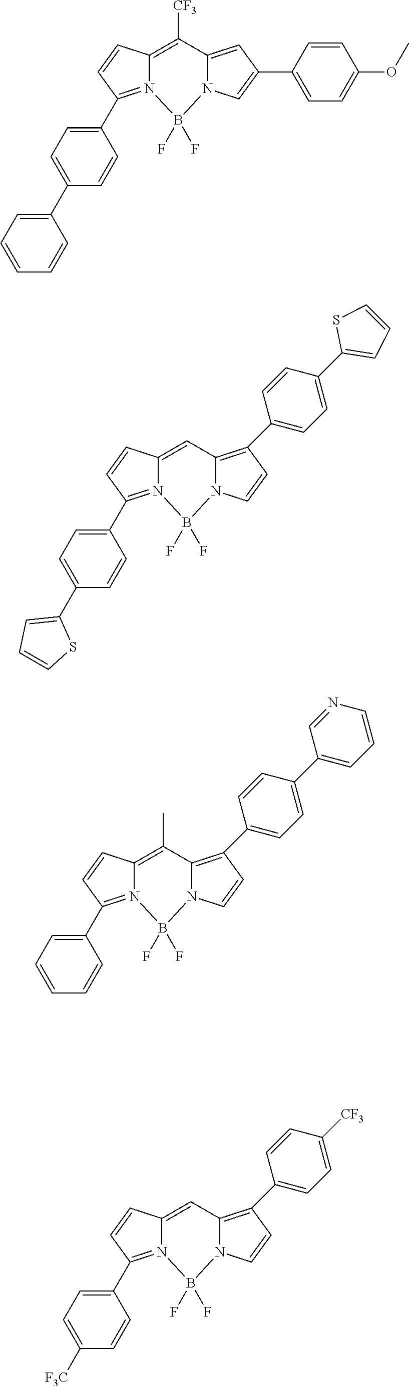

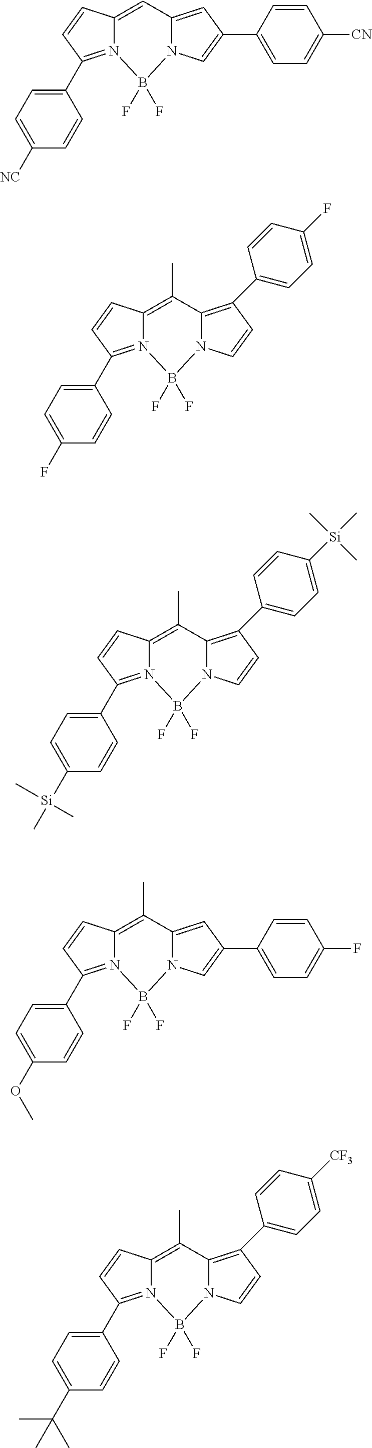

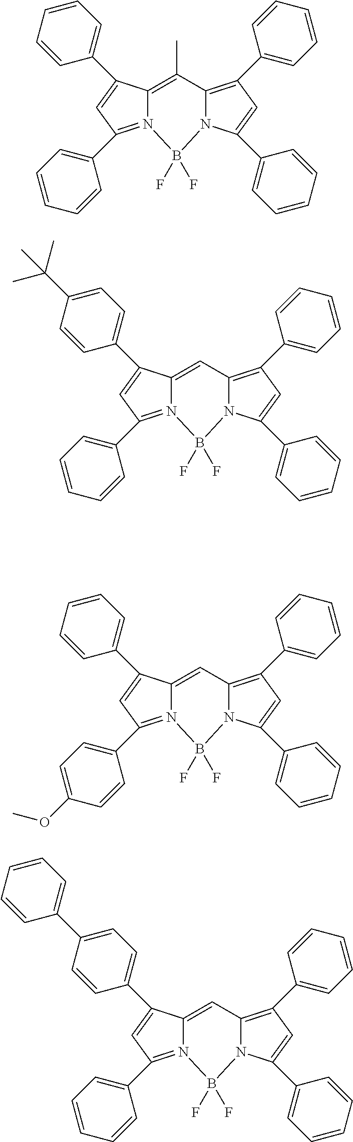

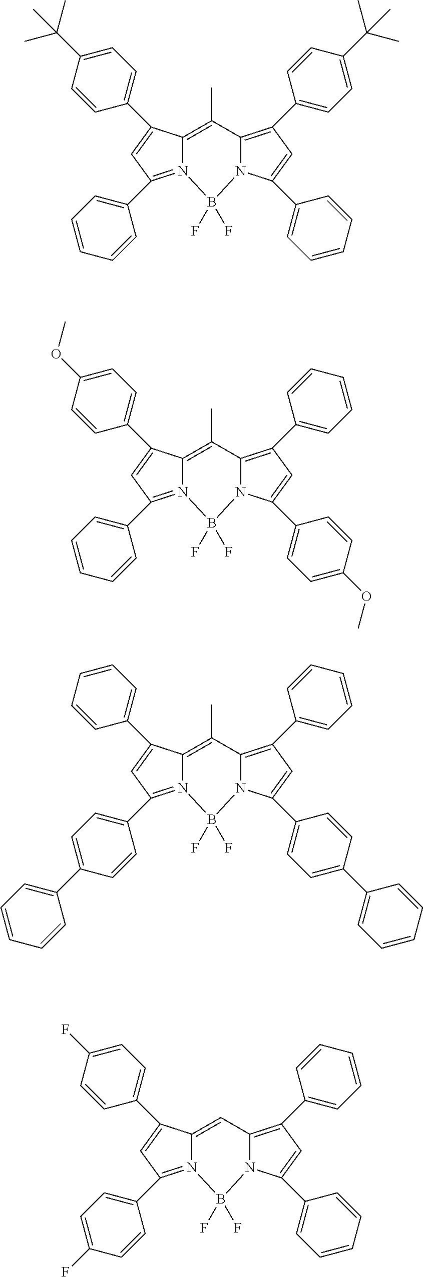

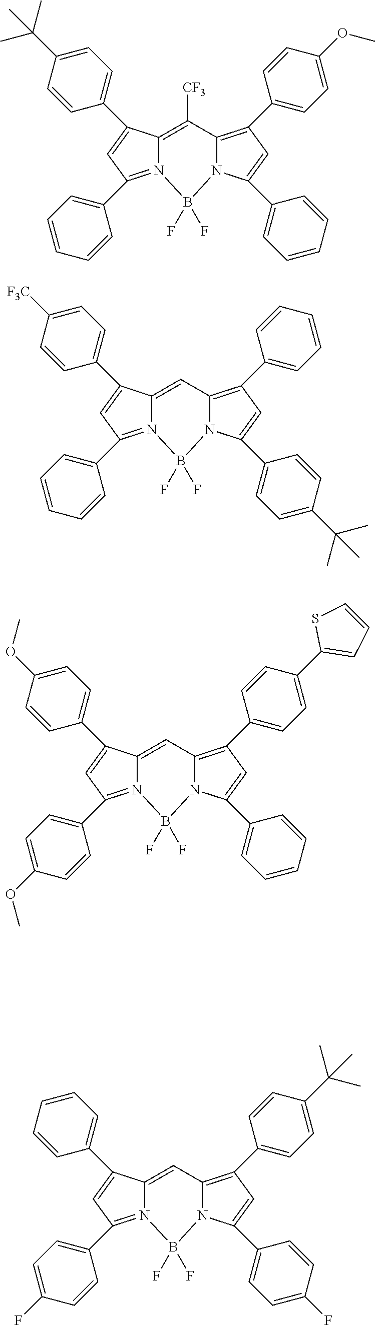

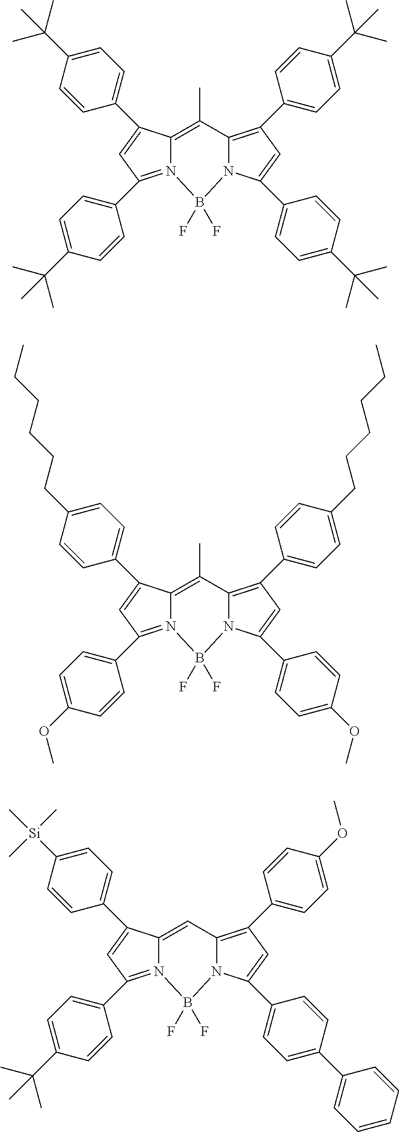

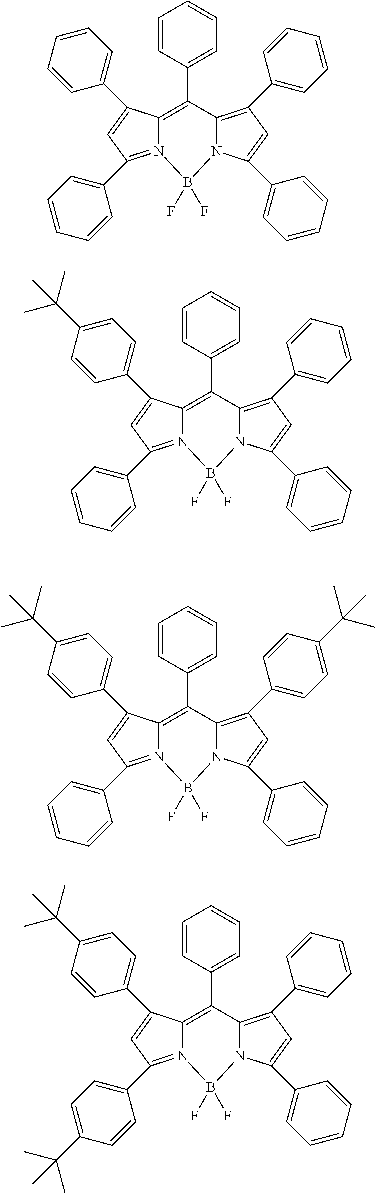

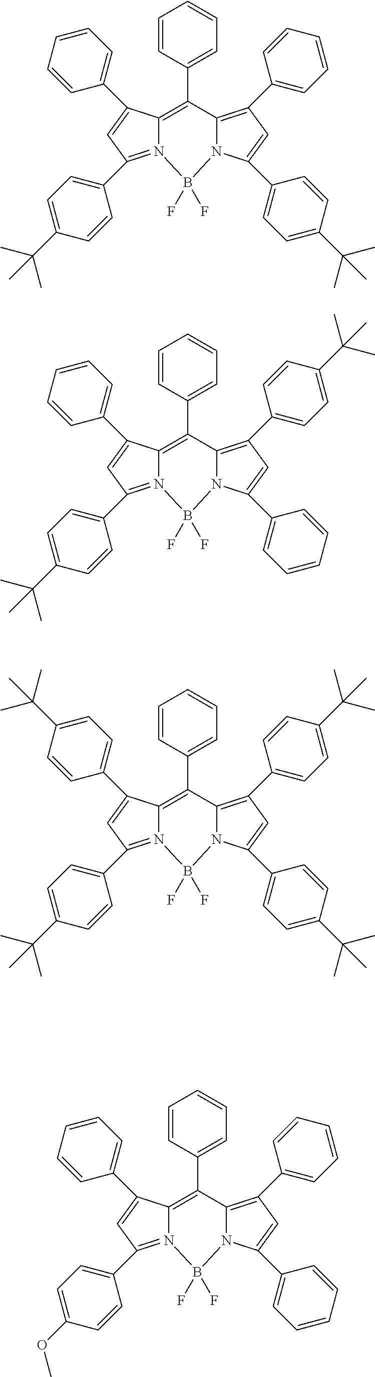

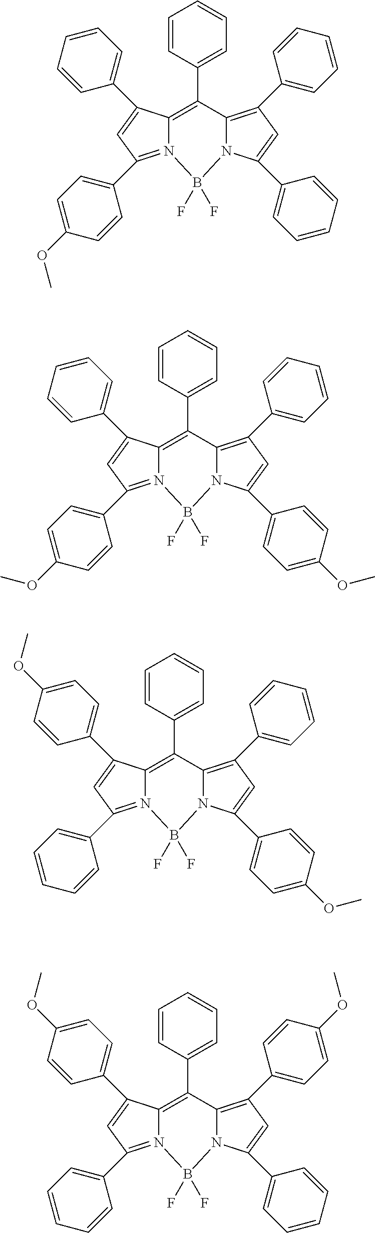

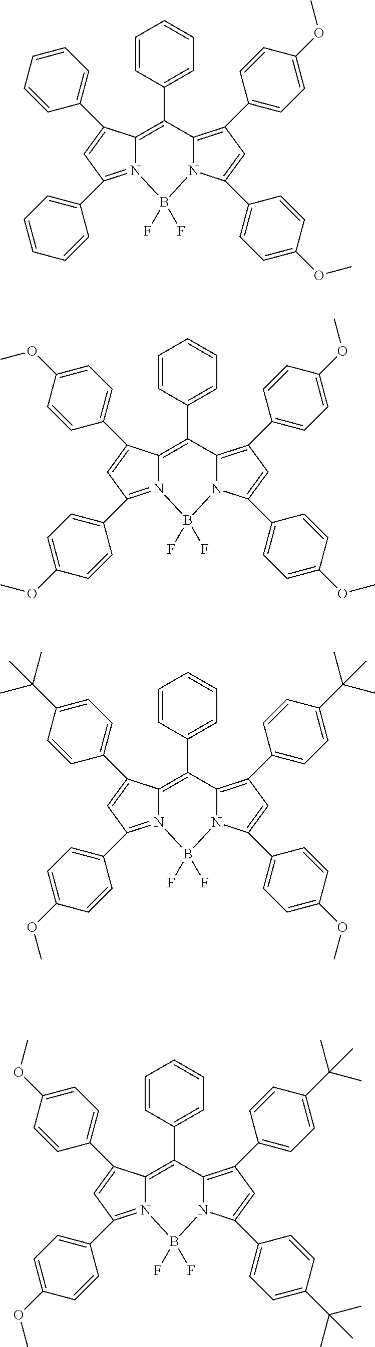

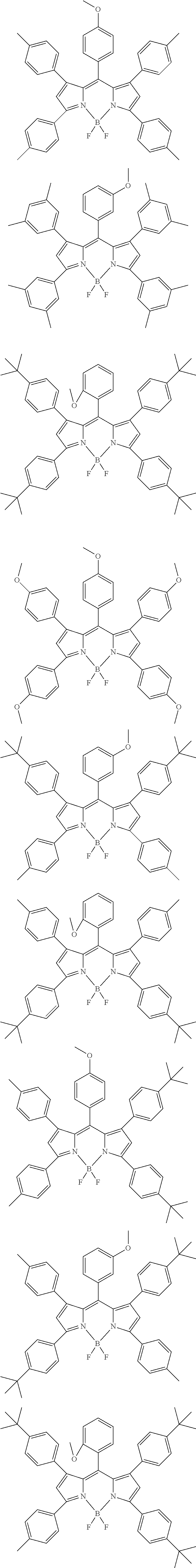

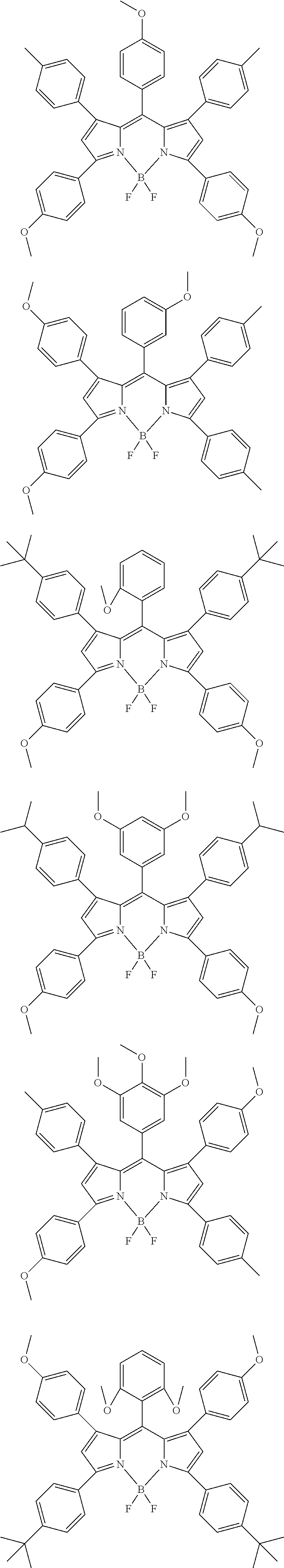

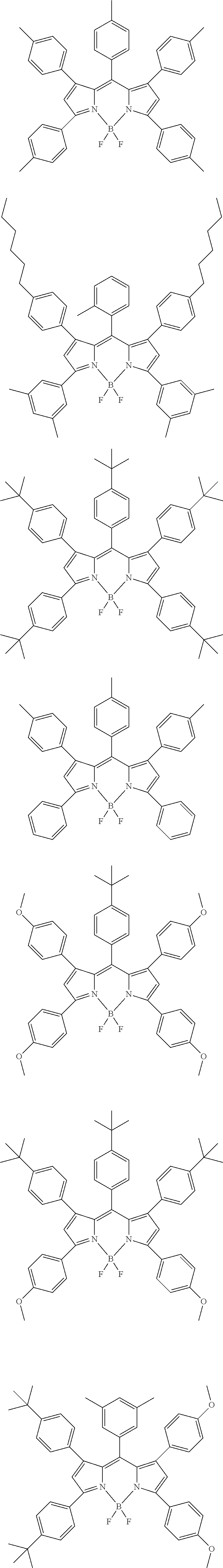

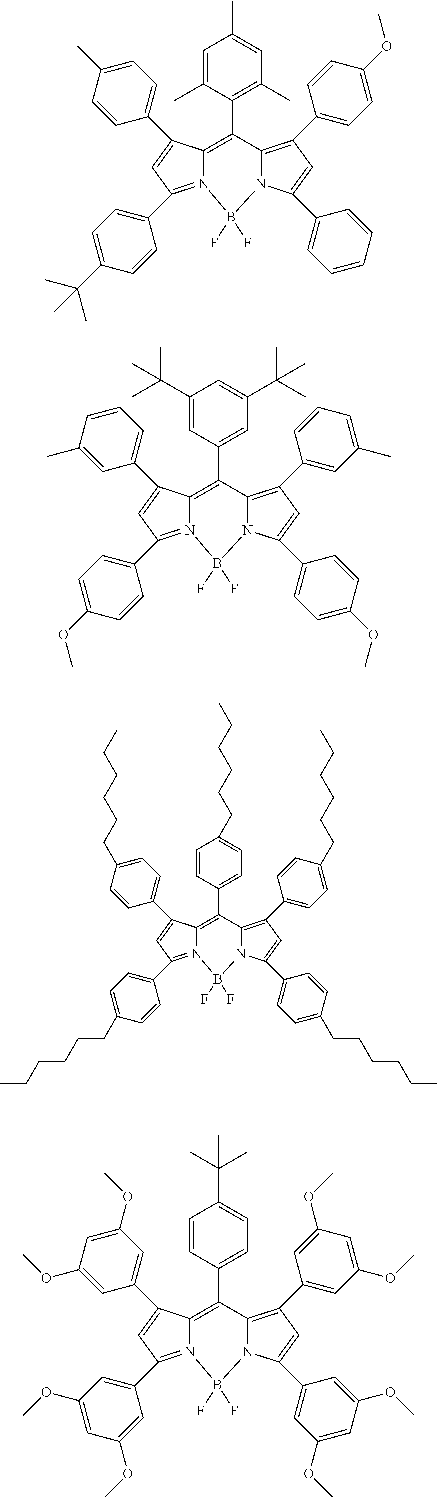

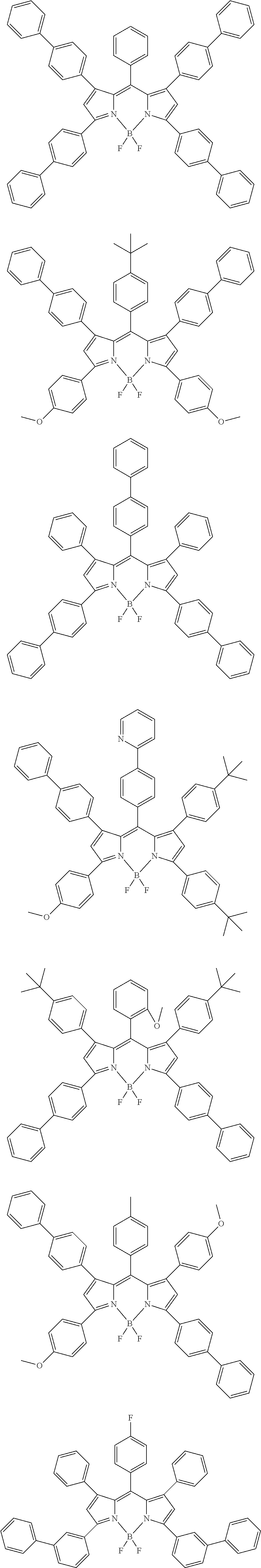

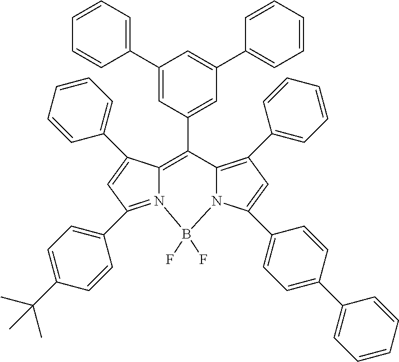

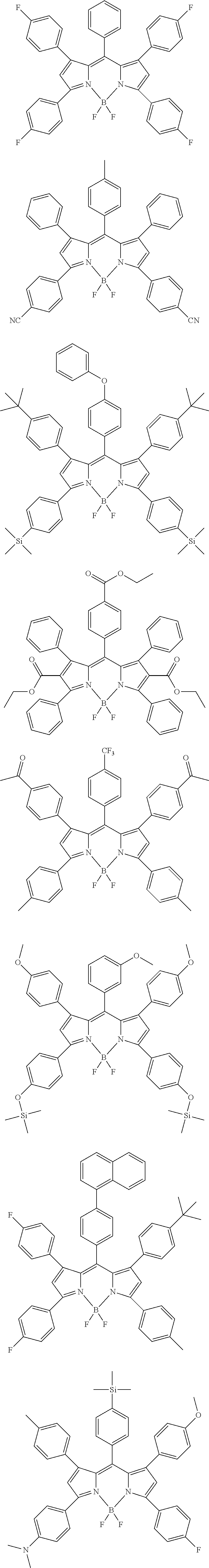

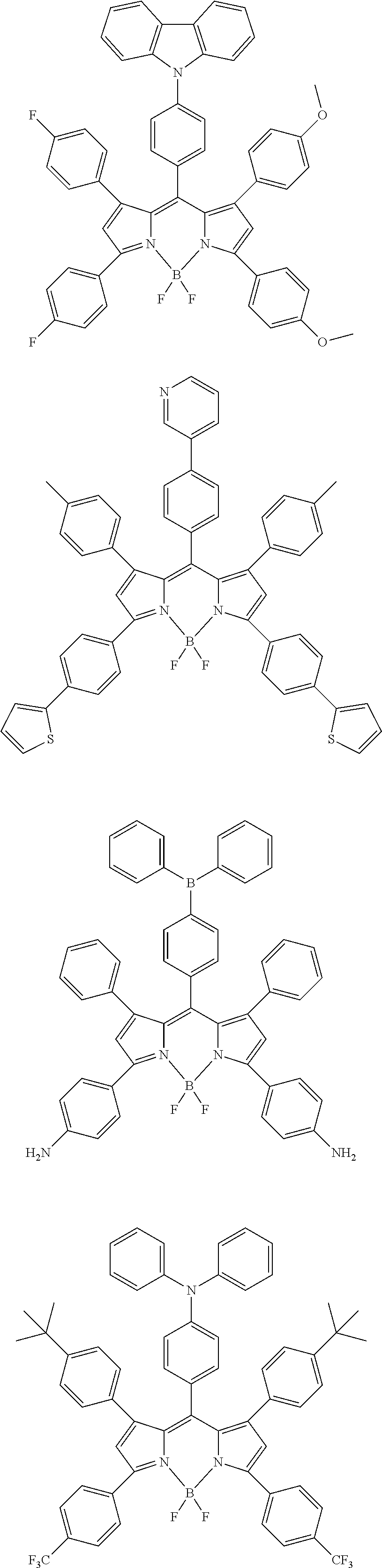

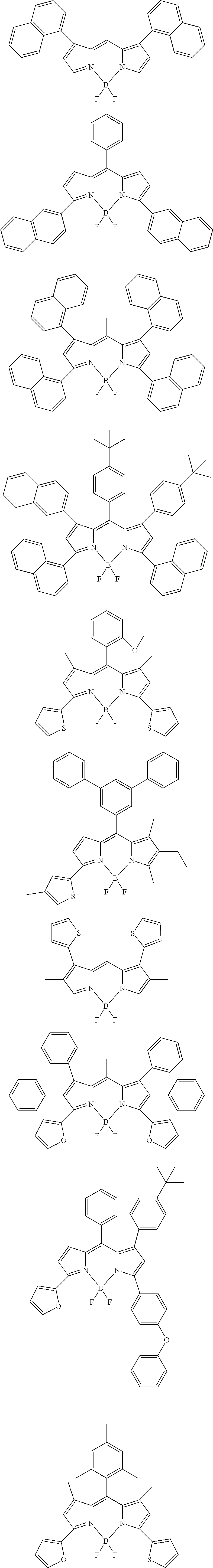

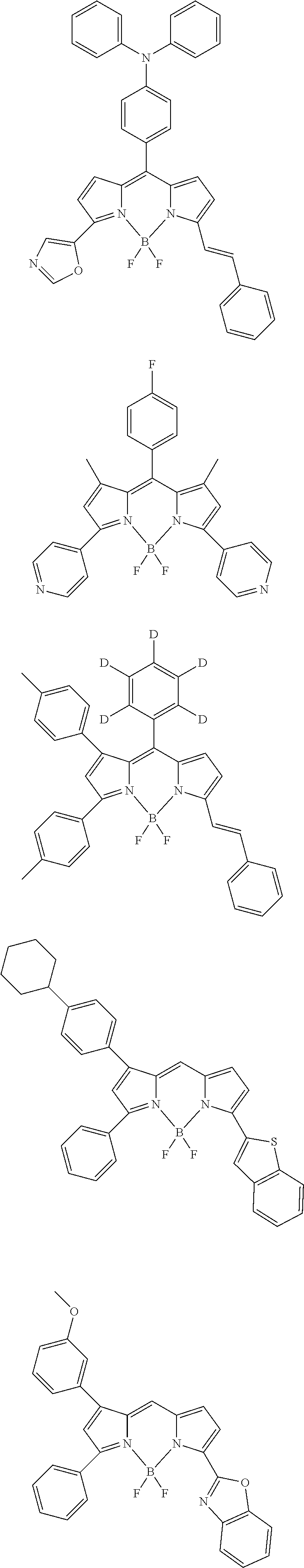

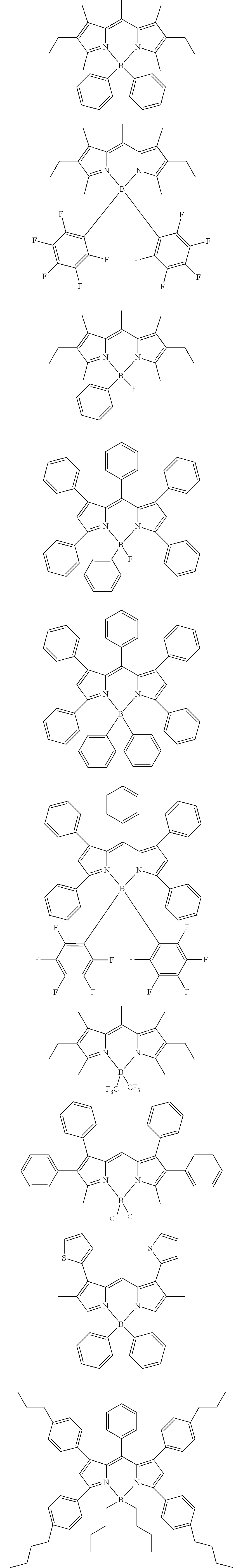

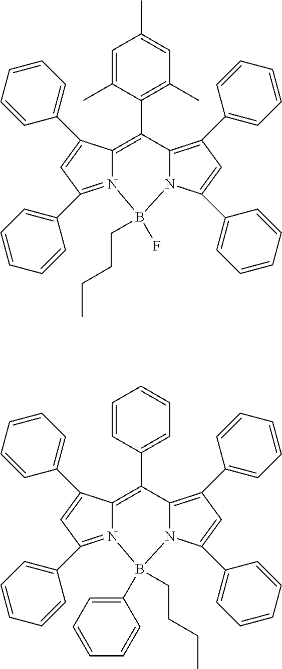

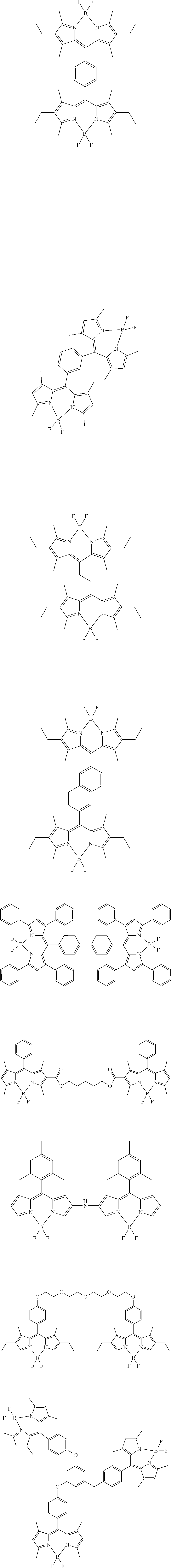

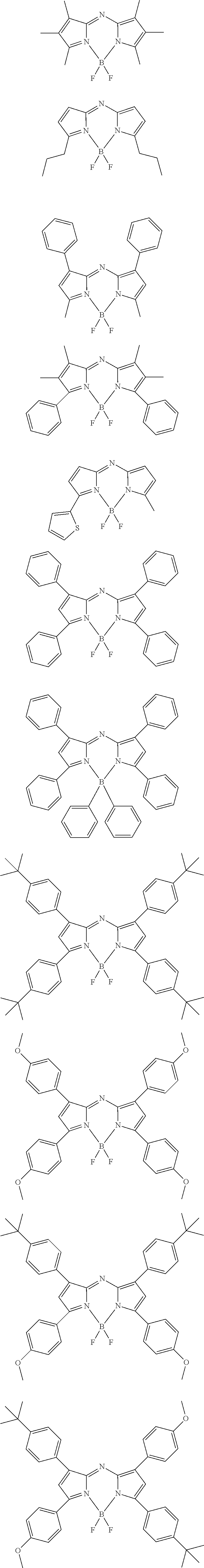

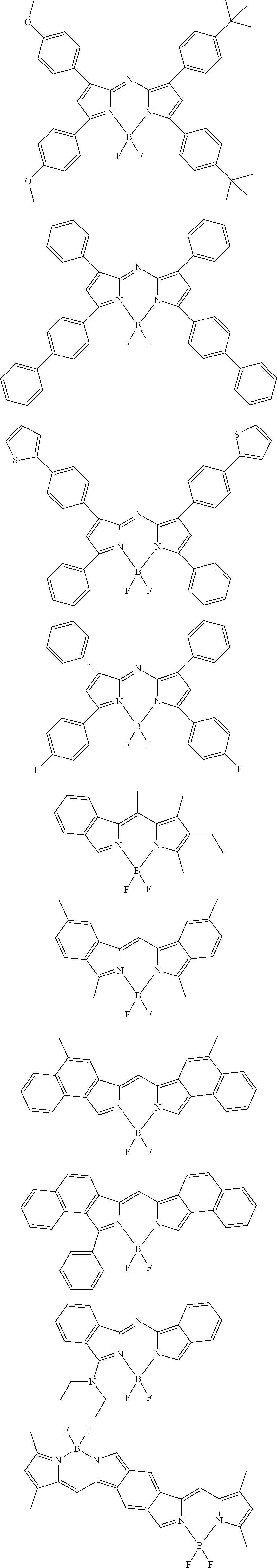

The compound represented by General Formula (1) can be synthesized, for example, by the method described in JP1996-509471A (JP-H8-509471A) and JP2000-208262A. That is, a target pyrromethene-based metal complex is obtained by reacting a pyrromethene compound with a metal salt in the presence of a base.

In addition, with regard to a synthesis of a pyrromethene-boron fluoride complex, the compound represented by General Formula (1) can be synthesized with reference to the method described in J. Org. Chem., vol. 64, No. 21, pp. 7813 to 7819 (1999); Angew. Chem., Int. Ed. Engl., vol. 36, pp. 1333 to 1335 (1997); and the like. Examples thereof include a method of obtaining the compound represented by General Formula (1) by heating a compound represented by General Formula (3) and a compound represented by General Formula (4) in the presence of phosphorus oxychloride, and then reacting with a compound represented by General Formula (5) in 1,2-dichloroethane in the presence of triethylamine. However, the present disclosure is not limited thereto. Here, R¹ to R⁹ are the same as those described above. J represents halogen.

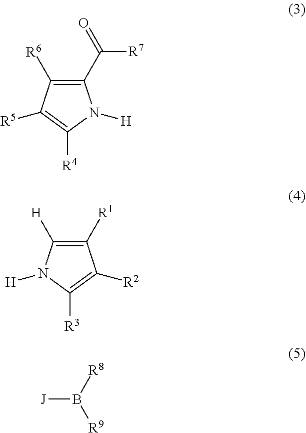

Furthermore, in a case of introducing the aryl group or the heteroaryl group, examples of the above-described method include a method of forming a carbon-carbon bond by a coupling reaction between a halogenated compound and a boronic acid or a boronic esterified compound, but the present disclosure is not limited thereto.

Similarly, in a case of introducing the amino group or the carbazolyl group, examples of the above-described method include a method forming a carbon-nitrogen bond by a coupling reaction between a halogenated compound and an amine or a carbazole compound in the presence of a metal catalyst such as palladium, but the present disclosure is not limited thereto.

The composition for a color conversion film may appropriately contain other compounds in addition to the compound represented by General Formula (1), as necessary. For example, in order to further increase energy transfer efficiency from the excitation light to the compound represented by General Formula (1), the composition for a color conversion film may contain an assist dopant such as rubrene.

In addition, in a case where it is desired to add a light-emitting color other than a light-emitting color of the compound represented by General Formula (1), a desired organic light-emitting material, such as a coumarin-based coloring agent and a rhodamine-based coloring agent, can be added. In addition to these organic light-emitting materials, it is also possible to add a combination of known light-emitting materials such as an inorganic phosphor, a fluorescent pigment, a fluorescent dye, and quantum dot.

Examples of the organic light-emitting material other than the compound represented by General Formula (1) are shown below, but the present disclosure is not particularly limited thereto.

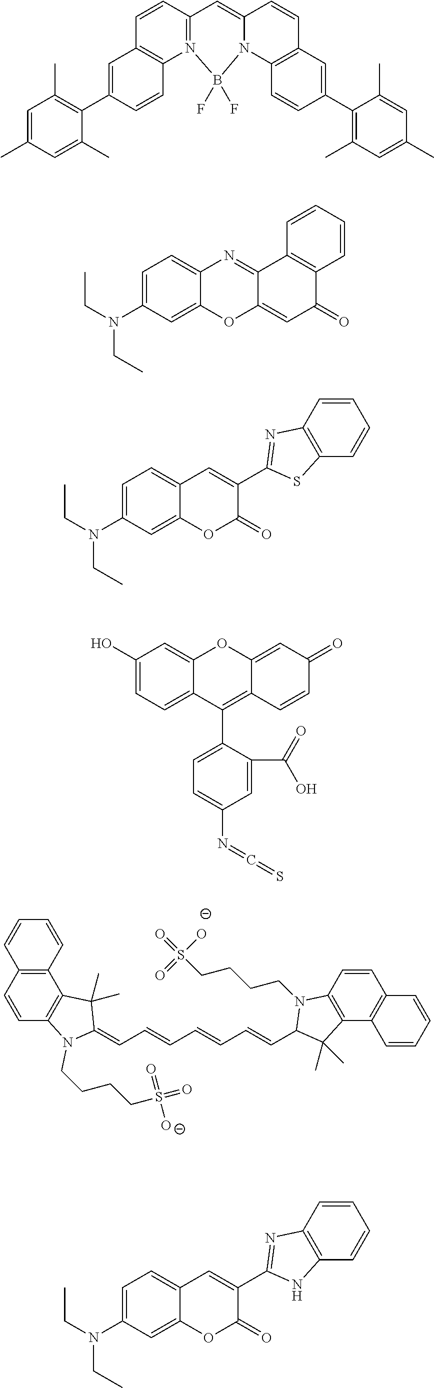

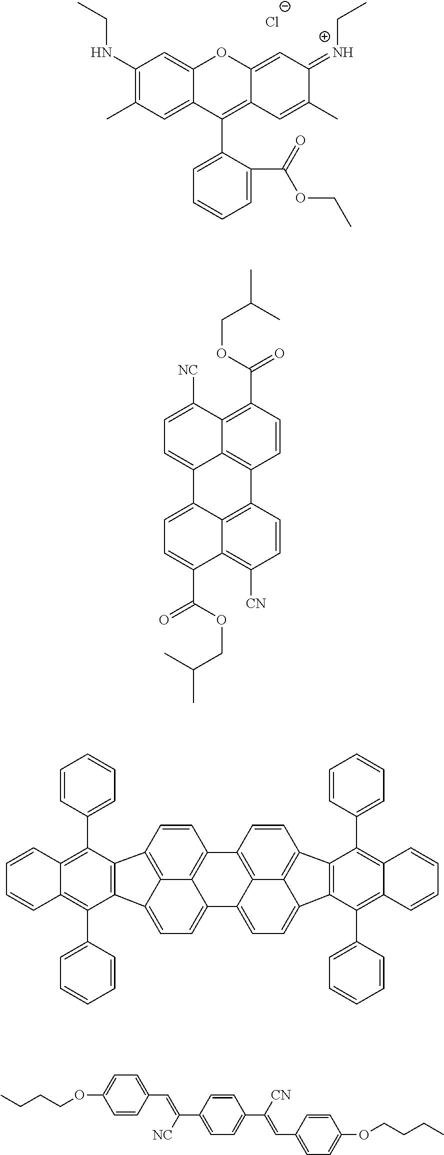

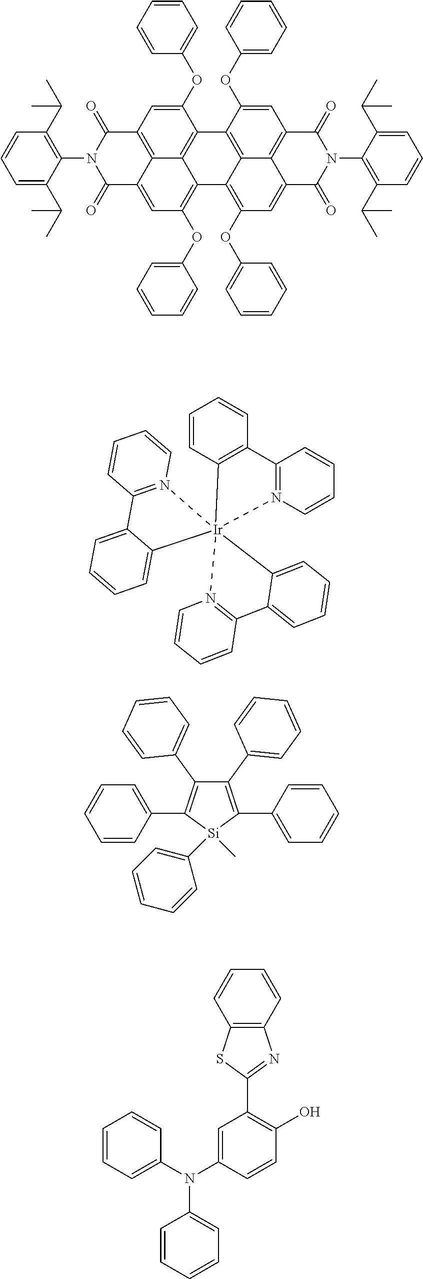

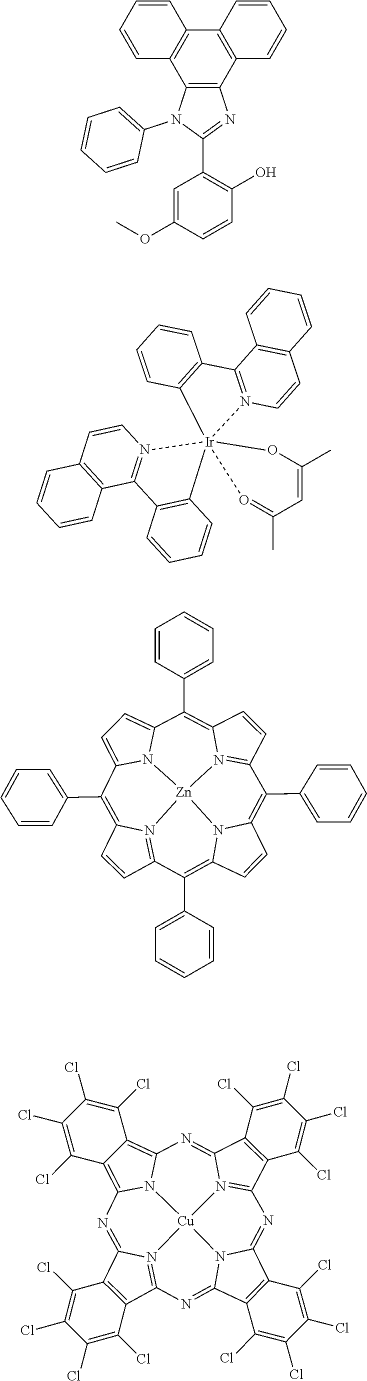

The composition for a color conversion film may contain two or more kinds of organic light-emitting materials.

From the viewpoint of wavelength conversion effect, a content of the organic light-emitting material is preferably 0.005 parts by mass to 1 part by mass, more preferably 0.007 parts by mass to 0.7 parts by mass, and still more preferably 0.01 parts by mass to 0.5 parts by mass with respect to 100 parts by mass of the total amount of solid contents contained in the composition for a color conversion film.

(Photopolymerizable Compound)

The photopolymerizable compound is not particularly limited, and a known compound in the related art can be appropriately selected and used. In addition, the composition for a color conversion film according to the embodiment of the present disclosure may contain two or more kinds of photopolymerizable compounds.

The photopolymerizable compound preferably includes a radically polymerizable compound or a cationically polymerizable compound. The photopolymerizable compound may include a radically polymerizable compound and a cationically polymerizable compound.

The sum of contents of the radically polymerizable compound and the cationically polymerizable compound is preferably 50 parts by mass or more, more preferably 60 parts by mass or more, and still more preferably 70 parts by mass or more with respect to 100 parts by mass of the total amount of the photopolymerizable compounds contained in the composition for a color conversion film. In addition, the contents of the radically polymerizable compound and the cationically polymerizable compound are preferably 100 parts by mass or less with respect to 100 parts by mass of the total amount of the photopolymerizable compounds contained in the composition for a color conversion film.

(Radically Polymerizable Compound)

As the radically polymerizable compound, a known compound in the related art can be appropriately selected and used.

Examples of the radically polymerizable compound include a compound having an ethylenically unsaturated double bond, a compound having a conjugated diene moiety, a compound having a maleimide moiety, and a thiol compound cured by a thiol-ene reaction.

Examples of the compound having a conjugated diene moiety include a compound in which a substituent is introduced into butadiene or isoprene to be non-volatile, polyacetylene and a derivative thereof, and polyphenylacetylene.

Examples of the compound having a maleimide moiety include a polymer compound having a maleimide group in the side chain, a compound having two or more maleimide groups in the molecule, and a compound having a (meth)acryloyl group and a maleimide group in the molecule.

Examples of the thiol compound cured by a thiol-ene reaction include compounds having an aliphatic thiol group, such as pentaerythritol tetrakisthiopropionate, pentaerythritol tetrakis(3-mercaptobutyrate), and 1,3,5-tris(3-mercaptobutyloxyethyl)-1,3,5-triazine-2,4,6-(1H,3H,5H)-trione.

From the viewpoint of curing properties, the compound having an ethylenically unsaturated double bond is preferable, and it is more preferable to include a compound having an acryloyl group in the molecule.

Examples thereof include a compound with (meth)acrylic acid added to one terminal of polyalkylene oxide, and a compound obtained by adding (meth)acrylic acid to one terminal of polyalkylene oxide and alkyl-etherifying or allyl-etherifying the other terminal.

Examples of the above-described compound having an ethylenically unsaturated double bond include phenoxyhexaethylene glycol mono(meth)acrylate, which is a (meth)acrylate of a compound in which polyethylene glycol is added to a phenyl group; 4-normal nonylphenoxyheptaethylene glycol dipropylene glycol (meth)acrylate, which is a (meth)acrylate of a compound obtained by adding polypropylene glycol with an average of 2 mol of propylene oxide added and polyethylene glycol with an average of 7 mol of ethylene oxide added to nonylphenol; and 4-normal nonylphenoxypentaethylene glycol monopropylene glycol (meth)acrylate, which is a (meth)acrylate of a compound obtained by adding polypropylene glycol with an average of 1 mol of propylene oxide added and polyethylene glycol with an average of 5 mol of ethylene oxide added to nonylphenol. Examples thereof also include 4-normal nonylphenoxy octaethylene glycol (meth)acrylate (manufactured by TOAGOSEI CO., LTD., M-114), which is an acrylate of a compound obtained by adding polyethylene glycol with an average of 8 mol of ethylene oxide added to nonylphenol.

Examples of the compound having an ethylenically unsaturated double bond include a compound having (meth)acryloyl groups at both terminals of an alkylene oxide chain and a compound (meth)acryloyl groups at both terminals of an alkylene oxide chain in which an ethylene oxide chain and a propylene oxide chain are randomly or block-bonded.

Examples of the above-described compound include tetraethylene glycol di(meth)acrylate, pentaethylene glycol di(meth)acrylate, hexaethylene glycol di(meth)acrylate, heptaethylene glycol di(meth)acrylate, octaethylene glycol di(meth)acrylate, nonaethylene glycol di(meth)acrylate meth)acrylate, decaethylene glycol di(meth)acrylate, and a compound having 12 mol of (meth)acryloyl groups at both terminals of an ethylene oxide chain.

In addition, an alkylene oxide-modified compound of bisphenol A, which has (meth)acryloyl groups at both terminals, can be suitably used.

Examples of the alkylene oxide modification include ethylene oxide modification, propylene oxide modification, butylene oxide modification, pentylene oxide modification, and hexylene oxide modification.

As the above-described compound, an ethylene oxide-modified compound of bisphenol A, which has (meth)acryloyl groups at both terminals, is preferable. Examples of the above-described compound include 2,2-bis(4-((meth)acryloxypolyethoxy)phenyl)propanes such as 2,2-bis(4-((meth)acryloxydiethoxy)phenyl)propane (manufactured by Shin-Nakamura Chemical Co., Ltd., NK ESTER BPE-200), 2,2-bis(4-((meth)acryloxytriethoxy)phenyl)propane, 2,2-bis(4-((meth)acryloxytetraethoxy)phenyl)propane, 2,2-bis(4-((meth)acryloxypentaethoxy)phenyl)propane (manufactured by Shin-Nakamura Chemical Co., Ltd., NK ESTER BPE-500), 2,2-bis(4-((meth)acryloxyhexaethoxy)phenyl)propane, 2,2-bis(4-((meth)acryloxyheptaethoxy)phenyl)propane, 2,2-bis(4-((meth)acryloxyoctaethoxy)phenyl)propane, 2,2-bis(4-((meth)acryloxynonaethoxy)phenyl)propane, 2,2-bis(4-((meth)acryloxydecaethoxy)phenyl)propane, 2,2-bis(4-((meth)acryloxyundec a) ethoxy)phenyl)propane, 2,2-bis(4-((meth)acryloxydodecaethoxy)phenyl)propane, 2,2-bis(4-((meth)acryloxytridecaethoxy)phenyl)propane, 2,2-bis(4-((meth)acryloxytetradecaethoxy)phenyl)propane, 2,2-bis(4-((meth)acryloxypentadecaethoxy)phenyl)propane, and 2,2-bis(4-((meth)acryloxyhexadecaethoxy)phenyl)propane.

The compound having more than two (meth)acryloyl groups in one molecule is obtained from a compound, as a central skeleton, having 3 mol or more of groups to which an alkylene oxide group can be added in the molecule, and by adding an alkylene oxide group such as an ethylene oxide group, propylene oxide and butylene oxide to the compound and then (meth)acrylate-forming the obtained alcohol.

Examples of the compound which can form the central skeleton include glycerin, trimethylolpropane, pentaerythritol, dipentaerythritol, and an isocyanurate ring.

Examples of the above-described compound include 3-mol-ethylene oxides (EO)-modified triacrylate of trimethylolpropane, 6-mol-EO-modified triacrylate of trimethylolpropane, 9-mol-EO-modified triacrylate of trimethylolpropane, and 12-mol-EO-modified triacrylate of trimethylolpropane.

Examples of the above-described compound include 3-mol-EO-modified triacrylate of glycerin (manufactured by Shin-Nakamura Chemical Co., Ltd., A-GLY-3E), 9-mol-EO-modified triacrylate of glycerin (manufactured by Shin-Nakamura Chemical Co., Ltd., A-GLY-9E), 6-mol-EO and 6-mol-propylene oxides (PO)-modified triacrylate of glycerin (manufactured by Shin-Nakamura Chemical Co., Ltd., A-GLY-0606PE), and 9-mol-EO and 9-mol-PO-modified triacrylate of glycerin (manufactured by Shin-Nakamura Chemical Co., Ltd., A-GLY-0909PE).

Examples of the above-described compound include 4EO-modified tetraacrylate of pentaerythritol (manufactured by Sartomer Japan Inc., SR-494) and 35EO-modified tetraacrylate of pentaerythritol (NK ESTER ATM-35E manufactured by Shin-Nakamura Chemical Co., Ltd.).

In addition to the above-described compounds, the following compounds can be appropriately used. Examples thereof include 1,6-hexanediol di(meth)acrylate, 1,4-cyclohexanediol di(meth)acrylate, 2-di(p-hydroxyphenyl)propane di(meth)acrylate, 2,2-bis[(4-(meth)acryloxypolypropyleneoxy)phenyl]propane, 2,2-bis[(4-(meth)acryloxypolybutyleneoxy)phenyl]propane, glycerol tri(meth)acrylate, trimethylolpropane tri(meth)acrylate, polyoxypropyltrimethylolpropane tri(meth)acrylate, dipentaerythritol penta(meth)acrylate, trimethylolpropane triglycidyl ether tri(meth)acrylate, β-hydroxypropyl-β′-(acryloyloxy)propyl phthalate, nonylphenoxypolypropylene glycol (meth)acrylate, nonylphenoxypolybutylene glycol (meth)acrylate, and polypropylene glycol mono(meth)acrylate.

(Cationically Polymerizable Compound)

Examples of the cationically polymerizable compound include an episulfide compound, an oxetane compound, a vinyl ether compound, an epoxy compound, a styrene compound, and a diene compound.

As the episulfide compound, any known compound can be used without particular limitation, and a polyfunctional episulfide compound having two or more episulfide groups in one molecule is preferable.

Examples of the polyfunctional episulfide compound include 2,2-bis(4-(2,3-epithiopropoxy)phenyl)propane, bis (4-(2,3-epithiopropoxy)phenyl)methane, bis(3,5-dimethyl-4-(2,3-epithiopropoxy)phenyl)methane, 1,6-di(2,3-epithiopropoxy)naphthalene, 1,1,1-tris-(4-(2,3-epithiopropoxy)phenyl)ethane, 2,2-bis(4-(2,3-epithiopropoxy)cyclohexyl)propane, bis(4-(2,3-epithiopropoxy)cyclohexyl)methane, 1,1,1-tris-(4-(2,3-epithiopropoxy)cyclohexyl)ethane, 2,3-epithiocyclohexyl)ether of 1,5-pentanediol, di(3,4-epithiooctyl)ether of 1,6-hexanediol, 1,3-bis(β-epithiopropylthio)cyclohexane, 1,3-bis(β-epithiopropylthiomethyl)cyclohexane, bis[4-(β-epithiopropylthio)cyclohexyl]methane, 2,2-bis[4-(β-epithiopropylthio)cyclohexyl]propane, bis[4-(β-epithiopropylthio)cyclohexyl]sulfide, 2,5-bis(β-epithiopropylthio)-1,4-dithiane, 2,5-bis(β-epithiopropylthioethylthiomethyl)-1,4-dithiane, 1,3-bis(β-epithiopropylthio)benzene, 1,3-bis(β-epithiopropylthio methyl)benzene, bis[4-(β-epithiopropylthio)phenyl]methane, 2,2-bis[4-(β-epithiopropylthio)phenyl]propane, bis[4-(β-epithiopropylthio)phenyl]sulfide, bis[4-(β-epithiopropylthio)phenyl]sulphine, 4,4-bis(β-epithiopropylthio)biphenyl, 2-(2-(β-epithiopropylthioethylthio)-1,3-bis(β-epithiopropylthio)propane, 1,2-bis[(2-(β-epithiopropylthioethyl)thio]-3-(β-epithiopropylthio)propane, tetrakis(β-epithiopropylthiomethyl)methane, 1,1,1-tris(β-epithiopropylthiomethyl)propane, 9,9-bis {4-[2-(2,3-epithiopropoxy)ethoxy]phenyl}fluorene, 9,9-bis {4-[2-(2,3-epithiopropoxy)ethoxy]-3-methylphenyl}fluorene, 9,9-bis {4-[2-(2,3-epithiopropoxy)ethoxy]-3,5-dimethylphenyl}fluorene, 9,9-bis {4-[2-(2,3-epithiopropoxy)ethoxy]-3-phenylphenyl}fluorene, 9,9-bis {6-[2-(2,3-epithiopropoxy)ethoxy]-2-naphthyl}fluorene, and 9,9-bis {5-[2-(2,3-epithiopropoxy)ethoxy]-1-naphthyl}fluorene.

As the oxetane compound, a known compound having an oxetane group can be used without particular limitation. Examples of the oxetane compound include a compound in which the oxetane group is monofunctional, a compound in which the oxetane group is bifunctional, and a compound in which the oxetane group is tri- or higher functional.

Examples of the compound in which the oxetane group is monofunctional include (3-ethyloxetan-3-yl)methyl acrylate, (3-ethyloxetan-3-yl)methyl methacrylate, 3-ethyl-3-hydroxymethyloxetane, 3-ethyl-3-(2-ethylhexyloxymethyl) oxetane, 3-ethyl-3-(phenoxymethyl)oxetane, 3-ethyl-3-(2-methacryloxymethyl)oxetane, and 3-ethyl-3-{[3-(triethoxy silyl)propoxy]methyl}oxetane.

Examples of the compound in which the oxetane group is bifunctional include 4,4′-bis[(3-ethyl-3-oxetanyl)methoxymethyl]biphenyl, 1,4-bis[(3-ethyl-3-oxetanyl)methoxymethyl]benzene, 1,4-bis {[(3-ethyl-3-oxetanyl)methoxy]methyl}benzene, di[1-ethyl (3-oxetanyl)]methyl ether, di[1-ethyl(3-oxetanyl)]methyl ether-3-ethyl-3-hydroxymethyloxetane, 3-ethyl-3-(2-ethylhexyloxymethyl)oxetane, 3-ethyl-3-(2-phenoxymethyl)oxetane, 3,7-bis(3-oxetanyl)-5-oxa-nonane, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl) ether, dicyclopentenyl bis(3-ethyl-3-oxetanylmethyl) ether, triethylene glycol bis(3-ethyl-3-oxetanylmethyl) ether, tetraethylene glycol bis(3-ethyl-3-oxetanylmethyl) ether, 1,4-bis(3-ethyl-3-oxetanylmethoxy)butane, 1,6-bis(3-ethyl-3-oxetanylmethoxy)hexane, polyethylene glycol bis(3-ethyl-3-oxetanylmethyl) ether, ethylene oxide (EO)-modified bisphenol A bis(3-ethyl-3-oxetanylmethyl) ether, propylene oxide (PO)-modified bisphenol A bis(3-ethyl-3-oxetanylmethyl) ether, EO-modified hydrogenated bisphenol A bis(3-ethyl-3-oxetanylmethyl) ether, PO-modified hydrogenated bisphenol A bis(3-ethyl-3-oxetanylmethyl) ether, and EO-modified bisphenol F (3-ethyl-3-oxetanylmethyl) ether.

Examples of the compound in which the oxetane group is tri- or higher functional include pentaerythritol tris(3-ethyl-3-oxetanylmethyl) ether, pentaerythritol tetrakis(3-ethyl-3-oxetanylmethyl) ether, dipentaerythritol hexa(3-ethyl-3-oxetanylmethyl) ether, dipentaerythritol pentakis(3-ethyl-3-oxetanylmethyl) ether, dipentaerythritol tetrakis(3-ethyl-3-oxetanylmethyl) ether, caprolactone-modified dipentaerythritol hexa(3-ethyl-3-oxetanylmethyl) ether, caprolactone-modified dipentaerythritol pentakis(3-ethyl-3-oxetanylmethyl) ether, ditrimethylolpropane tetrakis(3-ethyl-3-oxetanylmethyl) ether, a resin containing an oxetane group (for example, an oxetane-modified phenol novolac resin described in JP3783462B and the like), and a polymer obtained by polymerizing a (meth)acrylic monomer. Such a polymer can be obtained by using a known polymerization method.

As the vinyl ether compound, any known compound can be used without particular limitation, but a vinyl ether compound having 3 to 35 carbon atoms is preferable, and examples thereof include the following monofunctional or polyfunctional vinyl ethers.

The above-described “monofunctional vinyl ether” means a vinyl ether compound having one vinyl group, and the “polyfunctional vinyl ether” means a vinyl ether compound having two or more vinyl groups.

Examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, phenoxypolyethylene glycol vinyl ether, ethyl oxetane methyl vinyl ether, dicyclopentadiene vinyl ether, cyclohexanedimethanol vinyl glycidyl ether, tricyclodecane vinyl ether 2-(vinyloxyethoxy)ethyl acrylate, and 2-(vinyloxyethoxy)ethyl methacrylate.

Examples of the polyfunctional vinyl ether include divinyl ethers such as ethylene glycol divinyl ether, diethylene glycol divinyl ether, triethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether, trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, EO-added trimethylolpropane trivinyl ether, PO-added trimethylolpropane trivinyl ether, EO-added ditrimethylolpropane tetravinyl ether, PO-added ditrimethylolpropane tetravinyl ether, EO-added pentaerythritol tetravinyl ether, PO-added pentaerythritol tetravinyl ether, EO-added dipentaerythritol hexavinyl ether, and PO-added dipentaerythritol hexavinyl ether.

As the epoxy compound, a known compound having an epoxy group can be used without particular limitation.

Examples of the epoxy compound include a phenol novolac-type epoxy resin, a cresol novolac-type epoxy resin, a trihydroxyphenylmethane-type epoxy resin, a dicyclopentadiene phenol-type epoxy resin, a bisphenol A-type epoxy resin, a bisphenol F-type epoxy resin, a biphenol-type epoxy resin, a bisphenol A novolac-type epoxy resin, a naphthalene skeleton-containing epoxy resin, an alicyclic epoxy resin, and a heterocyclic epoxy resin.

From the viewpoint of light resistance, the sum of contents of the photopolymerizable compounds is preferably 30 parts by mass or more, more preferably 50 parts by mass or more, and still more preferably 70 parts by mass or more with respect to 100 parts by mass of the total amount of solid contents contained in the composition for a color conversion film.

In addition, the sum of the contents of the photopolymerizable compounds is preferably 95 parts by mass or less with respect to 100 parts by mass of the total amount of solid contents contained in the composition for a color conversion film.

(Compound Having Crosslinkable Group to which Protective Group that is to be Eliminated by Heat is Bonded)

The compound having a crosslinkable group to which a protective group that is to be eliminated by heat is bonded is a compound which has a crosslinkable group to which a protective group is bonded, and which, by heating, the protective group is to be eliminated. As a result, a polymerization and crosslinking reaction by the crosslinkable group is initiated, and the compound is cured.

Examples of the above-described compound include blocked isocyanate.

The blocked isocyanate can be obtained by reacting isocyanate with a blocking agent.

Examples of the isocyanate include 1,6-hexane diisocyanate, 4,4′-diphenylmethane diisocyanate, 2,4-tolylene diisocyanate, 2,6-tolylene diisocyanate, xylylene diisocyanate, 4,4′-dicyclohexylmethane diisocyanate, 4,4′-hydroxylated diisocyanate, isophorone diisocyanate, 1,5-naphthalene diisocyanate, 4,4′-diphenyl diisocyanate, 1,3-bis(isocyanatomethyl)cyclohexane, phenylene 1,4-diisocyanate, phenylene 2,6-diisocyanate, hexamethylene 1,3,6-triisocyanate, and hexamethylene diisocyanate.

Examples of the blocking agent include compounds such as alcohols, phenols, ε-caprolactam, oximes, active methylenes, mercaptans, amines, imides, acid amides, imidazoles, ureas, carbamates, imines, and sulfites.

Examples of a commercially available blocked isocyanate include DURANATE (registered trademark) SBN-70D, TPA-B80E, TPA-B80X, 17B-60PX, MF-B60X, E402-B80T, ME20-B80S, MF-K60X, and K6000, which are manufactured by Asahi Kasei Corporation.

From the viewpoint of light resistance, a content of the above-described compound is preferably 8 parts by mass or more, more preferably 10 parts by mass or more, and still more preferably 13 parts by mass or more with respect to 100 parts by mass of the total amount of solid contents contained in the composition for a color conversion film.

In addition, the content of the above-described compound is preferably 30 parts by mass or less with respect to 100 parts by mass of the total amount of solid contents contained in the composition for a color conversion film.

(Photopolymerization Initiator)

The composition for a color conversion film according to the embodiment of the present disclosure may contain one or two or more kinds of photopolymerization initiators. By containing the polymerization initiator in the composition for a color conversion film, it is possible to manufacture a color conversion film having more excellent light resistance.

Examples of the photopolymerization initiator include a photoradical polymerization initiator and a photocationic polymerization initiator.

(Photoradical Polymerization Initiator)

Examples of the photoradical polymerization initiator include quinones, aromatic ketones, acetophenones, acylphosphine oxides, benzoins, benzoin ethers, dialkylketals, thioxanthones, dialkylaminobenzoic acid esters, oxime esters, acridines, hexaarylbiimidazoles, pyrazoline compounds, N-arylamino acids and ester compounds thereof, and halogen compounds.

Examples of the quinones include compounds such as 2-ethylanthraquinone, octaethylanthraquinone, 1,2-benzanthraquinone, 2,3-benzanthraquinone, 2-phenylanthraquinone, 2,3-diphenylanthraquinone, 1-chloroanthraquinone, 2-chloroanthraquinone, 2-methylanthraquinone, 1,4-naphthoquinone, 9,10-phenanthraquinone, 2-methyl-1,4-naphthoquinone, 9,10-phenanthraquinone, 2-methyl-1,4-naphthoquinone, 2,3-dimethylanthraquinone, and 3-chloro-2-methylanthraquinone.

Examples of the aromatic ketones include compounds such as benzophenone, Michler's ketone [4,4′-bis(dim ethyl amino)benzophenone], 4,4′-bis(diethylamino)benzophenone, and 4-methoxy-4′-dimethylaminobenzophenone.

Examples of the acetophenones include compounds such as 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxyethoxy)-phenyl(2-hydroxy-2-propyl)ketone, 1-hydroxycyclohexylphenyl ketone, 2-benzyl-2-dimethylamino-1-(4-morpholinophenyl)-butanone-1, and 2-methyl-1-[4-(methylthio)phenyl]-2-morpholino-propanone-1. Examples of a commercially available product thereof include Irgacure (registered trademark) 907, Irgacure (registered trademark) 369, and Irgacure (registered trademark) 379, which are manufactured by BASF.

Examples of the acylphosphine oxides include compounds such as 2,4,6-trimethylbenzyldiphenylphosphine oxide, bis(2,4,6-trimethylbenzoyl)-phosphine oxide, and bis(2,6-dimethoxybenzoyl)-2,4,4-trimethyl-pentylphosphine oxide. Examples of a commercially available product thereof include Lucirin TPO manufactured by BASF and Irgacure (registered trademark) 819 manufactured by BASF.

Examples of the benzoins and the benzoin ethers include compounds such as benzoin, benzoin ethyl ether, benzoin phenyl ether, methylbenzoin, and ethylbenzoin.

Examples of the dialkylketals include compounds such as benzyl dimethyl ketal and benzyl diethyl ketal.

Examples of the thioxanthones include compounds such as 2,4-diethylthioxanthone, 2,4-diisopropylthioxanthone, and 2-chlorthioxanthone.

Examples of the dialkylaminobenzoic acid esters include compounds such as ethyl dimethylaminobenzoate, ethyl diethylaminobenzoate, ethyl-p-dimethylaminobenzoate, and 2-ethylhexyl-4-(dimethylamino)benzoate.

Examples of the oxime esters include compounds such as 1-phenyl-1,2-propanedione-2-O-benzoyloxime and 1-phenyl-1,2-propanedione-2-(O-ethoxycarbonyl)oxime. Examples of a commercially available product thereof include CGI-325, Irgacure (registered trademark) OXE01, and Irgacure (registered trademark) OXE02, which are manufactured by BASF.

(Photocationic Polymerization Initiator)

The photocationic polymerization initiator is not particularly limited, and a known compound in the related art can be used.

Examples of the photocationic polymerization initiator include aromatic sulfonium salts, aromatic iodonium salts, aromatic diazonium salts, aromatic ammonium salts, thioxanthonium salts, and (2,4-cyclopentadien-1-yl)[(1-methylethyl)benzene]-iron salts, which are composed of a cationic moiety of aromatic sulfonium, aromatic iodonium, aromatic diazonium, aromatic ammonium, thioxanthonium, (2,4-cyclopentadien-1-yl) [(1-methylethyl)benzene]-iron cation, or thianthrenium and an anionic moiety of BF₄⁻, PF₆⁻, SbF₆⁻, or [BX₄]⁻ (here, X represents a functional group in which two or more hydrogen atoms of a phenyl group are substituted with a fluorine atom or a trifluoromethyl group).

The photocationic polymerization initiator may be used alone or in admixture of two or more kinds thereof at an arbitrary ratio as necessary.

Examples of the aromatic sulfonium salt include bis[4-(diphenylsulfonio)phenyl]sulfide bishexafluorophosphate, bis[4-(diphenylsulfonio)phenyl]sulfide bishexafluoroantimonate, bis[4-(diphenylsulfonio)phenyl]sulfide bistetrafluoro borate, bis[4-(diphenylsulfonio)phenyl]sulfide tetrakis(pentafluorophenyl)borate, diphenyl-4-(phenylthio)phenylsulfonium hexafluorophosphate, diphenyl-4-(phenylthio)phenylsulfonium hexafluoroantimonate, diphenyl-4-(phenylthio)phenylsulfonium tetrafluoroborate, diphenyl-4-(phenylthio)phenylsulfonium tetrakis(pentafluorophenyl)borate, triphenylsulfonium hexafluorophosphate, triphenylsulfonium hexafluoroantimonate, triphenylsulfonium tetrafluoroborate, triphenylsulfonium tetrakis(pentafluorophenyl)borate, bis[4-(di(4-(2-hydroxyethoxy))phenylsulfonio)phenyl]sulfide bishexafluorophosphate, bis[4-(di(4-(2-hydroxyethoxy))phenylsulfonio)phenyl]sulfide bishexafluoroantimonate, bis[4-(di(4-(2-hydroxyethoxy))phenylsulfonio)phenyl]sulfide bistetrafluoroborate, and bis[4-(di(4-(2-hydroxyethoxy))phenylsulfonio)phenyl]sulfide tetrakis(pentafluorophenyl)borate.

Examples of the aromatic iodonium salt include diphenyliodonium hexafluorophosphate, diphenyliodonium hexafluoroantimonate, diphenyliodonium tetrafluoroborate, diphenyliodonium tetrakis(pentafluorophenyl)borate, bis(dodecylphenyl)iodonium hexafluorophosphate, bis(dodecylphenyl)iodonium hexafluoroantimonate, bis(dodecylphenyl)iodonium tetrafluoroborate, bis(dodecylphenyl)iodonium tetrakis(pentafluorophenyl)borate, 4-methylphenyl-4-(1-methylethyl)phenyliodonium hexafluorophosphate, 4-methylphenyl-4-(1-methylethyl)phenyliodonium hexafluoroantimonate, 4-methylphenyl-4-(1-methylethyl)phenyliodonium tetrafluoroborate, and 4-methylphenyl-4-(1-methylethyl)phenyliodonium tetrakis(pentafluorophenyl)borate.

Examples of the aromatic diazonium salt include phenyldiazonium hexafluorophosphate, phenyldiazonium hexafluoroantimonate, phenyldiazonium tetrafluoroborate, and phenyldiazonium tetrakis(pentafluorophenyl)borate.

Examples of the aromatic ammonium salt include 1-benzyl-2-cyanopyridinium hexafluorophosphate, 1-benzyl-2-cyanopyridinium hexafluoroantimonate, 1-benzyl-2-cyanopyridinium tetrafluoroborate, 1-benzyl-2-cyanopyridinium tetrakis(pentafluorophenyl)borate, 1-(naphthylmethyl)-2-cyanopyridinium hexafluorophosphate, 1-(naphthylmethyl)-2-cyanopyridinium hexafluoroantimonate, 1-(naphthylmethyl)-2-cyanopyridinium tetrafluoroborate, and 1-(naphthylmethyl)-2-cyanopyridinium tetrakis(pentafluorophenyl)borate.

In addition, as the thioxanthonium salt, for example, S-biphenyl2-isopropylthioxanthonium hexafluorophosphate or the like can be used.

Examples of the (2,4-cyclopentadien-1-yl) [(1-methylethyl)benzene]-iron salt include (2,4-cyclopentadien-1-yl) [(1-methylethyl)benzene]-iron (II) hexafluorophosphate, (2,4-cyclopentadien-1-yl) [(1-methylethyl)benzene]-iron (II) hexafluoroantimonate, (2,4-cyclopentadien-1-yl) [(1-methylethyl)benzene]-iron (II) tetrafluoroborate, and (2,4-cyclopentadien-1-yl) [(1-methylethyl)benzene]-iron (II) tetrakis(pentafluorophenyl)borate.

Examples of a commercially available product of the photocationic polymerization initiator include CPI-100P, CPI-200K, and CPI-101A (all of which are manufactured by San-Apro Ltd.); CYRACURE photocuring initiator UVI-6990, CYRACURE photocuring initiator UVI-6992, and CYRACURE photocuring initiator UVI-6976 (all of which are manufactured by Dow); ADEKA OPTOMER SP-150, ADEKA OPTOMER SP-152, ADEKA OPTOMER SP-170, and ADEKA OPTOMER SP-172 (all of which are manufactured by ADEKA CORPORATION); CI-5102 and CI-2855 (both of which are manufactured by NIPPON SODA CO., LTD.); SAN-AID SI-60L, SAN-AID SI-80L, SAN-AID SI-100L, SAN-AID SI-110L, SAN-AID SI-180L, SAN-AID SI-110, SAN-AID SI-145, SAN-AID SI-150, SAN-AID SI-160, and SAN-AID SI-180 (all of which are manufactured by SANSHIN CHEMICAL INDUSTRY CO., LTD.); ESACURE 1064 and ESACURE 1187 (both of which are manufactured by Lamberti S.P.A.); Omnicat 432, Omnicat 440, Omnicat 445, Omnicat 550, Omnicat 650, and Omnicat BL-550 (manufactured by IGM Resins B.V.); Irgacure 250 (manufactured by BASF); RHODORSIL PHOTOINITATOR 2074 (manufactured by Rhodia Japan, Ltd.); and WPI-113, WPI-116, WPI-169, and WPI-170 (manufactured by FUJIFILM Wako Pure Chemical Corporation).

A content of the photopolymerization initiator in the composition for a color conversion film is preferably 0.001 parts by mass to 10 parts by mass and more preferably 0.01 parts by mass to 5 parts by mass with respect to 100 parts by mass of solid contents contained in the composition for a color conversion film.

(Surfactant)

The composition for a color conversion film according to the embodiment of the present disclosure may contain a surfactant.

Examples of the surfactant include surfactants described in paragraph [0017] of JP4502784B and paragraphs [0060] to [0071] of JP2009-237362A.

As the surfactant, a fluorine-based surfactant, a nonionic surfactant, or a silicone-based surfactant is preferable.

Examples of a commercially available product of the fluorine-based surfactant include MEGAFACE (registered trademark) F-171, F-172, F-173, F-176, F-177, F-141, F-142, F-143, F-144, F-437, F-475, F-477, F-479, F-482, F-511, F-552, F-554, F-555-A, F-556, F-557, F-558, F-559, F-560, F-561, F-565, F-563, F-568, F-575, F-780, EXP, MFS-330, MFS-578, MFS-579, MFS-586, MFS-587, R-41, R-41-LM, R-01, R-40, R-40-LM, RS-43, TF-1956, RS-90, R-94, RS-72-K, and DS-21 (all of which are manufactured by DIC Corporation); FLUORAD FC430, FC431, and FC171 (all of which are manufactured by Sumitomo 3M Ltd.); SURFLON (registered trademark) S-382, SC-101, SC-103, SC-104, SC-105, SC-1068, SC-381, SC-383, S-393, and KH-40 (all of which are manufactured by Asahi Glass Co., Ltd.); and POLYFOX PF636, PF656, PF6320, PF6520, and PF7002 (all of which are manufactured by OMNOVA Solutions Inc.); FTERGENT (registered trademark) 710FL, 710FM, 610FM, 601AD, 601ADH2, 602A, 215M, 245F, 251, 212M, 250, 209F, 222F, 208G, 710LA, 710FS, 730LM, 650AC, 681, and 683 (all of which are manufactured by NEOS COMPANY LIMITED).

In addition, as the fluorine-based surfactant, a (meth)acrylic compound which has a molecular structure having a functional group containing a fluorine atom and in which the functional group containing a fluorine atom is broken to volatilize a fluorine atom by applying heat to the molecular structure can also be suitably used.

Examples of such a fluorine-based surfactant include MEGAFACE (registered trademark) DS series manufactured by DIC Corporation (The Chemical Daily (Feb. 22, 2016) and Nikkei Business Daily (Feb. 23, 2016)) (for example, MEGAFACE (registered trademark) DS-21).

In addition, as the fluorine-based surfactant, a polymer of a fluorine atom-containing vinyl ether compound having a fluorinated alkyl group or a fluorinated alkylene ether group, and a hydrophilic vinyl ether compound can also be preferably used.

In addition, a block polymer can also be used as the fluorine-based surfactant.

As the fluorine-based surfactant, a fluorine-containing polymer compound including a constitutional unit derived from a (meth)acrylate compound having a fluorine atom and a constitutional unit derived from a (meth)acrylate compound having 2 or more (preferably 5 or more) alkyleneoxy groups (preferably ethyleneoxy groups or propyleneoxy groups) can also be preferably used.

In addition, as the fluorine-based surfactant, a fluorine-containing polymer having an ethylenically unsaturated bond-containing group at a side chain can also be used. Specific examples thereof include MEGAFACE (registered trademark) RS-101, RS-102, RS-718K, and RS-72-K (all of which are manufactured by DIC Corporation).

As the fluorine-based surfactant, from the viewpoint of improving environmental suitability, a surfactant derived from a substitute material for a compound having a linear perfluoroalkyl group having 7 or more carbon atoms, such as perfluorooctanoic acid (PFOA) and perfluorooctanesulfonic acid (PFOS), is preferable.

Examples of the nonionic surfactant include glycerol, trimethylolpropane, trimethylolethane, and ethoxylate and propoxylate thereof (for example, glycerol propoxylate, glycerol ethoxylate, and the like), polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, and sorbitan fatty acid ester.

Examples of a commercially available product thereof include PLURONIC (registered trademark) L10, L31, L61, L62, 10R5, 17R2, and 25R2 (all of which are manufactured by BASF); TETRONIC (registered trademark) 304, 701, 704, 901, 904, and 150R1 (all of which are manufactured by BASF); Solsperse 20000 (manufactured by Nippon Lubrizol Corporation); NCW-101, NCW-1001, and NCW-1002 (all of which are manufactured by FUJIFILM Wako Pure Chemical Corporation); Pionin D-6112, D-6112-W, and D-6315 (all of which are manufactured by TAKEMOTO OIL & FAT Co., Ltd.); and OLFINE (registered trademark) E1010, SURFYNOL (registered trademark) 104, 400, and 440 (all of which are manufactured by Nissin Chemical Co., Ltd.).

Examples of the silicone-based surfactant include a linear polymer having a siloxane bond and a modified siloxane polymer with an organic group introduced in the side chain or the terminal.

Specific examples of the silicone-based surfactant include DOWSIL (registered trademark) 8032 ADDITIVE, TORAY SILICONE DC3PA, TORAY SILICONE SH7PA, TORAY SILICONE DC11PA, TORAY SILICONE SH21PA, TORAY SILICONE SH28PA, TORAY SILICONE SH29PA, TORAY SILICONE SH30PA, and TORAY SILICONE SH8400 (all of which are manufactured by Dow Corning Toray Co., Ltd.), X-22-4952, X-22-4272, X-22-6266, KF-351A, K354L, KF-355A, KF-945, KF-640, KF-642, KF-643, X-22-6191, X-22-4515, KF-6004, KP-341, KF-6001, and KF-6002 (all of which are manufactured by Shin-Etsu Silicone Co., Ltd.), F-4440, TSF-4300, TSF-4445, TSF-4460, and TSF-4452 (all of which are manufactured by Momentive Performance Materials Co., Ltd.), and BYK307, BYK323, and BYK330 (all of which are manufactured by BYK Chemie).

The surfactant may be used alone or in combination of two or more kinds thereof.

In a case where the composition for a color conversion film contains a surfactant, a content of the surfactant is preferably 0.01 parts by mass to 3 parts by mass, more preferably 0.02 parts by mass to 1 part by mass, and still more preferably 0.05 parts by mass to 0.80 parts by mass with respect to 100 parts by mass of solid contents contained in the composition for a color conversion film.

(Binder Resin)

The composition for a color conversion film may contain one or two or more kinds of binder resins other than the photopolymerizable compound.

The binder resin is not particularly limited, and examples thereof include an epoxy resin, a silicone resin (including organopolysiloxane cured products (crosslinked products) such as silicone rubber and silicone gel), a polyester resin, a (meth)acrylic resin, a vinyl resin, a polyamide resin, a polyimide resin, a polycarbonate resin, a cellulose resin, a polyolefin resin, a urea resin, a melamine resin, a phenol resin, a polyvinyl alcohol resin, a polyvinyl butyral resin, and a fluororesin.

(Additive)

In addition, the composition for a color conversion film may contain an additive other than the organic light-emitting material, the polymerization initiator, and the binder resin described above. Examples of the additive include a viscosity adjuster, an antioxidant, a heat stabilizer, a plasticizer, a leveling agent, an antistatic agent, a crosslinking agent, a curing agent, a silane coupling agent, inorganic particles, and organic particles.

(Organic Solvent)

The composition for a color conversion film may contain one or two or more kinds of organic solvents.

The type of the organic solvent is not particularly limited, and a known organic solvent in the related art can be used.

An amount of the organic solvent contained in the composition for a color conversion film is not particularly limited, but from the viewpoint dispersibility of the organic light-emitting material and the like, ease of applying a coating liquid onto a support, and ease of drying, a content of the organic solvent is preferably 50 parts by mass to 500 parts by mass with respect to 100 parts by mass of the total amount of solid contents contained in the composition for a color conversion film.

(Color Conversion Film)

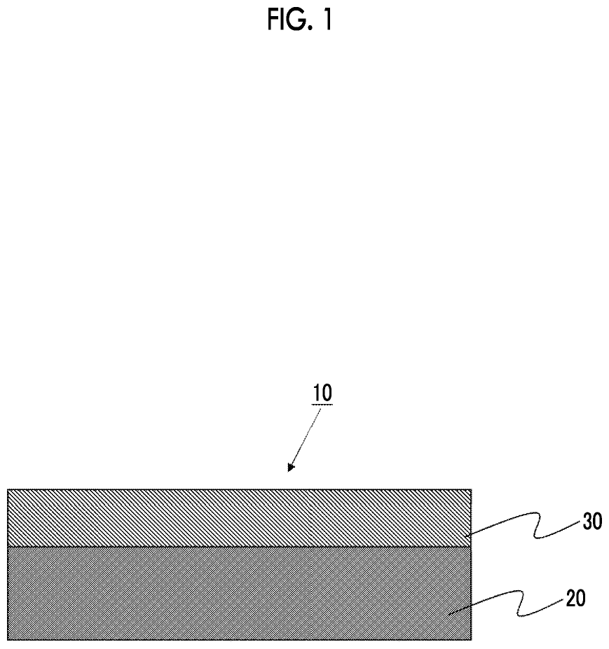

As shown in FIG. 1, a color conversion film 10 according to the embodiment of the present disclosure includes a support 20 and a color conversion layer 30. The color conversion film according to the embodiment of the present disclosure may include two or more color conversion layers.

The color conversion film according to the embodiment of the present disclosure may include a protective layer on the color conversion layer (not shown).

(Support)

The support is not particularly limited, and a known support in the related art can be used. Examples of the support include a resin film, glass, ceramic, paper, a metal plate, and a foil.

Examples of a resin material contained in the above-described resin film include polyester such as polyethylene terephthalate (PET), a cellulose resin such as cellulose acetate, a polyolefin resin such as polyethylene and polypropylene, a polyamide resin, a polyimide resin, a polystyrene resin, a polycarbonate resin, a vinyl resin, a silicone resin, a fluororesin, a thermocurable resin, and a photopolymerizable resin.

The above-described resin film may be surface-treated, and for example, a resin film subjected to chemical matting treatment may be used as the support. By using the resin film which is subjected to the chemical matting treatment, it is possible to impart a function of light diffusion layer to the support.

From the viewpoint that it has flexibility, does not undergo significant deformation, shrinkage, or elongation under pressure or under pressure and heat, has excellent transparency, and has excellent smoothness, the above-described resin film is preferably a polyester film and particularly preferably a polyethylene terephthalate film.

The polyester film is preferably a biaxially stretching film.

In addition, a thickness of the polyester film is preferably 20 μm to 250 μm. Examples of a commercially available product of the polyester film include LUMIRROR (registered trademark) #38-U48, LUMIRROR (registered trademark) #50-U48, LUMIRROR (registered trademark) #75-U48, LUMIRROR (registered trademark) #50-U40, and LUMIRROR (registered trademark) #75-U40 (all of which are manufactured by Toray Industries, Inc.); and COSMOSHINE (registered trademark) A4100 (film thickness: 50 μm, 75 μm, 100 μm, 125 μm, and 188 μm), COSMOSHINE (registered trademark) A4300 (film thickness: 38 μm, 50 μm, 75 μm, 100 μm, 125 μm, 188 μm, and 250 μm), and COSMOSHINE (registered trademark) A8300 (film thickness: 100 μm) (all of which are manufactured by TOYOBO Co., Ltd.).

The support may be manufactured by a known method in the related art, or a commercially available support may be used. Examples of the above-described resin film subjected to the chemical matting treatment include Chemical Matte 125PW manufactured by KIMOTO. Examples of the chemical matting treatment include treating a surface of the film with a chemical agent to form an uneven structure.

A thickness of the support is not particularly limited, but from the viewpoint of strength of the color conversion film and retention of the color conversion layer, it is preferably 20 μm or more, and more preferably 30 μm or more.

In addition, from the viewpoint of downsizing of a backlight unit or the like, the thickness of the support is preferably 1000 μm or less.

(Color Conversion Layer)

The color conversion layer contains at least two types of organic light-emitting materials which emit, by excitation light, light having a longer wavelength than the excitation light and have different peak wavelengths from each other.

In a preferred aspect, the organic light-emitting material includes a first organic light-emitting material which emits, by excitation light having a wavelength of 400 nm or more and less than 500 nm, light observed in a region having a peak wavelength of 500 nm or more and less than 580 nm, and a second organic light-emitting material which emits, by at least one of the excitation light having a wavelength of 400 nm or more and less than 500 nm or the light emitted from the first organic light-emitting material, light observed in a region having a peak wavelength of 580 nm or more and 750 nm or less.

The organic light-emitting material, the first organic light-emitting material, and the second organic light-emitting material have been described above, and thus the description thereof will be omitted here.

From the viewpoint of wavelength conversion effect, a content of the organic light-emitting material is preferably 0.005 parts by mass to 1 part by mass, more preferably 0.007 parts by mass to 0.7 parts by mass, and still more preferably 0.01 parts by mass to 0.5 parts by mass with respect to 100 parts by mass of the total amount of solid contents contained in the color conversion layer.

In a case where the color conversion layer has a multilayer structure, the numerical range of the above-described content is applied for each layer.

The color conversion layer contains at least one of a photopolymerized compound or a polymerized substance of a compound having a crosslinkable group to which a protective group that is to be eliminated by heat is bonded (hereinafter, also referred to as a specific polymerized substance).

The photopolymerized compound is a compound obtained by polymerizing the above-described photopolymerizable compound, and the specific polymerized substance is a compound obtained by polymerizing the above-described compound having a crosslinkable group to which a protective group to be eliminated is bonded.

From the viewpoint of light resistance, the sum of contents of the photopolymerized compounds is preferably 30 parts by mass or more, more preferably 50 parts by mass or more, and still more preferably 70 parts by mass or more with respect to 100 parts by mass of the total amount of solid contents contained in the composition for a color conversion film.

In addition, the sum of the contents of the photopolymerized compounds is preferably 95 parts by mass or less with respect to 100 parts by mass of the total amount of solid contents contained in the composition for a color conversion film.

From the viewpoint of light resistance, a content of the specific polymerized substance is preferably 8 parts by mass or more, more preferably 10 parts by mass or more, and still more preferably 13 parts by mass or more with respect to 100 parts by mass of the total amount of solid contents contained in the composition for a color conversion film.

In addition, the content of the specific polymerized substance is preferably 30 parts by mass or less with respect to 100 parts by mass of the total amount of solid contents contained in the composition for a color conversion film.

The color conversion layer may contain one or two or more kinds of photopolymerization initiators. Since the photopolymerization initiator has been described above, the description thereof will be omitted here.

A content of the photopolymerization initiator in the color conversion layer is preferably 0.001 parts by mass to 10 parts by mass, and more preferably 0.01 parts by mass to 5 parts by mass with respect to 100 parts by mass of solid contents contained in the color conversion layer.

In a case where the color conversion layer has a multilayer structure, the numerical range of the above-described content is applied for each layer.

The color conversion layer may contain the binder resin, the additive, and the like described above.

From the viewpoint of wavelength conversion effect, a thickness of the color conversion layer is preferably 1 μm or more, more preferably 5 μm or more, and still more preferably 10 μm or more.

In addition, from the viewpoint of downsizing of a backlight unit or the like, the thickness of the first color conversion layer is preferably 50 μm or less.

In a case where the color conversion layer has a multilayer structure, the numerical range of the above-described thickness is applied for each layer.

(Protective Layer)

The color conversion film may include a protective layer on the color conversion layer.

As the protective layer, the same material as the support described above can be used. Since the specific materials have been described above, the description thereof will be omitted here.

From the viewpoint of strength of the color conversion film, a thickness of the protective layer is preferably 20 μm or more, and more preferably 30 μm or more.

In addition, from the viewpoint of downsizing of a backlight unit or the like, the thickness of the protective layer is preferably 1000 μm or less.

(Formation of Other Layers)

In the color conversion film, other layers may be formed on the support, the color conversion layer, or the protective layer.

Examples of the other layers include an oxygen barrier layer, a water vapor barrier layer, an antireflection layer, an antistatic layer, and an antifouling later.

(Method for Manufacturing Color Conversion Film)

The method for manufacturing a color conversion film according to the embodiment of the present disclosure includes forming a color conversion layer on a support by curing a composition for a color conversion film, that contains at least two types of organic light-emitting materials which emit, by an excitation light, light having a longer wavelength than the excitation light and have peak wavelengths of light emission different from each other and at least one of a photopolymerizable compound or a compound having a crosslinkable group to which a protective group that is to be eliminated by heat is bonded.

As the composition for a color conversion film, the above-described composition can be used, and the details thereof will be omitted here.

(Formation of Color Conversion Layer)

The formation of the color conversion layer is performed by curing the composition for a color conversion film on the support.

The curing of the composition for a color conversion film can be carried out, for example, by applying and drying the composition for a color conversion film on the support, and then irradiating the composition with an actinic ray such as ultraviolet rays and an electron beam.

An applying method of the composition for a color conversion film is not particularly limited, and the composition can be applied by a known method in the related art. Examples of the applying method include a curtain coating method, a dip coating method, a spin coating method, a printing coating method, a spray coating method, a slot coating method, a roll coating method, a slide coating method, a blade coating method, a gravure coating method, and a wire bar method.

A drying method is not particularly limited, and the drying can be performed by a known method in the related art, such as using warm air.

A drying temperature is preferably changed as appropriate depending on composition of a coating liquid for forming the first color conversion layer, but is preferably 50° C. to 200° C. and more preferably 70° C. to 150° C.

As a light source for the light irradiation, a known light source in the related art can be used, and for example, an air-cooled metal halide lamp can be used.

In a case where ultraviolet rays are used in the light irradiation, an output density is not particularly limited, but is preferably 30 W/cm to 100 W/cm. In addition, an irradiation amount is not particularly limited, but is preferably 300 mJ/cm² to 2000 mJ/cm².

(Formation of Protective Layer)

The method for manufacturing a color conversion film may include forming a protective layer on the color conversion layer.

The protective layer can be formed by heating and pressure-bonding the resin film or the like described above onto the color conversion layer.

In another aspect, the protective layer can be formed by applying and drying a coating liquid containing the resin material on the color conversion layer.

(Formation of Other Layers)

In the method for manufacturing a color conversion film of the first aspect, other layers may be formed on a layer such as the color conversion layer. Since the specific examples of the other layers have been described above, the description thereof will be omitted here.

(Backlight Unit)

The backlight unit according to the embodiment of the present disclosure includes a light source and the above-described color conversion film. It is preferable that a surface on which the support is provided is disposed to face the light source side.

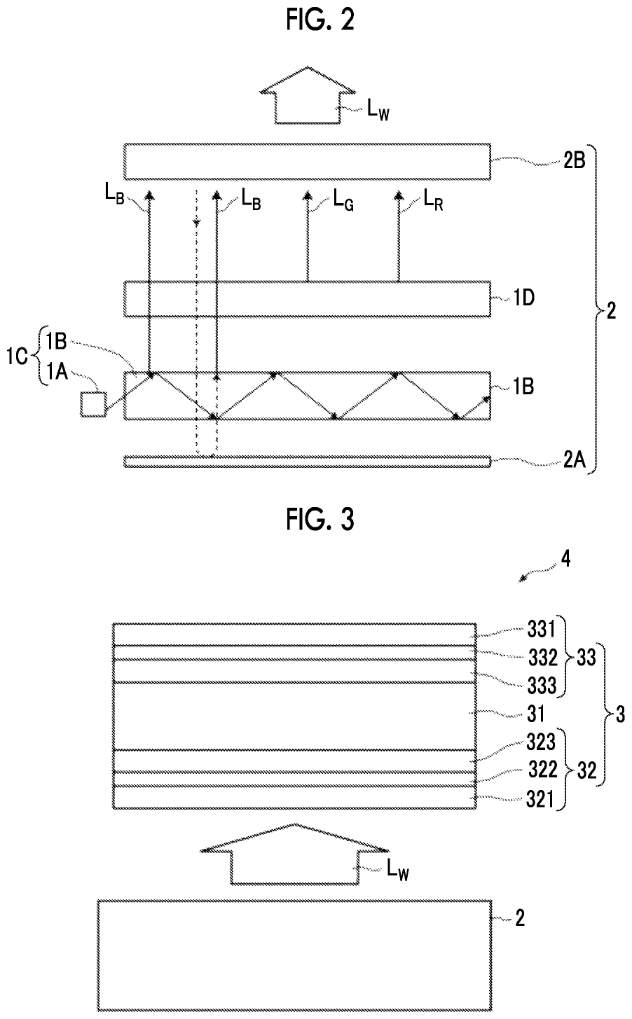

FIG. 2 is a schematic configuration cross-sectional diagram showing an embodiment of the backlight unit, and the backlight unit will be described below with reference to FIG. 2.

As shown in FIG. 2, a backlight unit 2 includes a planar light source 1C including a light source 1A which emits excitation light (blue light L_{B}) having a wavelength of 400 nm or more and less than 500 nm and a light guide plate 1B which guides and emits the excitation light emitted from the light source 1A, a color conversion film 1D provided on the planar light source 1C, a retroreflective member 2B disposed to face the planar light source 1C with the color conversion film 1D interposed therebetween, and a reflecting plate 2A disposed to face the color conversion film 1D with the planar light source 1C interposed therebetween.

The two types of the organic light-emitting materials contained in the color conversion layer each emit, by the excitation light emitted from the planar light source 1C, light (green light L_{G}) observed in a region having a peak wavelength of 500 nm or more and less than 580 nm and light (red light L_{R}) observed in a region having a peak wavelength of 580 nm or more and 750 nm or less.

White light L_{W} is emitted from a surface of the retroreflective member 2B by the excitation light (blue light L_{B}) which has been passed through the color conversion film, the light (green light L_{G}) observed in the region having a peak wavelength of 500 nm or more and less than 580 nm, and the light (red light L_{R}) which is observed in the region having a peak wavelength of 580 nm or more and 750 nm or less.

In FIG. 2, the blue light L_{B}, the green light L_{G}, and the red light L_{R} emitted from the color conversion film 1D are incident on the retroreflective member 2B, and each incident light is repeatedly reflected between the retroreflective member 2B and the reflecting plate 2A and passes through the color conversion film 1D multiple times.

As a result, in the color conversion film 1D, a sufficient amount of the excitation light (blue light L_{B}) is absorbed by the specific organic light-emitting material B which emits the red light L_{R} and the organic light-emitting material which emits the green light L_{G}, a required amount of fluorescence (the green light L_{G} and the red light L_{R}) is emitted, and the white light L_{W} is emitted from the retroreflective member 2B as the sum of the blue light L_{B}, the green light L_{G}, and the red light L_{R}.

From the viewpoint of improving brightness and color reproducibility, half-widths of each light emission intensity of the blue light, the green light, and the red light emitted by the backlight unit are all preferably 80 nm or less, more preferably 50 nm or less, still more preferably 40 nm or less, and even more preferably 30 nm or less. In addition, it is particularly preferable that the half-width of the light emission intensity of the blue light is 25 nm or less.

As the light source 1A, a light-emitting diode, a laser light source, or the like can be used.

As shown in FIG. 2, the planar light source 1C may be a light source (edge light mode light source) including the light source 1A and the light guide plate 1B which guides and emits primary light emitted from the light source 1A, or may be a light source (direct backlight mode light source) in which the light source 1A is disposed in a plane parallel to the color conversion film 1D and a diffusion plate is provided in place of the light guide plate 1B. As the configuration of the backlight unit, although the edge light mode light source including the light guide plate, the reflecting plate, and the like as constituent members has been described in FIG. 2, the backlight unit may be the direct backlight mode light source.

As the light guide plate, a known light guide plate can be used without any limitation. In the present embodiment, the case where the planar light source is used as the light source has been described as an example, but a light source other than the planar light source can also be used as the light source.

In addition, the reflecting plate is not particularly limited, and a known reflecting plate can be used. For example, reflecting plates described in each publication such as JP3416302B, JP3363565B, JP4091978B, and JP3448626B can be used. The contents of these publications are incorporated herein by reference.

The retroreflective member may be configured of a known diffusion plate, diffusion sheet, prism sheet (for example, BEF series manufactured by Sumitomo 3M), a reflective type polarizing film (for example, DBEF series manufactured by Sumitomo 3M), or the like.

The configuration of the retroreflective member is described in each publication such as JP3416302B, JP3363565B, JP4091978B, and JP3448626B, the contents of which are incorporated herein by reference.

(Liquid Crystal Display Device)

The liquid crystal display device according to the embodiment of the present disclosure includes the above-described backlight unit and a liquid crystal cell unit.

FIG. 3 shows a schematic configuration cross-sectional diagram showing an embodiment of the liquid crystal display device according to the present disclosure. As shown in FIG. 3, a liquid crystal display device 4 includes the backlight unit 2 shown in FIG. 2 and a liquid crystal cell unit 3 disposed to face the retroreflective member 2B side of the backlight unit 2.

The liquid crystal cell unit 3 has a configuration in which a liquid crystal cell 31 is sandwiched between a polarizing plate 32 and a polarizing plate 33. In addition, each of the polarizing plate 32 and the polarizing plate 33 has a configuration in which both main surfaces of a polarizer 322 and a polarizer 332 are protected by polarizing plate protective films 321, 323, 331, and 333.

The liquid crystal cell and the polarizing plate constituting the liquid crystal display device are not particularly limited, and those manufactured by a known method or commercially available products can be used. In addition, a known interlayer such as an adhesive layer may be provided between the layers.

A drive mode of the liquid crystal cell is not particularly limited, and various modes such as twisted nematic (TN), super twisted nematic (STN), vertical alignment (VA), in-plane switching (IPS), and optically compensated bend cell (OCB) can be used.

Examples of a configuration of the liquid crystal display device in the VA mode include a configuration shown in FIG. 2 of JP2008-262161A. However, the specific configuration of the liquid crystal display device is not particularly limited, and a known configuration can be adopted.

The liquid crystal display device may include a functional layer such as an optical compensation member which performs optical compensation and an adhesive layer.

In addition, the liquid crystal display device may include a color filter substrate, a thin-layer transistor substrate, a lens film, a diffusion sheet, a hard coat layer, an antireflection layer, a low reflection layer, an antiglare layer, or the like.

Further, the liquid crystal display device may include a forward scattering layer, a primer layer, an antistatic layer, an undercoat layer, or the like.

The polarizing plate on the backlight unit side may include a phase difference film as the polarizing plate protective film on the liquid crystal cell side. As such a phase difference film, a known phase difference film such as a cellulose acylate film can be used.

### EXAMPLES

Hereinafter, the present disclosure will be described in more detail using Examples. However, the present disclosure is not limited to the following examples as long as it does not exceed the gist of the present invention.

(Preparation of Composition for Color Conversion Film)

Components shown in Table 23 were mixed in a container to prepare coating liquids A-1 to A-5 and a-1 and a-2 for forming a color conversion layer.

Details of the components in Table 23 are as follows.
Organic light-emitting material a: compound represented by the following chemical formula

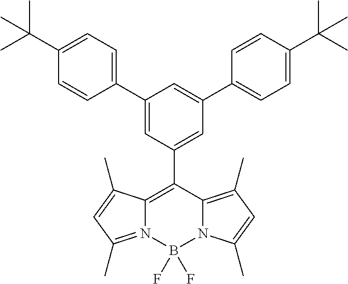

Organic light-emitting material b: compound represented by the following chemical formula

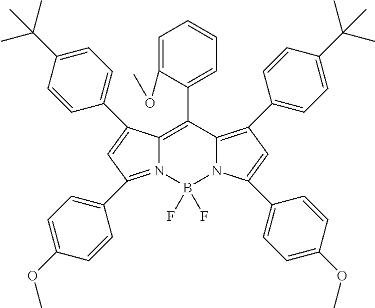

Radically polymerizable compound a: tricyclodecanedimethanol diacrylate, manufactured by Shin-Nakamura Chemical Co., Ltd., A-DCP
Radically polymerizable compound b: dipentaerythritol polyacrylate, manufactured by Shin-Nakamura Chemical Co., Ltd., A-DPH
Radically polymerizable compound c: 1,9-nonanediol diacrylate, manufactured by Shin-Nakamura Chemical Co., Ltd., A-NOD-N
Cationic ally polymerizable compound: 1,4-bis{[(3-ethyl-3-oxetanyl)methoxy]methyl}benzene, di[1-ethyl (3-oxetanyl)]methyl ether, manufactured by TOAGOSEI CO., LTD., ARON OXETANE (registered trademark) OXT-221
Blocked isocyanate: manufactured by Asahi Kasei Corporation, DURANATE (registered trademark) SBN-700
Radical polymerization initiator a: 1-[9-ethyl-6-(2-methylbenzoyl)-9H-carbazol-3-yl]ethanone-1-(O-acetyloxime), manufactured by BASF, Irgacure (registered trademark) OXE-02
Radical polymerization initiator b: 1-[4-(phenylthio)phenyl]octane-1,2-dione-2-(O-benzoyloxime), manufactured by BASF, Irgacure (registered trademark) OXE-01
Radical polymerization initiator c: 2-(dimethylamino)-2-(4-methylbenzyl)-1-(4-morpholinophenyl)butan-1-one, manufactured by BASF, Irgacure (registered trademark) 379EG
Cationic polymerization initiator: photoacid generator, manufactured by San-Apro Ltd., CPI-200K
Binder resin a: acrylic polyol, solution having a solid content of 50% by mass, manufactured by DIC Corporation, ACRYDIC (registered trademark) A-801
Binder resin b: epoxy group-containing polymer, manufactured by Daicel Corporation, EHPE 3150
Binder resin c: acrylic polymer, solution having a solid content of 50% by mass, manufactured by Taisei Fine Chemical Co., Ltd., Acrylic polymer 0403KA
Additive a: surfactant, manufactured by DIC Corporation, MEGAFACE (registered trademark) F551A
Additive b: curing agent, diethyltriamine
MEK: methyl ethyl ketone, boiling point: 80° C.
MMPGAC: 1-methoxy-2-propyl acetate, boiling point: 140° C.

The composition for a color conversion film, which was prepared as described above, was applied onto glass, and the solvent was volatilized to obtain a solid composition. In a case where, using a spectrofluoro-photometer (manufactured by Hitachi, Ltd., F-2500 spectrofluoro-photometer), an emission spectrum exhibited by irradiating the solid composition with excitation light having a wavelength of 460 nm was obtained, peak wavelengths were confirmed in a range of 500 nm or more and less than 580 nm and in a range of 580 nm or more and 750 nm or less for each of the compositions for a color conversion film.

TABLE 23

| | Organic | | | | | Cation- | | | | | Photo- | | | | | | | | |
|---|---|---|---|---|---|---|---|---|---|---|---|---|---|---|---|---|---|---|---|
| | light- | | Radically | | | ically | | Photoradical | | | cationic | | | | | | | | |
| | emitting | | polymerizable | | | polymer- | Blocked | polymerization | | | polymer- | | | | | | | | |
| | material | | compound | | | izable | isocya- | initiator | | | ization | Binder resin | | | Epoxy | Additive | | Organic solvent | |
| | a | b | a | b | c | compound | nate | a | b | c | initiator | a | b | c | compound | a | b | MEK | MMPGAC |
| A-1 | 0.2 | 0.08 | 50 | 50 | | — | — | 1 | — | — | — | — | — | — | — | 0.1 | — | 40 | 60 |
| A-2 | 0.2 | 0.08 | 25 | 50 | 25 | — | — | — | 1 | — | — | — | — | — | — | 0.1 | — | 40 | 60 |
| A-3 | 0.2 | 0.08 | 30 | 20 | 30 | — | — | — | — | 1 | — | — | — | 50 | — | 0.1 | — | 10 | 60 |
| A-4 | 0.2 | 0.08 | — | — | — | 100 | — | — | — | — | 5 | — | — | — | — | 0.1 | — | 40 | 60 |
| A-5 | 0.2 | 0.08 | — | — | — | — | 20 | — | — | — | — | 120 | — | — | — | 0.1 | — | 20 | 20 |
| a-1 | 0.2 | 0.08 | — | — | — | — | — | — | — | — | — | — | — | 200 | — | 0.1 | — | — | — |
| a-2 | 0.2 | 0.08 | — | — | — | — | — | — | — | — | — | — | 60 | — | 40 | 0.1 | 8 | 40 | 40 |

### Example 1

As a support, a polyethylene terephthalate (PET) film (thickness: 50 μm, manufactured by Toray Industries, Inc., LUMIRROR (registered trademark) U48) was prepared.

The composition A-1 for a color conversion film was applied onto one surface of the PET film using a slot die coater, and dried at 100° C. for 2 minutes. After the drying, under a nitrogen purge environment, the composition was cured by irradiating the composition with ultraviolet rays using an air-cooled metal halide lamp (manufactured by Eye Graphics Co., Ltd.) to form a color conversion layer having a thickness of 10 μm after drying on the support.

In the ultraviolet irradiation, an irradiation amount was 500 mJ/cm².

Next, a chemical mat-treated film having a thickness of 138 μm (manufactured by KIMOTO, Chemical Matte 125PW) as a protective layer was heated and pressure-bonded to the color conversion layer to manufacture a color conversion film.

### Examples 2 to 5 and Comparative Examples 1 and 2

Color conversion films were produced in the same manner as in Example 1, except that the composition A-1 for a color conversion film was changed to the composition for a color conversion film shown in Table 24.

In Example 5 and Comparative Example 2, the above-described composition for a color conversion film was dried at 130° C. for 5 minutes, and then was not irradiated with ultraviolet rays.

In addition, in Comparative Example 1, the ultraviolet irradiation was not performed.

<<Evaluation of Storage Stability>>

The composition for a color conversion film, which was used for manufacturing the color conversion film in Examples and Comparative Examples described above, was stored at room temperature (25° C.) after replacing the air in the container in which the composition for the color conversion film was produced with nitrogen.

After 1 week, the state of the composition for a color conversion film in the container was confirmed, and the presence or absence of gel-like component was visually confirmed. Table 24 summarizes a case where the gel-like component was not confirmed as A and a case where the gel-like component was confirmed as B.

<<Measurement of Emission Peak>>

The color conversion film obtained in Example 1 was disposed on a planar light-emitting device equipped with a blue LED element having an emission peak wavelength of 447 nm such that a support surface was in contact with the planar light-emitting device, and a prism sheet was placed on the color conversion film.

In a case where a current of 30 mA was passed through the planar light-emitting device to turn on the blue LED element and light having an emission peak wavelength of 447 nm was radiated from the support side, white light including blue light, green light, and red light was observed.

Using a spectral emission brightness meter (CS-1000 manufactured by Konica Minolta Inc.), an emission spectrum of the above-described white light was obtained.

From the obtained emission spectrum, it was confirmed that a peak wavelength of the green light was 500 nm or more and less than 580 nm. In addition, similarly, it was confirmed that a peak wavelength of the red light was 580 nm or more and 750 nm or less.

As a result of measuring peak wavelengths for other Examples in the same manner, it was confirmed that a peak wavelength of the green light was 500 nm or more and less than 580 nm and a peak wavelength of the red light was 580 nm or more and 750 nm or less.

<<Evaluation of Light Resistance>>

The color conversion films obtained in Examples and Comparative Examples described above were cut out into squares of 3 cm square.

The cut-out color conversion film was placed on a commercially available blue light source (manufactured by OPTEX FA CO., LTD., OPSM-H 150X142B), the color conversion film was irradiated with blue light having a wavelength of 447 nm, and brightness of light passing through the color conversion film was measured with a brightness meter (manufactured by Konica Minolta Inc., CS-1000).

In an environment of 25° C. and a relative humidity of 60%, the cut-out color conversion film was placed on the above-described blue light source, and the color conversion film was continuously irradiated with the blue light having a wavelength of 447 nm.

The brightness of the light was measured every 10 hours in the same manner as described above, and a time for which the brightness decreased by 2% (hereinafter, referred to as a brightness decrease time) was obtained and evaluated based on the following evaluation standard. The evaluation results are shown in Table 24.

(Evaluation Standard)

A: brightness decrease time was 100 hours or more.

B: brightness decrease time was 30 hours or more and less than 100 hours.

C: brightness decrease time was less than 30 hours.

TABLE 24

| | Composition used for | | With or without | Evaluation of | Evaluation |
|---|---|---|---|---|---|
| | forming color | Heating | ultraviolet | storage | of light |
| | conversion layer | condition | irradiation | stability | resistance |
| Example 1 | A-1 | 100° C. for 2 minutes | Y | A | A |
| Example 2 | A-2 | 100° C. for 2 minutes | Y | A | A |
| Example 3 | A-3 | 100° C. for 2 minutes | Y | A | A |
| Example 4 | A-4 | 100° C. for 2 minutes | Y | A | A |
| Example 5 | A-5 | 130° C. for 5 minutes | N | A | A |
| Comparative | a-1 | 100° C. for 2 minutes | N | A | C |
| Example 1 | | | | | |
| Comparative | a-2 | 100° C. for 2 minutes | N | B | A |
| Example 2 | | | | | |

From the results of Examples described above, it was found that the composition for a color conversion film according to the embodiment of the present disclosure has excellent storage stability, and a color conversion film having excellent light resistance can be manufactured.

The disclosure of JP2020-210834 filed on Dec. 18, 2020 is incorporated in the present specification by reference. All documents, patent applications, and technical standards described in the present specification are herein incorporated by reference to the same extent that each individual document, patent application, or technical standard was specifically and individually indicated to be incorporated by reference.

What is claimed is:

1. A color conversion film comprising:
a support; and
a color conversion layer formed by curing a composition for a color conversion film, the composition comprising:
at least two types of organic light-emitting materials which emit, by an excitation light, light having a longer wavelength than the excitation light and have peak wavelengths of light emission different from each other; and
at least one of a photopolymerizable compound or a compound having a crosslinkable group to which a protective group that is to be eliminated by heat is bonded.

2. The color conversion film according to claim 1,
wherein the photopolymerizable compound includes a radically polymerizable compound.

3. The color conversion film according to claim 1,
wherein the photopolymerizable compound includes a cationically polymerizable compound.

4. The color conversion film according to claim 1,
wherein the compound having a crosslinkable group to which a protective group that is to be eliminated by heat is bonded is a blocked isocyanate compound.

5. The color conversion film according to claim 1, the composition further comprising:
a photopolymerization initiator.

6. The color conversion film according to claim 1,
wherein the organic light-emitting material includes a first organic light-emitting material which emits, by an excitation light having a wavelength of 400 nm or more and less than 500 nm, light observed in a region having a peak wavelength of 500 nm or more and less than 580 nm, and a second organic light-emitting material which emits, by at least one of the excitation light having a wavelength of 400 nm or more and less than 500 nm or the light emitted from the first organic light-emitting material, light observed in a region having a peak wavelength of 580 nm or more and 750 nm or less.

7. The color conversion film according to claim 1,
wherein each of the organic light-emitting materials is represented by General Formula (1), 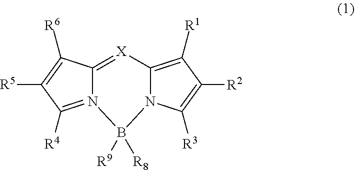
in General Formula (1), X represents C—R⁷ or N, and R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring.

8. A backlight unit comprising:
a light source; and
the color conversion film according to claim 1.

9. A liquid crystal display device comprising:
the backlight unit according to claim 8; and
a liquid crystal cell unit.
